(19) United States
(12) Patent Application Publication
(10) Pub. No.: US 2026/0247404 A1
(43) Pub. Date: Aug. 20, 2026

(54) UE-INITIATED CSI MEASUREMENT AND REPORTING

(71) Applicant: Samsung Electronics Co., Ltd., Suwon-si (KR)

(72) Inventors: Dalin Zhu, Allen, TX (US); Md. Saifur Rahman, Plano, TX (US); Emad Nader Farag, Flanders, NJ (US); Gilwon Lee, Prosper, TX (US); Eko Onggosanusi, Coppell, TX (US)

(21) Appl. No.: 19/648,374

(22) Filed: Apr. 15, 2026

Related U.S. Application Data
(63) Continuation of application No. 18/391,318, filed on Dec. 20, 2023.
(60) Provisional application No. 63/436,816, filed on Jan. 3, 2023.
(60) Provisional application No. 63/437,073, filed on Jan. 4, 2023.

(51) Int. Cl. H04W 72/232; H04B 7/06; H04L 5/00; H04W 16/28

(52) U.S. Cl. CPC H04W 72/232; H04B 7/0626; H04L 5/0053; H04W 16/28

(57) ABSTRACT

Methods and apparatus for user equipment (UE)-initiated channel state information (CSI) measurement and reporting. A method performed by a UE includes transmitting an indicator to request transmission of one or more CSI reference signals (RSs), receiving a downlink control information (DCI) format indicating a value of a CSI request field, and identifying a first time window. The method further includes identifying a reception time of the DCI format relative to a last symbol for transmission of the indicator, determining, based on the value, a CSI resource setting and a CSI reporting setting, and measuring, based on the CSI resource setting, the one or more CSI-RSs.

### CROSS-REFERENCE TO RELATED AND CLAIM OF PRIORITY

This application is a continuation of U.S. patent application Ser. No. 18/391,318 filed on Dec. 20, 2023, which claims priority under 35 U.S.C. § 119(e) to U.S. Provisional Patent Application No. 63/436,816 filed on Jan. 3, 2023, and U.S. Provisional Patent Application No. 63/437,073 filed on Jan. 4, 2023, which are hereby incorporated by reference in their entirety.

### TECHNICAL FIELD

The present disclosure relates generally to wireless communication systems and, more specifically, the present disclosure relates to methods and apparatus for user equipment (UE)-initiated channel state information (CSI) measurement and reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE-initiated CSI measurement and reporting.

In one embodiment, a UE is provided. The UE includes a transceiver configured to transmit an indicator to request transmission of one or more channel state information (CSI) reference signals (RSs) and receive a downlink control information (DCI) format indicating a value of a CSI request field. The UE further includes a processor operably coupled with the transceiver. The processor is configured to identify a first time window, identify a reception time of the DCI format relative to a last symbol for transmission of the indicator, determine, based on the value, a CSI resource setting and a CSI reporting setting, and measure, based on the CSI resource setting, the one or more CSI-RSs.

In another embodiment, a base station (BS) is provided. The BS includes a processor and a transceiver operably coupled with the processor. The transceiver is configured to receive an indicator to request transmission of one or more channel state information CSI-RSs, transmit a DCI format indicating a value of a CSI request field, and transmit the one or more CSI-RSs according to a CSI resource setting associated with the value.

In yet another embodiment, a method performed by a UE is provided. The method includes transmitting an indicator to request transmission of one or more CSI-RSs, receiving a DCI format indicating a value of a CSI request field, and identifying a first time window. The method further includes identifying a reception time of the DCI format relative to a last symbol for transmission of the indicator, determining, based on the value, a CSI resource setting and a CSI reporting setting, and measuring, based on the CSI resource setting, the one or more CSI-RSs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example procedure for UE-initiated/triggered channel state information (CSI) measurement and reporting according to embodiments of the present disclosure;

FIG. 8 illustrates an example procedure for UE-initiated/triggered CSI measurement and reporting according to embodiments of the present disclosure;

FIG. 9 illustrates an example procedure for UE-initiated/triggered CSI measurement and reporting according to embodiments of the present disclosure;

FIG. 10 illustrates an example procedure for UE-initiated/triggered CSI measurement and reporting according to embodiments of the present disclosure;

FIG. 11 illustrates an example procedure for UE-initiated/triggered CSI measurement and reporting according to embodiments of the present disclosure;

FIG. 12 illustrates an example procedure for UE-initiated/triggered CSI measurement and reporting according to embodiments of the present disclosure;

FIG. 13 illustrates examples procedures for UE-initiated/triggered CSI measurement and reporting according to embodiments of the present disclosure;

FIG. 14 illustrates an example procedure for UE-initiated/triggered CSI measurement and reporting according to embodiments of the present disclosure;

FIG. 15 illustrates an example procedure for UE-initiated/triggered CSI measurement and reporting according to embodiments of the present disclosure;

FIG. 16 illustrates examples procedures for UE-initiated/triggered CSI measurement and reporting according to embodiments of the present disclosure;

FIG. 17 illustrates an example procedure for UE-initiated/triggered CSI measurement and reporting according to embodiments of the present disclosure; and

FIG. 18 illustrates an example procedure for UE-initiated/triggered CSI measurement and reporting according to embodiments of the present disclosure.

### DETAILED DESCRIPTION

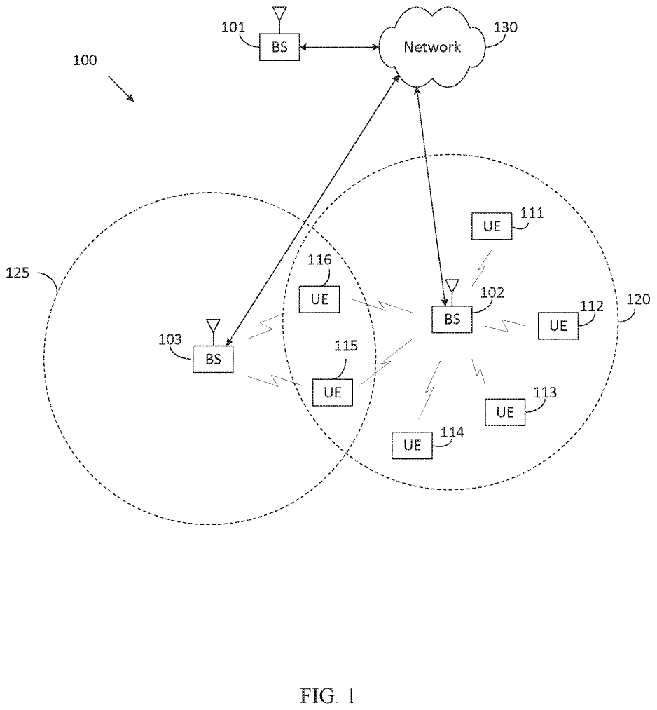

FIGS. 1-18, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1]3GPP TS 38.211 v16.1.0, “NR; Physical channels and modulation;” [2]3GPP TS 38.212 v16.1.0, “NR; Multiplexing and Channel coding;” [3]3GPP TS 38.213 v16.1.0, “NR; Physical Layer Procedures for Control;” [4]3GPP TS 38.214 v16.1.0, “NR; Physical Layer Procedures for Data;” [5]3GPP TS 38.321 v16.1.0, “NR; Medium Access Control (MAC) protocol specification;” and [6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing UE-initiated CSI measurement and reporting. In certain embodiments, one or more of the BSs 101-103 include circuitry, programing, or a combination thereof to support a UE-initiated CSI measurement and reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

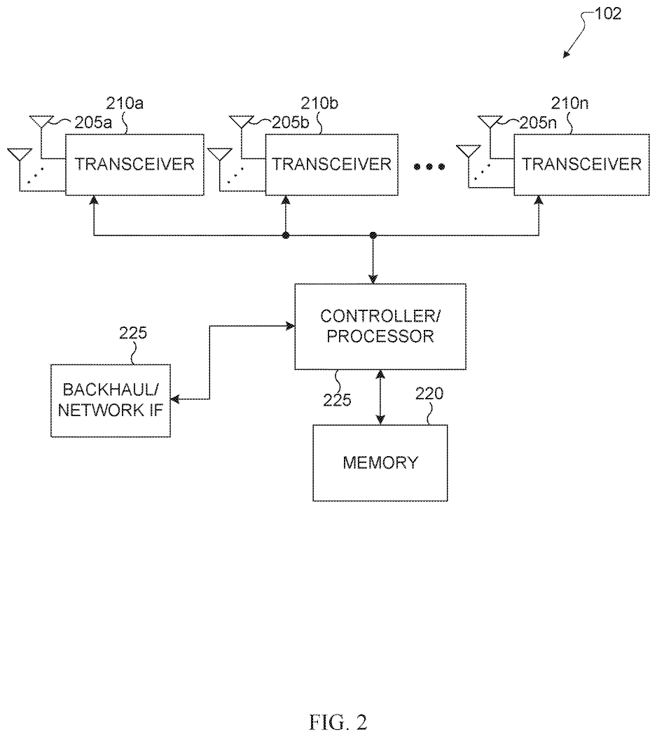

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting UE-initiated CSI measurement and reporting. Any of a wide variety of other functions could be supported in the gNB 102 by the controller/processor 225.

The controller/processor 225 is also capable of executing programs and other processes resident in the memory 230, such as UE-initiated CSI measurement and reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

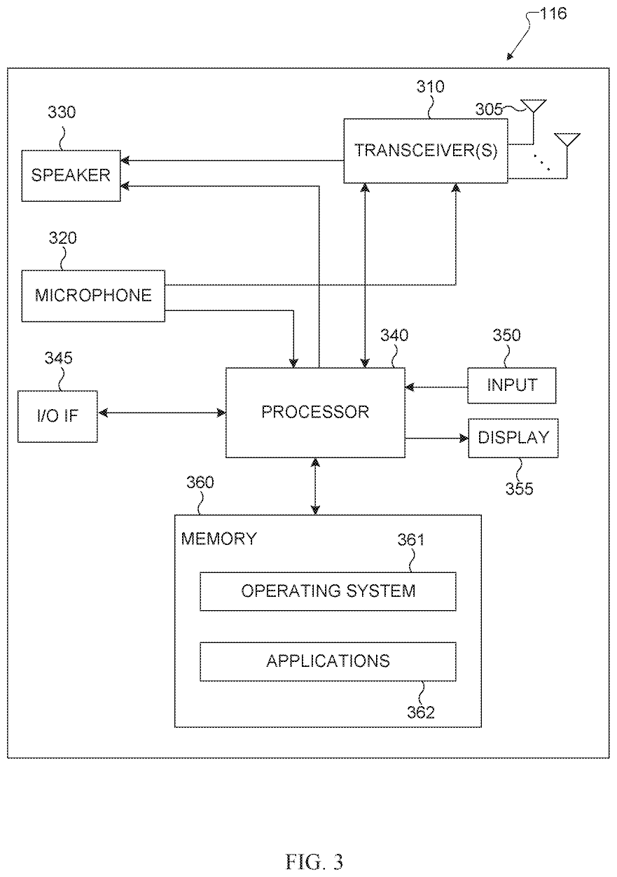

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for performing a UE-initiated CSI measurement and reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

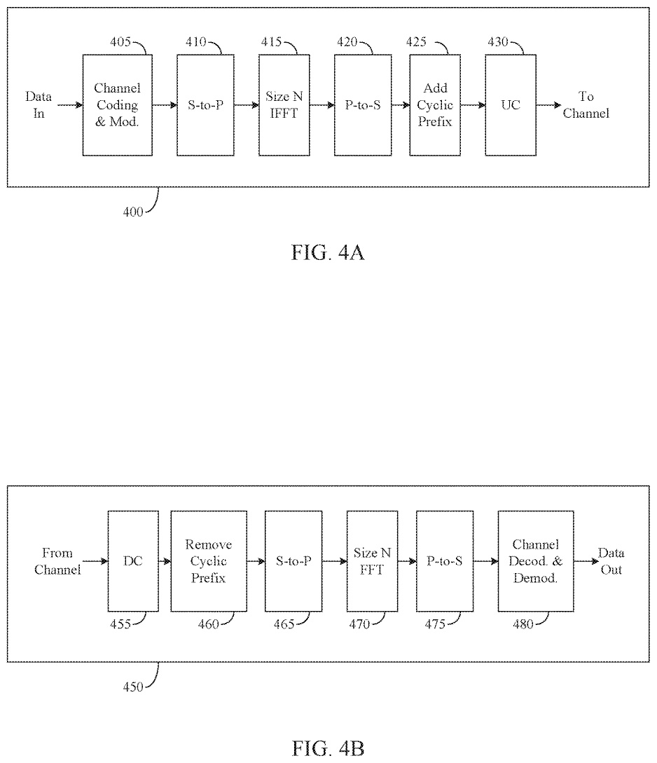

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to support UE-initiated CSI measurement and reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding reference signal (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

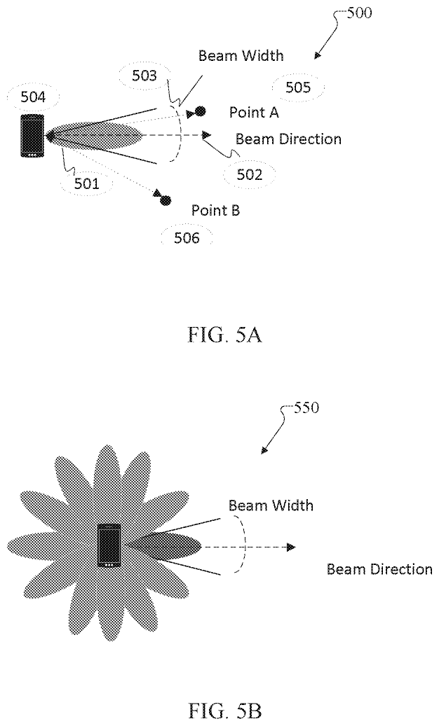

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by gNB 102 of FIG. 2. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

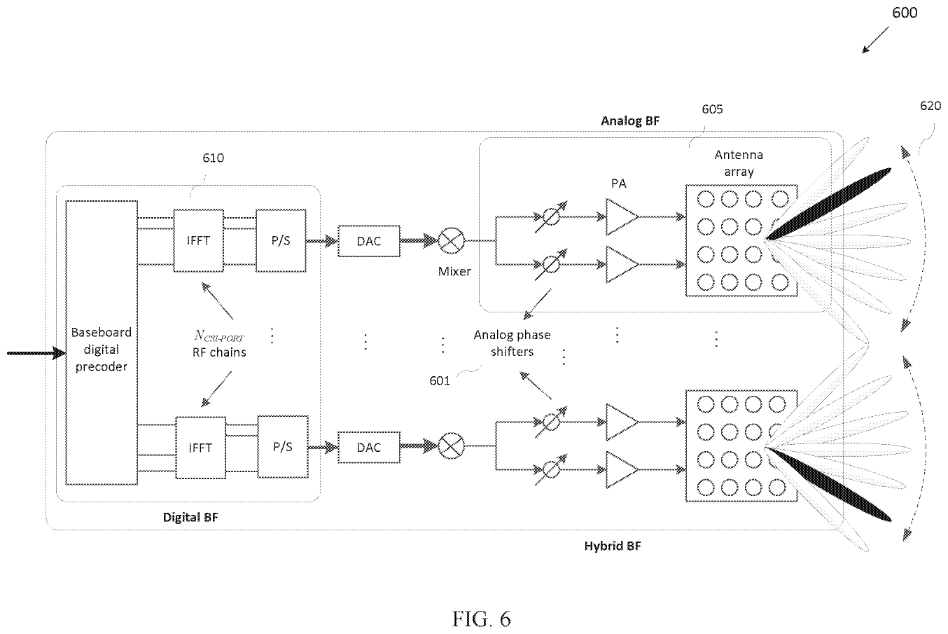

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In (up to Rel.17) NR specification, the most resource-efficient reporting mechanism for a content (e.g., beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the network (NW)/gNB lacks knowledge on the DL channel condition—or, in other words, the UE knows the DL channel condition better. In this case, it is clearly beneficial if the UE can initiate its own aperiodic reporting for a content (e.g., beam, CSI etc.). For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB. Such UE-initiated reporting for a content can be enabled for other types of report quantities (different from traditional beam or CSI reports).

Although UE-initiated reporting can be beneficial, efficient designs are needed to ensure that the latency is reduced and, at the same time, error events can be minimized. Therefore, embodiments of the present disclosure recognize there is a need for efficient designs for UE-initiated reporting for a content that can offer good trade-off between latency and reliability. In particular, when the UE-initiated reporting framework can include multiple report types (or report quantities), or/and multiple event types when report types can be associated with an event (e.g., for beam report, the event can be beam failure, and for CSI, the event can be user throughput degradation or increasing retransmission rate).

This disclosure provides example embodiments on UE-initiated/triggered reporting. More specifically, the present disclosure provides various means of triggering/initiating (aperiodic) CSI measurement/reporting by the UE (or jointly with the network).

The present disclosure provides various novel and detailed resource and reporting settings to enable the UE-initiated/triggered reporting. Furthermore, various means of triggering/initiating (aperiodic) CSI measurement/reporting by the UE (or jointly by the UE and the network) are specified in the present disclosure.

In the present disclosure, a UE detects (or determines) a need for transmitting a UE-initiated/UE-triggered report (or initiation/triggering) of a (report-)type (A), (B), or (C), where:
(A) includes an initiator/trigger/pre-notification message.
(B) includes a report/content (comprising one or multiple report quantities).
(C) includes both a trigger/pre-notification message and a (corresponding) report/content.

The report is to facilitate/enable efficient/timely/fast/reliable communication over the link/channel between a target entity (e.g., NW/gNB or another device) and the UE. The content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g. CRI, SS/PBCH Block Resource Indicator (SSBRI) and Jᵢ is a beam metric (e.g. L1-reference signal received power (RSRP), L1-signal to interference and noise ratio (SINR)).
In one example, the content includes CSI-related quantity/quantities. For example, at least one of (rank indicator (RI), precoding matrix indicator (PMI), channel quality indicator (CQI), CQI report interval (CRI), layer index (LI)).
In one example, the content includes TDCP-related quantity/quantities. For example, an indicator about the Doppler profile (e.g., Doppler spread or Doppler shift, relative Doppler spreads, or relative Doppler shifts) or an indicator about the auto-correlation profiles (e.g. (auto-)correlation values corresponding to a few dominant lags/delays).
In one example, the content includes other (e.g., non-beam, non-CSI, non-TDCP) quantity/quantities.
   In one example, quantity/quantities comprise a selector/indicator indicating selection of one (or >1) of either:
      beam (TCI state) TCI states (e.g., DL TCI state, UL TCI state, or unified (joint) DL/UL TCI state), or
      panel(s) (e.g., UE panels for DL reception or/and UL transmission), or
      antenna(e) (e.g., UE antennae for DL reception or/and UL transmission), or
      antenna port(s) (e.g., UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities and at least one other quantity/quantities.
In one example, the content includes CSI-related quantity/quantities and at least one other quantity/quantities.
In one example, the content includes TDCP-related quantity/quantities and at least one other quantity/quantities.
In one example, the content includes beam-related quantity/quantities and CSI-related quantity/quantities.
In one example, the content includes beam-related quantity/quantities and TDCP-related quantity/quantities.
In one example, the content includes TDCP-related quantity/quantities and CSI-related quantity/quantities.

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE 116 is a Uu interface (i.e., DL, UL).

In one example, the link/channel between the target entity and the UE 116 is a sidelink (SL), or a device-to-device (D2D) or PC5 interface.

In one example, such reporting can be non-event-based or autonomous, the UE 116 can initiate/trigger the report autonomously (i.e., without being associated with any event) or unconditionally/freely. For example, the UE 116 can be configured with a triggering time window (or multiple UL slots), and the UE 116 can trigger the report during this window.

In one example, such reporting can be event-based, i.e., the UE 116 can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be Joint, as shown in Table 4. A few examples of the autonomous UE-initiated report are shown in Table 5.

TABLE 1
event-based UE-initiated report

| | Report | | |
|---|---|---|---|
| Event type | Type | Trigger/pre-notification message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non-CSI/ | (A) | Yes (e.g., non-CSI-related event) | No |
| beam/TDCP | (B) | No | Yes |
| | (C) | Yes (e.g., non-CSI-related event) | Yes |
| 4. other | (A) | Yes (no need for content) | No |
| (content-free/ | | | |
| less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report

| Report | | |
|---|---|---|
| Type | Trigger/pre-notification message | Content |
| 0 | Yes (e.g., beam-related event), content-specific or event- | No |
| | specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
non-event-based or autonomous UE-initiated report

| Report | | |
|---|---|---|
| Type | Trigger/pre-notification message | Content |
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, an index or a parameter (e.g., reportQuantity) can be used to indicate one example from tables herein. The index/parameter can be used to configure the UE-initiated report according to one or more examples described herein, e.g., via higher layer RRC. Such a configuration can be subject to the UE 116 capability. In one example, the index/parameter can also indicate multiple (e.g., 2) examples from tables herein. In this case, the UE-initiated report can include the report for at least one for the two.

In this disclosure, the UE-initiated or UE-triggered reporting as specified herein in the present disclosure could be associated with or linked to one or more CSI reporting settings each provided by CSI-ReportConfig.
In one example, the CSI reporting setting ID(s) provided by reportConfigId for the one or more CSI reporting settings for the UE-initiated or UE-triggered reporting could be fixed in the system specification(s)—e.g., corresponding to the lowest/highest or predefined/preconfigured CSI reporting setting ID(s), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-MeasConfig) and/or MAC CE command and/or dynamic downlink control information (DCI) based L1 signaling, the CSI reporting setting ID(s)—provided by reportConfigId—for the one or more CSI reporting settings for the UE-initiated or UE-triggered reporting.
In another example, the one or more CSI reporting settings for the UE-initiated or UE-triggered reporting could correspond to the CSI reporting setting(s) with the higher layer parameter ‘reportQuantity’ configured therein set to ‘none’.
In yet another example, a higher layer parameter denoted by ‘ueInitiatedReporting’ could be provided/configured in a CSI reporting setting (e.g., in the corresponding higher layer RRC parameter CSI-ReportConfig). For this case, the one or more CSI reporting settings for the UE-initiated or UE-triggered reporting could correspond to the CSI reporting setting(s) with the higher layer parameter ‘ueInitiatedReporting’ configured therein set to ‘enabled’.
In yet another example, the UE 116 could be provided/configured/indicated by the network 130, e.g., via higher layer RRC signaling/parameter (e.g., in/via the higher layer RRC parameter CSI-MeasConfig) and/or MAC CE command and/or dynamic DCI based L1 signaling, a bitmap with each bit position/entry of the bitmap corresponding/associated to a CSI reporting setting configured therein. When/if a bit position/entry of the bitmap is set to ‘1’ (or ‘0’), the corresponding/associated CSI reporting setting could be enabled for the UE-initiated/triggered reporting.

In the present disclosure, a CSI reporting setting for the UE-initiated/triggered reporting as described herein could be associated with one or more CSI resource settings (each provided by CSI-ResourceConfig); here, the one or more CSI resource settings could be referred to as CSI resource setting(s) for the UE-initiated/triggered reporting. Each CSI resource setting for the UE-initiated/triggered reporting could comprise one or more CSI resource sets (e.g., SSB resource set(s) provided by CSI-SSB-ResourceSet or non-zero power (NZP) CSI-RS resource set(s) provided by nzp-CSI-RS-ResourceSet); here, the one or more CSI resource sets could be referred to as CSI resource set(s) for the UE-initiated/triggered reporting. Furthermore, each CSI resource set for the UE-initiated/triggered reporting could comprise one or more CSI-RS resources including SSB resource indexes (each provided by SSB-Index) or one or more NZP CSI-RS resources (each provided by NZP-CSI-RS-Resource) for the UE-initiated/triggered reporting. In the present disclosure, the UE 116 could measure the one or more CSI-RSs for the UE-initiated/triggered reporting (e.g., provided/configured in the CSI resource setting(s)/CSI resource set(s) for the UE-initiated/triggered reporting) and use/apply the corresponding measurement result(s) to autonomously initiate/trigger the event(s)-based or non-event(s)-based reporting as specified herein in the present disclosure.

In the present disclosure, a CSI reporting setting could be associated with one or more CSI resource settings (each provided by CSI-ResourceConfig), wherein each CSI resource setting could comprise one or more CSI resource sets (e.g., SSB resource set(s) provided by CSI-SSB-ResourceSet or NZP CSI-RS resource set(s) provided by nzp-CSI-RS-ResourceSet) and each CSI resource set could comprise one or more CSI-RS resources including SSB resource indexes (each provided by SSB-Index) or one or more NZP CSI-RS resources (each provided by NZP-CSI-RS-Resource).
In one example, the one or more CSI resource settings could be (enabled) for the UE-initiated/triggered reporting according to one or more of the following.
   For example, the CSI resource setting ID(s) provided by csi-ResourceConfigId for the one or more CSI resource settings for the UE-initiated or UE-triggered reporting could be fixed in the system specification(s)—e.g., corresponding to the lowest/highest or predefined/preconfigured CSI resource setting ID(s), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-MeasConfig) and/or MAC CE command and/or dynamic DCI based L1 signaling, the CSI resource setting ID(s)—provided by csi-ResourceConfigId—for the one or more CSI resource settings for the UE-initiated or UE-triggered reporting.
   For another example, a higher layer parameter denoted by ‘csiResourceConfigForUeInitiatedReporting’ could be provided/configured in a CSI resource setting (e.g., in the corresponding higher layer RRC parameter CSI-Resource Config). For this case, the one or more CSI resource settings for the UE-initiated or UE-triggered reporting could correspond to the CSI resource setting(s) with the higher layer parameter ‘csiResourceConfigForUeInitiatedReporting’ configured therein set to ‘enabled’.
   Yet for another example, the UE 116 could be provided/configured/indicated by the network 130, e.g., via higher layer RRC signaling/parameter (e.g., in/via the higher layer RRC parameter CSI-MeasConfig) and/or MAC CE command and/or dynamic DCI based L1 signaling, a bitmap with each bit position/entry of the bitmap corresponding/associated to a CSI resource setting configured therein. When/if a bit position/entry of the bitmap is set to ‘1’ (or ‘0’), the corresponding/associated CSI resource setting could be enabled for the UE-initiated/triggered reporting.
In another example, the one or more CSI resource sets (provided/configured in the one or more CSI resource settings) could be (enabled) for the UE-initiated/triggered reporting according to one or more of the following.
   For example, the CSI resource set ID(s) (e.g., provided by csi-SSB-ResourceSetId for a SSB resource set or nzp-CSI-RS-ResourceSetId for a NZP CSI-RS resource set) for the one or more CSI resource sets for the UE-initiated or UE-triggered reporting could be fixed in the system specification(s)—e.g., corresponding to the lowest/highest or predefined/preconfigured CSI resource set ID(s), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-ResourceConfig) and/or MAC CE command and/or dynamic DCI based L1 signaling, the CSI resource set ID(s)—provided by csi-SSB-ResourceSetId for a SSB resource set or nzp-CSI-RS-ResourceSetId for a NZP CSI-RS resource set—for the one or more CSI resource sets for the UE-initiated or UE-triggered reporting.
   For another example, a higher layer parameter denoted by ‘csiResourceSetForUeInitiatedReporting’ could be provided/configured in a CSI resource set (e.g., in the corresponding higher layer RRC parameter csi-SSB-ResourceSetId for a SSB resource set or nzp-CSI-RS-ResourceSetId for a NZP CSI-RS resource set). For this case, the one or more CSI resource sets for the UE-initiated or UE-triggered reporting could correspond to the CSI resource set(s) with the higher layer parameter ‘csiResourceSetForUeInitiatedReporting’ configured therein set to ‘enabled’.
   Yet for another example, the UE 116 could be provided/configured/indicated by the network 130, e.g., via higher layer RRC signaling/parameter (e.g., in/via the higher layer RRC parameter CSI-ResourceConfig) and/or MAC CE command and/or dynamic DCI based L1 signaling, a bitmap with each bit position/entry of the bitmap corresponding/associated to a CSI resource set configured therein. When/if a bit position/entry of the bitmap is set to ‘1’ (or ‘0’), the corresponding/associated CSI resource set such as SSB resource set or NZP CSI-RS resource set could be enabled for the UE-initiated/triggered reporting.
In yet another example, the one or more CSI-RS resources (provided/configured in the one or more CSI resource sets) could be (enabled) for the UE-initiated/triggered reporting according to one or more of the following.
   For example, the CSI-RS resource ID(s) (e.g., provided by SSB-Index for a SSB resource or nzp-CSI-RS-ResourceId for a NZP CSI-RS resource) for the one or more CSI-RS resources for the UE-initiated or UE-triggered reporting could be fixed in the system specification(s)—e.g., corresponding to the lowest/highest or predefined/preconfigured CSI-RS resource ID(s), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, the CSI-RS resource ID(s)—provided by SSB-Index for a SSB resource or nzp-CSI-RS-ResourceId for a NZP CSI-RS resource—for the one or more CSI-RS resources for the UE-initiated or UE-triggered reporting.
   For another example, a higher layer parameter denoted by ‘csiResourceForUeInitiatedReporting’ could be provided/configured in a CSI-RS resource (e.g., in the corresponding higher layer RRC parameter SSB-Index for a SSB resource or NZP-CSI-RS-Resource for a NZP CSI-RS resource). For this case, the one or more CSI-RS resources for the UE-initiated or UE-triggered reporting could correspond to the CSI-RS resources with the higher layer parameter ‘csiResourceForUeInitiatedReporting’ configured therein set to ‘enabled’.
   Yet for another example, the UE 116 could be provided/configured/indicated by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, a bitmap with each bit position/entry of the bitmap corresponding/associated to a CSI-RS resource configured therein. When/if a bit position/entry of the bitmap is set to ‘1’ (or ‘0’), the corresponding/associated CSI-RS resource such as a SSB resource or a NZP CSI-RS resource could be enabled for the UE-initiated/triggered reporting.

In the present disclosure, the UE could receive from the network, one or more MAC CEs/MAC CE commands to update one or more of the measurement CSI-RSs as specified herein in the present disclosure for (aperiodic) CSI reporting or the UE-initiated/triggered reporting. Furthermore, the measurement resource and/or reporting settings—including the CSI reporting settings (each provided by CSI-ReportConfig), the CSI resource settings (each provided by CSI-ResourceConfig), the CSI resource sets (each provided by CSI-SSB-ResourceSet or NZP-CSI-RS-ResourceSet) and/or the CSI-RS resources (each corresponding to a SSB or a NZP CSI-RS resource) configured therein—as specified herein in the present disclosure could be (one-to-one) associated/linked to one or more events or event types as specified herein in the present disclosure; the UE could be provided/configured/indicated by the network 130, e.g., via higher layer RRC signaling and/or MAC CE command and/or dynamic DCI based L1 signaling, the association/linkage between the resource or reporting settings and the events or event types. Upon receiving or determining the measurement resource and/or reporting settings, the UE could then, based on the association/linkage, determine the corresponding event(s) or event type(s) for the UE-initiated/triggered reporting. In addition, the measurement resource and/or reporting settings—including the CSI reporting settings (each provided by CSI-ReportConfig), the CSI resource settings (each provided by CSI-ResourceConfig), the corresponding CSI resource sets (each provided by CSI-SSB-ResourceSet or NZP-CSI-RS-ResourceSet) and/or the CSI-RS resources (each corresponding to a SSB or a NZP CSI-RS resource) configured therein—as specified herein in the present disclosure could be (one-to-one) associated/linked to one or more uplink resources/channels/signals (e.g., one or more physical uplink control channel (PUCCH)/physical uplink shared channel (PUSCH) resources, one or more physical random access channel (PRACH) resources, etc.); the UE could be provided/configured/indicated by the network 130, e.g., via higher layer RRC signaling and/or MAC CE command and/or dynamic DCI based L1 signaling, the association/linkage between the resource or reporting settings and the uplink resources/channels/signals. Upon receiving or determining the measurement resource and/or reporting settings, the UE could then, based on the association/linkage, determine the corresponding uplink resource(s)/channel(s)/signal(s)—e.g., the PUCCH/PUSCH resource(s) or the PRACH resource(s)—to send/transmit the UE-initiated/triggered report.

As specified herein in the present disclosure, in one embodiment, one or more CSI resource settings could be (enabled) for the UE-initiated/triggered reporting. The UE 116 could measure the CSI-RS(s) configured in the CSI resource setting for the UE-initiated/triggered reporting and use/apply the corresponding measurement result(s) to autonomously initiate/trigger the event(s)-based or non-event(s)-based reporting as specified herein in the present disclosure.

As specified herein in the present disclosure, in one embodiment, one or more CSI resource sets (configured in one or more CSI resource settings) could be (enabled) for the UE-initiated/triggered reporting. The UE 116 could measure the CSI-RS(s) configured in the CSI resource set for the UE-initiated/triggered reporting, and use/apply the corresponding measurement result(s) to autonomously initiate/trigger the event(s)-based reporting as specified herein in the present disclosure.

As specified herein in the present disclosure, in one embodiment, the UE could be configured by the network, e.g., via higher layer RRC signaling/parameter (e.g., in a CSI resource set provided by CSI-SSB-ResourceSet or nzp-CSI-RS-ResourceSet) and/or MAC CE command and/or dynamic DCI based L1 signaling, one or more (e.g., N≥1) first reference signals (RSs) or RS resources for beam, channel or interference measurement(s), wherein a first RS could correspond to a SSB (e.g., provided by SSB-Index) or a CSI-RS for tracking, a CSI-RS for CSI acquisition or a CSI-RS for beam management (e.g., provided by NZP-CSI-RS-Resource). Furthermore, the UE could use the measurement results of one or more (e.g., M where 1≤M≤N) of the first RSs—referred to as second RSs in the present disclosure—for the UE-initiated or UE-triggered reporting as specified herein in the present disclosure. As described herein, the second RSs here can also be referred to as the CSI-RSs or CSI-RS resources (enabled) for the UE-initiated/triggered reporting. For example, the UE 116 could autonomously determine which M second RSs (out of the N first RSs), and therefore, their corresponding measurement results, to use for the UE-initiated/triggered reporting. For another example, the UE 116 could be indicated/configured/provided by the network 130, e.g., via higher layer RRC signaling/parameter and/or MAC CE command and/or dynamic DCI based L1 signaling, which M second RSs (out of the N first RSs), and therefore, their corresponding measurement results, to use for the UE-initiated/triggered reporting. More specifically:
In one example, the M second RSs or indexes of the M second RSs—out of the N first RSs—could be fixed in the system specification(s) and known to both the UE 116 and network 130 sides. Specifically, for this design example, the positions/orderings/indexes of the M second RSs in the N first RSs are known to both the UE 116 and network 130 sides.
   For example, the M second RSs could correspond to the first (e.g., received or configured to receive earliest in time) M RSs of the N first RSs. For instance, for M=1, the UE 116 could use the first RS (e.g., received or configured to receive earliest in time) of the N first RSs, and therefore, the corresponding measurement result(s), for the UE-initiated/triggered reporting.
   For another example, the M second RSs could correspond to the last (e.g., received or configured to receive latest in time) M RSs of the N first RSs. For instance, for M=1, the UE 116 could use the last RS (e.g., received or configured to receive latest in time) of the N first RSs, and therefore, the corresponding measurement result(s), for the UE-initiated/triggered reporting.
   Yet for another example, the M second RSs could correspond to the M RSs of the N first RSs with the lowest (or highest) RS indexes. For instance, for M=1, the UE 116 could use the RS with the lowest (or highest) RS index of the N first RSs, and therefore, the corresponding measurement result(s), for the UE-initiated/triggered reporting.
   Yet for another example, the M second RSs could correspond to the M RSs of the N first RSs with the lowest (or highest) odd RS indexes. For instance, for M=N, the M second RSs could correspond to each of the RSs out of the N first RSs with odd RS indexes.
   Yet for another example, the M second RSs could correspond to the M RSs of the N first RSs with the lowest (or highest) even RS indexes. For instance, for M=N, the M second RSs could correspond to each of the RSs out of the N first RSs with even RS indexes.
   Yet for another example, the M second RSs could correspond to the M RSs of the N first RSs with predefined (odd/even) RS indexes.
   Yet for another example, the M second RSs could correspond to the M RSs of the N first RSs with predefined ordering of reception time.
In another example, the M second RSs or indexes of the M second RSs—out of the N first RSs—could be fixed in the system specification(s) and known to both the UE 116 and network 130 sides. Specifically, for this design example, the starting/ending RS index(es) of the M second RSs in the N first RSs are known to both the UE 116 and network 130 sides.
   For example, the starting RS could correspond to the first RS (e.g., received or configured to receive earliest in time) of the N first RSs; alternatively, the starting RS could correspond to the RS of the N first RSs with the lowest (or highest) RS index.
      In one example, the M second RSs could correspond to the first M RSs including the starting RS—out of the N first RSs—that are received or configured to receive earliest in time after reception of the starting RS. For instance, for M=1, the UE 116 could use the starting RS, and therefore, the corresponding measurement result(s), for the UE-initiated/triggered reporting.
      In another example, the M second RSs could correspond to the M RSs including the starting RS—out of the N first RSs—that are with the lowest (or highest) RS indexes lower (or higher) than the starting RS index. For instance, for M=1, the UE 116 could use the starting RS, and therefore, the corresponding measurement result(s), for the UE-initiated/triggered reporting.
      In yet another example, the M second RSs could correspond to the M RSs including the starting RS—out of the N first RSs—that are with the lowest (or highest) odd RS indexes lower (or higher) than the starting RS index; alternatively, the M second RSs could correspond to the M RSs including the starting RS—out of the N first RSs—that are with the lowest (or highest) even RS indexes lower (or higher) than the starting RS index.
      In yet another example, the M second RSs could correspond to the M RSs including the starting RS—out of the N first RSs—that are with predefined ordering of reception time later than the reception of the starting RS; alternatively, the M second RSs could correspond to the M RSs including the starting RS—out of the N first RSs—that are with predefined (odd/even) RS indexes lower (or higher) than the starting RS index.
   For another example, the ending RS could correspond to the last RS (e.g., received or configured to receive latest in time) of the N first RSs; alternatively, the ending RS could correspond to the RS of the N first RSs with the highest (or lowest) RS index.
      In one example, the M second RSs could correspond to the last M RSs including the ending RS—out of the N first RSs—that are received or configured to receive latest in time before reception of the ending RS. For instance, for M=1, the UE 116 could use the ending RS, and therefore, the corresponding measurement result(s), for the UE-initiated/triggered reporting.
      In another example, the M second RSs could correspond to the M RSs including the ending RS—out of the N first RSs—that are with the highest (or lowest) RS indexes higher (or lower) than the ending RS index. For instance, for M=1, the UE 116 could use the ending RS, and therefore, the corresponding measurement result(s), for the UE-initiated/triggered reporting.
      In yet another example, the M second RSs could correspond to the M RSs including the ending RS—out of the N first RSs—that are with the highest (or lowest) odd RS indexes higher (or lower) than the ending RS index; alternatively, the M second RSs could correspond to the M RSs including the ending RS—out of the N first RSs—that are with the highest (or lowest) even RS indexes higher (or lower) than the ending RS index.
      In yet another example, the M second RSs could correspond to the M RSs including the ending RS—out of the N first RSs—that are with predefined ordering of reception time earlier than the reception of the ending RS; alternatively, the M second RSs could correspond to the M RSs including the ending RS—out of the N first RSs—that are with predefined (odd/even) RS indexes higher (or lower) than the ending RS index.
   Yet for another example, the starting/ending RS could correspond to a predefined RS index out of the N first RSs; alternatively, the starting/ending RS could correspond to a RS out of the N first RSs that is received or configured to receive in a predefined reception time. For this case, the M second RSs could be determined according to the starting/ending RS specified herein and one or more of the described design examples herein in the present disclosure.
In yet another example, the M second RSs or indexes of the M second RSs—out of the N first RSs—could be fixed in the system specification(s) and known to both the UE 116 and network 130 sides. Specifically, for this design example, information of the M second RSs such as a time window/duration for the M second RSs including the starting/ending RS and/or the number of the second RSs (i.e., M in this design example) and/or etc. are known to both the UE 116 and network 130 sides. For this case, the starting/ending RS and/or the M second RSs and/or etc. of the time window/duration for the M second RSs (and therefore, the corresponding information) could be determined according to one or more of the described design examples herein in the present disclosure.
In yet another example, the UE 116 could be provided/indicated/configured by the network 130, e.g., via higher layer RRC signaling/parameter (e.g., via a CSI resource/reporting setting) and/or MAC CE command and/or dynamic DCI based L1 signaling, the positions/orderings/indexes of the M second RSs in the N first RSs as described/specified herein in the present disclosure, and/or the starting/ending RS index(es) of the M second RSs in the N first RSs as described/specified herein in the present disclosure, and/or the information of the M second RSs such as the time window/duration for the M second RSs including the starting/ending RS and/or the number of the second RSs (i.e., M in this design example) and/or etc. as described/specified herein in the present disclosure, etc.
   For example, the RS index(es) of the M second RSs (e.g., provided by SSB-Index for a SSB resource or nzp-CSI-RS-ResourceId for a NZP CSI-RS resource) in the N first RSs could be fixed in the system specification(s)—e.g., corresponding to the lowest/highest or predefined/preconfigured RS index(es), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, the RS index(es) of the M second RSs—provided by SSB-Index for a SSB resource or nzp-CSI-RS-ResourceId for a NZP CSI-RS resource—in the N first RSs.
   For another example, a higher layer parameter denoted by ‘csiResourceForUeInitiatedReporting’ could be provided/configured in the configuration of a RS resource (e.g., in the corresponding higher layer RRC parameter SSB-Index for a SSB resource or NZP-CSI-RS-Resource for a NZP CSI-RS resource). For this case, the second RSs (or second RS resources) could correspond to the RS resources with the higher layer parameter ‘csiResourceForUeInitiatedReporting’ configured therein set to ‘enabled’.
   Yet for another example, the UE 116 could be provided/configured/indicated by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, a bitmap with each bit position/entry of the bitmap corresponding/associated to a first RS or RS resource configured therein. When/if a bit position/entry of the bitmap is set to ‘1’ (or ‘0’), the corresponding/associated first RS or RS resource such as a SSB resource or a NZP CSI-RS resource could be enabled as a second RS or RS resource for the UE-initiated/triggered reporting.

The UE 116 could measure the CSI-RS(s) for the UE-initiated/triggered reporting as specified herein in the present disclosure and use/apply the corresponding measurement result(s) to autonomously initiate/trigger the event(s)-based or non-event(s)-based reporting.

In the present disclosure, the UE 116 could be provided/configured/indicated by the network, e.g., via higher layer RRC signaling/parameter and/or MAC CE command and/or dynamic DCI based L1 signaling, whether the UE-initiated or UE-triggered reporting is enabled or not. For instance, a higher layer RRC parameter denoted by ueInitiatedReporting could be provided/configured in PDSCH-Config, PDCCH-Config, ControlResourceSet, CSI-ReportConfig, CSI-ResourceConfig, etc. When/if the higher layer parameter ueInitiatedReporting is set to enabled, the UE 116 could measure the CSI-RS(s) for the UE-initiated/triggered reporting determined according to one or more examples described herein and use/apply the corresponding measurement result(s) to autonomously initiate/trigger the event(s)-based or non-event(s)-based reporting as specified herein in the present disclosure. In addition, the CSI resource setting(s)—and therefore, the corresponding CSI resource set(s) and CSI-RS resource(s) configured therein—for the UE-initiated/triggered reporting could be configured or received or configured to receive the latest in time (e.g., in the latest or most recent slot). Furthermore, the CSI resource setting(s)—and therefore, the corresponding CSI resource set(s) and CSI-RS resource(s) configured therein—for the UE-initiated/triggered reporting could be configured with ‘resourceType’ set to ‘aperiodic’, ‘semiPersistent’ or ‘periodic’. Optionally, a CSI resource setting—and therefore, the corresponding CSI resource set(s) and CSI-RS resource(s) configured/provided therein—could be configured with a first ‘resourceType’ set to ‘aperiodic’, ‘semiPersistent’ or ‘periodic’ and with a second ‘resourceType’ set to ‘networkInitiatedReporting’ or ‘ueInitiatedReporting’; for this case/design example, for instance, when/if the second ‘resourceType’ is set to ‘ueInitiatedReporting’, the UE-initiated/triggered reporting as specified herein in the present disclosure could be enabled such that the UE could follow those specified herein in the present disclosure for the UE-initiated/triggered reporting to measure the corresponding CSI-RSs (whose time-domain behaviors could follow those provided in/by the first ‘resourceType’) and send the corresponding CSI report(s). Alternatively, the UE could receive from or could be provided/indicated/activated/triggered by the network a first CSI resource setting—and therefore, the corresponding CSI resource set(s) and CSI-RS resource(s) configured/provided therein—configured with a ‘resourceType’ set to ‘aperiodic’, ‘semiPersistent’ or ‘periodic’, and a second CSI resource setting—and therefore, the corresponding CSI resource set(s) and CSI-RS resource(s) configured/provided therein—configured with a ‘resourceType’ set to ‘networkInitiatedReporting’ or ‘ueInitiatedReporting’; for this case/design example, for instance, when/if the ‘resourceType’ in the second CSI resource setting is set to ‘ueInitiatedReporting’, the UE-initiated/triggered reporting as specified herein in the present disclosure could be enabled such that the UE could follow those specified herein in the present disclosure for the UE-initiated/triggered reporting to measure the corresponding CSI-RSs (whose time-domain behaviors could follow those provided by ‘resourceType’ in the first CSI resource setting) and send the corresponding CSI report(s). The UE could further identify/determine that the first and second CSI resource settings as specified herein in the present disclosure are associated/linked/related to each other according to: (i) fixed rule(s)/value(s) in the system specification(s), (ii) configuration(s)/indication(s) via or from the network 130, e.g., via higher layer RRC signaling/parameter and/or MAC CE command and/or dynamic DCI based L1 signaling, or (iii) autonomous decision, selection or determination of the UE 116, which could be further sent to the network 130 via uplink channels such as PUCCH/PUSCH.

Additionally, the CSI reporting setting(s) for the UE-initiated/triggered reporting could be configured with ‘reportConfigType’ set to ‘aperiodic’, ‘semiPersistentOnPUCCH’, ‘semiPersistentOnPUSCH’ or ‘periodic’. Optionally, a CSI reporting setting could be configured with a first ‘reportConfigType’ set to ‘aperiodic’, ‘semiPersistentOnPUCCH’, ‘semiPersistentOnPUSCH’ or ‘periodic’ and with a second ‘reportConfigType’ set to ‘networkInitiatedReporting’ or ‘ueInitiatedReporting’; for this case/design example, for instance, when/if the second ‘reportConfigType’ is set to ‘ueInitiatedReporting’, the UE-initiated/triggered reporting as specified herein in the present disclosure could be enabled such that the UE could follow those specified herein in the present disclosure for the UE-initiated/triggered reporting to measure the corresponding CSI-RSs and send the corresponding CSI report(s) according to the value provide in/by the first ‘reportConfigType’. Alternatively, the UE could receive from the network or could be provided/indicated/triggered/activated by the network a first CSI reporting setting configured with a ‘reportConfigType’ set to ‘aperiodic’, ‘semiPersistentOnPUCCH’, ‘semiPersistentOnPUSCH’ or ‘periodic’, and a second CSI reporting setting configured with a ‘reportConfigType’ set to ‘networkInitiatedReporting’ or ‘ueInitiatedReporting’; for this case/design example, for instance, when/if the ‘reportConfigType’ in the second CSI reporting setting is set to ‘ueInitiatedReporting’, the UE-initiated/triggered reporting as specified herein in the present disclosure could be enabled such that the UE could follow those specified herein in the present disclosure for the UE-initiated/triggered reporting to measure the corresponding CSI-RSs and send the corresponding CSI report(s) according to the value provide by the ‘reportConfigType’ in the first CSI reporting setting. The UE could further identify/determine that the first and second CSI reporting settings as specified herein in the present disclosure are associated/linked/related to each other according to: (i) fixed rule(s)/value(s) in the system specification(s), (ii) configuration(s)/indication(s) via or from the network 130, e.g., via higher layer RRC signaling/parameter and/or MAC CE command and/or dynamic DCI based L1 signaling, or (iii) autonomous decision, selection or determination of the UE 116, which could be further sent to the network 130 via uplink channels such as PUCCH/PUSCH.

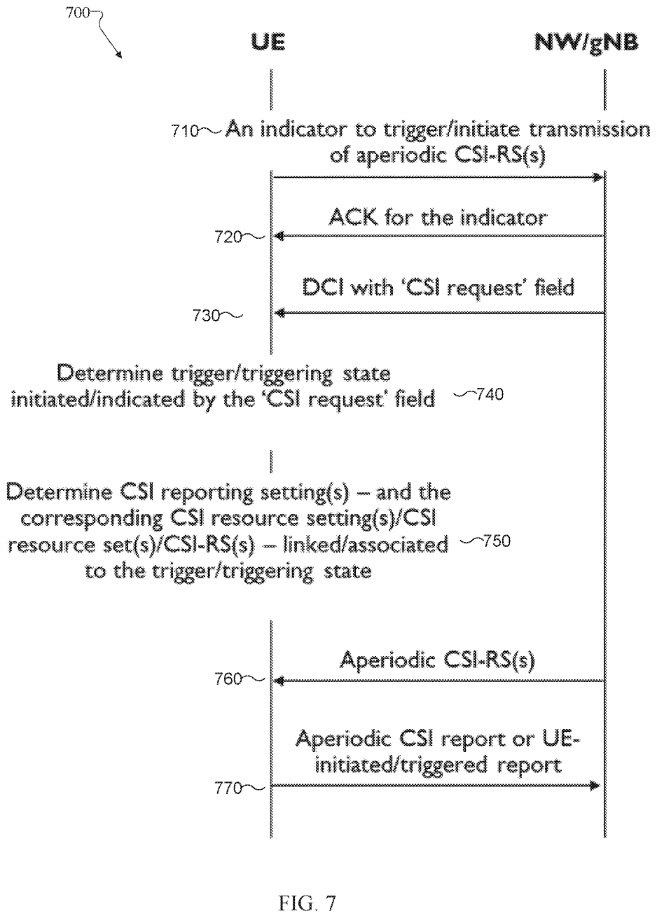

FIG. 7 illustrates an example procedure 700 for UE-initiated/triggered CSI measurement and reporting according to embodiments of the present disclosure. For example, procedure 700 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The procedure begins in 710, the UE 116 sends an indicator to trigger/initiate transmission of aperiodic CSI-RS(s) to the gNB 102 and/or the network 130. In 720, the gNB 102 and/or the network 130 sends an ACL for the indicator to the UE 116. In 730, the gNB 102 and/or the network 130 sends a DCI with ‘CSI request’ field to the UE 116. In 740, the UE 116 determines the trigger/triggering state initiated/indicated by the ‘CSI request’ field. In 750, the UE 116 determines CSI reporting setting(s)—and the corresponding CSI resource setting(s)/CSI resource set(s)/CSI-RS(s)—linked/associated to the trigger/triggering state. In 760, the gNB 102 and/or the network 130 send aperiodic CSI-RS(s) to the UE 116. In 770, the UE 116 send aperiodic CSI report or UE-initiated/triggered report to the gNB 102 and/or the network 130.

In one embodiment, the UE 116 could indicate to the network 130, or send to the network 130 an indicator, to initiate/trigger a transmission of a DCI that schedules aperiodic CSI report(s)—e.g., on PUSCH—by a ‘CSI request’ field in the DCI, and therefore transmission(s) of aperiodic CSI-RS(s)/CSI-RS resource(s). In the present disclosure, the indicator could correspond to the trigger/pre-notification message in a (report-)type (A) based report or a (report-)type (C) based report, or part of the (corresponding) content in a (report-)type (B) based report, or a (report-)type (C) based report.

In one example, the UE 116 may expect to receive from the network 130 an acknowledgement (ACK) (or negative acknowledgement (NACK)) for the indicator within a first time window/offset (e.g., in terms of the number of slots/symbols/etc.) starting from the transmission of the indicator (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the indicator within the first time window/offset starting from the transmission of the indicator or receives a NACK for the indicator within the first time window/offset starting from the transmission of the indicator, the UE 116 could (re-)send the indicator.
When/if the UE 116 receives from the network 130 an ACK for the indicator within the first time window/offset starting from the transmission of the indicator, the UE 116 may expect to receive from the network 130 a DCI that schedules aperiodic CSI report(s)—e.g., on PUSCH—by a ‘CSI request’ field in the DCI within a second time window/offset (e.g., in terms of the number of slots/symbols/etc.) starting from the reception of the ACK message (e.g., starting from the corresponding slot/symbol/etc.). The value of the second time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive from the network 130 a DCI that schedules aperiodic CSI report(s) by the ‘CSI request’ field indicated therein within the second time window/offset starting from the reception of the ACK for the indicator, the UE 116 could (re-)send the indicator. When/if the UE 116 receives from the network 130 a DCI that schedules aperiodic CSI report(s) by the ‘CSI request’ field indicated therein within the second time window/offset starting from the reception of the ACK for the indicator, the UE 116 could first determine a trigger/triggering state initiated/indicated by the ‘CSI request’ field in the DCI.
   The trigger/triggering state—configured using the higher layer parameter CSI-AperiodicTriggerState—initiated/indicated by the ‘CSI request’ field in the DCI could be associated with one or multiple CSI reporting settings each provided by CSI-ReportConfig, wherein a CSI reporting setting provided by CSI-ReportConfig could be linked to one or multiple periodic, semi-persistent, or aperiodic CSI resource settings (and therefore, the corresponding CSI resource set(s) and CSI-RS resource(s) configured/provided therein).
   For the UE-initiated or UE-triggered reporting specified herein in the present disclosure, and for periodic, semi-persistent and aperiodic CSI resource settings, the trigger/triggering state—configured using the higher layer parameter CSI-AperiodicTriggerState—initiated/indicated by the ‘CSI request’ field in the DCI could be associated with one or multiple CSI reporting settings each provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting as specified herein in the present disclosure and for aperiodic CSI resource settings, the trigger/triggering state—configured using the higher layer parameter CSI-AperiodicTriggerState—initiated/indicated by the ‘CSI request’ field in the DCI could be associated with one or multiple CSI reporting settings each provided by CSI-ReportConfig, wherein the one or multiple CSI reporting settings could be associated with resourcesForUeInitiatedReporting, wherein:
      The resourcesForUeInitiatedReporting could correspond to a CSI resource set (enabled) for the UE-initiated/triggered reporting determined according to one or more examples described herein—e.g., the CSI resource set with the higher layer parameter ‘csiResourceSetForUeInitiatedReporting’ set to ‘enabled’.
      The resourcesForUeInitiatedReporting could correspond to or comprise one or more CSI-RS resources for the UE-initiated/triggered reporting determined according to one or more examples described herein.
      The resourcesForUeInitiatedReporting could provide one or more CSI-RS resources (e.g., SSB resources each provided by SSB-Index or NZP CSI-RS resources each provided by NZP-CSI-RS-Resource); the UE 116 could measure the one or more CSI-RS resources provided/configured in resourcesForUeInitiatedReporting and use/apply the corresponding measurement result(s) to autonomously initiate/trigger the event(s)-based or non-event(s)-based reporting as specified herein in the present disclosure.

The UE 116 could then measure the CSI-RS(s) triggered by/associated to the trigger/triggering state as specified herein in the present disclosure and use/apply the corresponding measurement result(s) for the aperiodic CSI reporting or to autonomously initiate/trigger the event(s)-based or non-event(s)-based reporting as specified herein in the present disclosure.

In another example, the UE 116 may not expect to receive from the network 130 an ACK (or NACK) for the indicator. For this case, the UE 116 may expect to receive from the network 130 a DCI that schedules aperiodic CSI report(s)—e.g., on PUSCH—by a ‘CSI request’ field in the DCI within a third time window/offset (e.g., in terms of the number of slots/symbols/etc.) starting from the transmission of the indicator (e.g., starting from the corresponding slot/symbol/etc.). The value of the third time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive from the network 130 a DCI that schedules aperiodic CSI report(s) by the ‘CSI request’ field indicated therein within the third time window/offset starting from the transmission of the indicator, the UE 116 could (re-)send the indicator. When/if the UE 116 receives from the network 130 a DCI that schedules aperiodic CSI report(s) by the ‘CSI request’ field indicated therein within the third time window/offset starting from the transmission of the indicator, the UE 116 could first determine a trigger/triggering state initiated/indicated by the ‘CSI request’ field in the DCI. The UE 116 could then determine the CSI resource setting(s) (and therefore, the corresponding CSI resource set(s) and CSI-RS resource(s) configured/provided therein) according to the linked CSI reporting setting(s) that is associated to the trigger/triggering state—configured using the higher layer parameter CSI-AperiodicTriggerState—initiated/indicated by the ‘CSI request’ field in the DCI according to one or more examples described herein. The UE 116 could measure the CSI-RS(s) triggered by/associated to the trigger/triggering state as specified herein in the present disclosure, and use/apply the corresponding measurement result(s) for the aperiodic CSI reporting or to autonomously initiate/trigger the event(s)-based or non-event(s)-based reporting as specified herein in the present disclosure.

In one embodiment, the UE 116 could indicate to the network 130, or send to the network 130 an indicator, to initiate/trigger transmission(s) of aperiodic CSI-RS(s)/CSI-RS resource(s). In the present disclosure, the indicator could correspond to the trigger/pre-notification message in a (report-)type (A) based report or a (report-)type (C) based report, or part of the (corresponding) content in a (report-)type (B) based report or a (report-)type (C) based report.

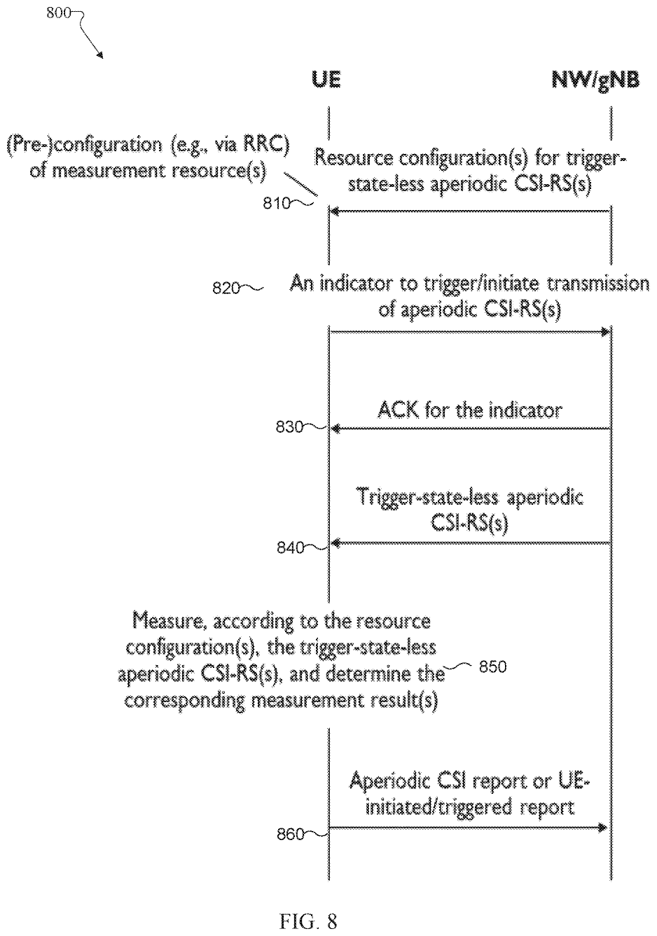

FIG. 8 illustrates an example procedure 800 for UE-initiated/triggered CSI measurement and reporting according to embodiments of the present disclosure. For example, procedure 800 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The procedure begins in 810, the gNB 102 and/or the network 130 sends (pre-) configuration (e.g., via RRC) of measurement resources and/or resource configuration(s) for trigger-state-less aperiodic CSI-RS(s). In 820, the UE 116 sends an indicator to trigger/initiate transmission of aperiodic CSI-RS(s) to the gNB 102 and/or the network 130. In 830, the gNB 102 and/or the network 130 sends an ACK for the indicator to the UE 116. In 840 the gNB 102 and/or the network 130 send trigger-state-less aperiodic CSI-RS(s) to the UE 116. In 850, the UE 116 measures, according to the resource configuration(s), the trigger-state-less aperiodic CSI-S(s) and determines the corresponding measurement result(s). In 860, the UE 116 sends aperiodic CSI report or UE-initiated/triggered report to the gNB 102 and/or the network 130.

In one example, the UE 116 may expect to receive from the network 130 an ACK (or NACK) for the indicator within a first time window/offset (e.g., in terms of the number of slots/symbols/etc.) starting from the transmission of the indicator (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the indicator within the first time window/offset starting from the transmission of the indicator or receives a NACK for the indicator within the first time window/offset starting from the transmission of the indicator, the UE 116 could (re-)send the indicator.
When/if the UE 116 receives from the network 130 an ACK for the indicator within the first time window/offset starting from the transmission of the indicator, the UE 116 could start to measure one or more trigger-state-less aperiodic CSI-RSs within a fourth time window/offset (e.g., in terms of the number of slots/symbols/etc.) starting from the reception of the ACK for the indicator (e.g., starting from the corresponding slot/symbol/etc.). When/if the UE 116 does not receive the trigger-state-less aperiodic CSI-RSs within the fourth time window/offset starting from the reception of the ACK for the indicator, the UE 116 could (re-)send the indicator; otherwise, the UE 116 could use/apply the corresponding measurement result(s) for the aperiodic CSI reporting or to autonomously initiate/trigger the event(s)-based or non-event(s)-based reporting as specified herein in the present disclosure. Furthermore, the UE 116 could be (pre-)configured/indicated/provided by the network 130, e.g., via higher layer RRC signaling/parameter and/or MAC CE command and/or dynamic DCI based L1 signaling, resource configuration(s) including resource mapping for the one or more trigger-state-less aperiodic CSI-RSs. The trigger-state-less aperiodic CSI-RSs may not be triggered/initiated by the ‘CSI request’ field in a DCI, and therefore, the trigger-state-less aperiodic CSI-RSs may not be associated with a trigger/triggering state. The value of the fourth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The resource configuration(s) for the trigger-state-less aperiodic CSI-RSs, for instance, could be provided through one or more CSI reporting settings, one or more CSI resource settings, one or more CSI resource sets and/or one or more CSI-RS resources according to one or more examples described herein. More specifically:
   The resource configuration(s) for the trigger-state-less aperiodic CSI-RSs could be provided through one or multiple CSI reporting settings each provided by CSI-ReportConfig, wherein a CSI reporting setting provided by CSI-ReportConfig could be linked to one or multiple periodic, semi-persistent, or aperiodic CSI resource settings (and therefore, the corresponding CSI resource set(s) and CSI-RS resource(s) configured/provided therein).
   For the UE-initiated or UE-triggered reporting specified herein in the present disclosure, the resource configuration(s) for the trigger-state-less aperiodic CSI-RSs could be provided through one or multiple CSI reporting settings each provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting as specified herein in the present disclosure, the resource configuration(s) for the trigger-state-less aperiodic CSI-RSs could be provided through one or multiple CSI reporting settings each provided by CSI-ReportConfig, wherein the one or multiple CSI reporting settings could be associated with resourcesForUeInitiatedReporting, wherein:
      The resourcesForUeInitiatedReporting could correspond to a CSI resource set (enabled) for the UE-initiated/triggered reporting determined according to one or more examples described herein—e.g., the CSI resource set with the higher layer parameter ‘csiResourceSetForUeInitiatedReporting’ set to ‘enabled’.
      The resourcesForUeInitiatedReporting could correspond to or comprise one or more CSI-RS resources for the UE-initiated/triggered reporting determined according to one or more examples described herein.
      The resourcesForUeInitiatedReporting could provide one or more CSI-RS resources (e.g., SSB resources each provided by SSB-Index or NZP CSI-RS resources each provided by NZP-CSI-RS-Resource); the UE 116 could measure the one or more CSI-RS resources provided/configured in resourcesForUeInitiatedReporting, and use/apply the corresponding measurement result(s) to autonomously initiate/trigger the event(s)-based or non-event(s)-based reporting as specified herein in the present disclosure.
   For the UE-initiated or UE-triggered reporting specified herein in the present disclosure, the resource configuration(s) for the trigger-state-less CSI-RSs could be provided through one or multiple CSI resource settings each provided by CSI-Resource Config, one or multiple CSI resource sets each provided by CSI-SSB-ResourceSet or NZP-CSI-ResourceSet, or one or multiple CSI-RS resources each provided by SSB-Index or NZP-CSI-RS-Resource, wherein:
      The one or multiple CSI resource settings/CSI resource sets/CSI-RS resources could be linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI resource settings could correspond to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI resource sets could correspond to one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI-RS resources could correspond to one or more CSI-RS resources for the UE-initiated/triggered reporting determined according to one or more examples described herein.

The UE 116 could then measure the trigger-state-less aperiodic CSI-RS(s) as specified herein in the present disclosure and use/apply the corresponding measurement result(s) for the aperiodic CSI reporting or to autonomously initiate/trigger the event(s)-based or non-event(s)-based reporting as specified herein in the present disclosure.

In another example, the UE 116 may not expect to receive from the network 130 an ACK (or NACK) for the indicator. For this case, the UE 116 could start to measure one or more trigger-state-less aperiodic CSI-RSs within a fifth time window/offset (e.g., in terms of the number of slots/symbols/etc.) starting from the transmission of the indicator (e.g., starting from the corresponding slot/symbol/etc.). When/if the UE 116 does not receive the trigger-state-less aperiodic CSI-RSs within the fifth time window/offset starting from the transmission of the indicator, the UE 116 could (re-)send the indicator; otherwise, the UE 116 could use/apply the corresponding measurement result(s) for the aperiodic CSI reporting or to autonomously initiate/trigger the event(s)-based or non-event(s)-based reporting as specified herein in the present disclosure. Furthermore, the UE 116 could be (pre-)configured/indicated/provided by the network 130, e.g., via higher layer RRC signaling/parameter and/or MAC CE command and/or dynamic DCI based L1 signaling, resource configuration(s) including resource mapping for the one or more trigger-state-less aperiodic CSI-RSs. The trigger-state-less aperiodic CSI-RSs may not be triggered/initiated by the ‘CSI request’ field in a DCI, and therefore, the trigger-state-less aperiodic CSI-RSs may not be associated with a trigger/triggering state. The value of the fifth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The resource configuration(s) for the trigger-state-less aperiodic CSI-RSs, for instance, could be provided through one or more CSI reporting settings, one or more CSI resource settings, one or more CSI resource sets and/or one or more CSI-RS resources according to one or more examples described herein. The UE 116 could then measure the trigger-state-less aperiodic CSI-RS(s) as specified herein in the present disclosure and use/apply the corresponding measurement result(s) for the aperiodic CSI reporting or to autonomously initiate/trigger the event(s)-based or non-event(s)-based reporting as specified herein in the present disclosure.

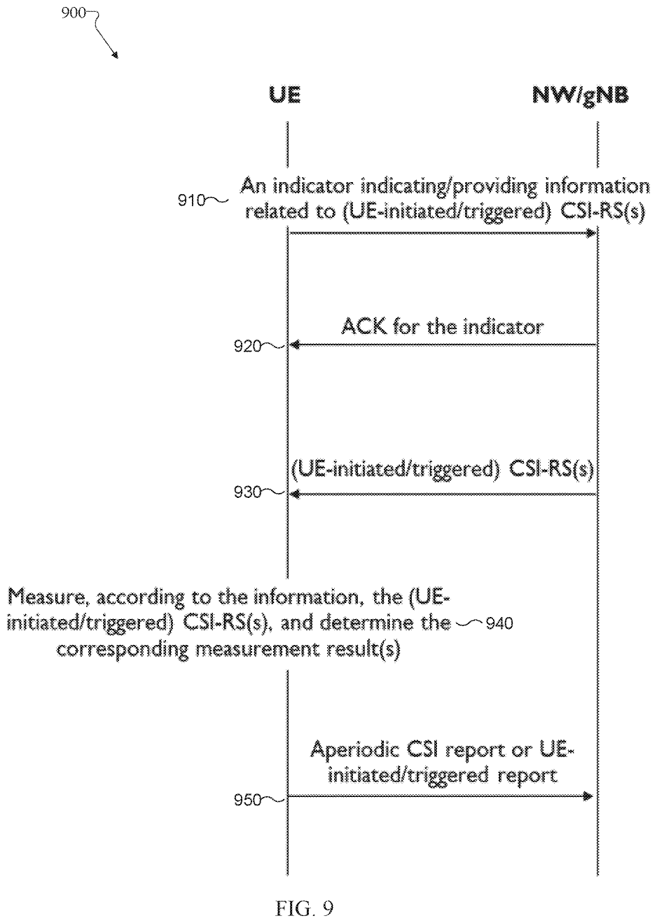

FIG. 9 illustrates an example procedure 900 for UE-initiated/triggered CSI measurement and reporting according to embodiments of the present disclosure. For example, procedure 900 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The procedure begins in 910, the UE 116 sends an indicator indicating/providing information related to (UE-initiated/triggered) CSI-RS(s) to the gNB 102 and/or the network 130. In 920, the gNB 102 and/or the network 130 sends an ACK for the indicator to the UE 116. In 930, the gNB 102 and/or the network 130 sends (UE-initiated/triggered) CSI-RS(s) to the UE 116. In 940, the UE 116 measures, according to the information, the (UE-initiated/triggered) CSI-RS(s) and determines the corresponding measurement result(s). In 950, the UE 116 sends aperiodic CSI report or UE-initiated/triggered report to the gNB 102 and/or the network 130.

In one embodiment, the UE 116 could indicate to the network 130, or send to the network 130 an indicator, to provide/indicate information related to one or more (UE-initiated/triggered) CSI-RS resources for (aperiodic) CSI reporting or UE-initiated/triggered reporting as specified herein in the present disclosure. For example, the information could include/contain a trigger state in CSI-AperiodicTriggerStateList containing a list of associated CSI reporting settings each provided by CSI-ReportConfig. For another example, the information could include/contain one or more CSI reporting settings/CSI reporting setting IDs, wherein a CSI reporting setting could be provided by CSI-ReportConfig. Yet for another example, the information could include/contain one or more CSI resource settings/CSI resource setting IDs, wherein a CSI resource setting could be provided by CSI-ResourceConfig. Yet for another example, the information could include/contain one or more CSI resource sets/CSI resource set IDs, wherein a CSI resource set could be provided by CSI-SSB-ResourceSet or NZP-CSI-RS-ResourceSet. Yet for another example, the information could include/contain one or more CSI-RS resources/CSI-RS resource indexes/IDs, wherein a CSI-RS resource could correspond to a SSB provided by SSB-Index or a NZP CSI-RS resource provided by nzp-CSI-RS-Resource. In the present disclosure, the indicator could correspond to the trigger/pre-notification message in a (report-)type (A) based report or a (report-)type (C) based report, or part of the (corresponding) content in a (report-)type (B) based report or a (report-)type (C) based report.

In one example, the UE 116 may expect to receive from the network 130 an ACK (or NACK) for the indicator within a first time window/offset (e.g., in terms of the number of slots/symbols/etc.) starting from the transmission of the indicator (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the indicator within the first time window/offset starting from the transmission of the indicator or receives a NACK for the indicator within the first time window/offset starting from the transmission of the indicator, the UE 116 could (re-)send the indicator.
When/if the UE 116 receives from the network 130 an ACK for the indicator within the first time window/offset starting from the transmission of the indicator, the UE 116 could start to measure one or more UE-initiated/triggered CSI-RSs within a fourth time window/offset (e.g., in terms of the number of slots/symbols/etc.) starting from the reception of the ACK for the indicator (e.g., starting from the corresponding slot/symbol/etc.), wherein the information related to the one or more UE-initiated/triggered CSI-RS resources is provided/indicated to the network 130 by/via the indicator. When/if the UE 116 does not receive the UE 116-initiated/triggered CSI-RSs within the fourth time window/offset starting from the reception of the ACK for the indicator, the UE 116 could (re-)send the indicator; otherwise, the UE 116 could use/apply the corresponding measurement result(s) for the aperiodic CSI reporting or to autonomously initiate/trigger the event(s)-based or non-event(s)-based reporting as specified herein in the present disclosure. The value of the fourth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. As discussed herein, the information related to the UE-initiated/triggered CSI-RS(s)—indicated/provided to the network 130 by/via the indicator—could include/contain one or more CSI reporting settings, one or more CSI resource settings, one or more CSI resource sets, and/or one or more CSI-RS resources according to one or more examples described herein. More specifically:
   The information related to the UE-initiated/triggered CSI-RSs could include/contain one or multiple CSI reporting settings or a trigger state containing one or multiple CSI reporting settings with each CSI reporting setting provided by CSI-ReportConfig, wherein a CSI reporting setting could be linked to one or multiple periodic, semi-persistent, or aperiodic CSI resource settings (and therefore, the corresponding CSI resource set(s) and CSI-RS resource(s) configured/provided therein).
   For the UE-initiated or UE-triggered reporting specified herein in the present disclosure, the information related to the UE-initiated/triggered CSI-RSs could include/contain one or multiple CSI reporting settings or a trigger state containing one or multiple CSI reporting settings with each CSI reporting setting provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting as specified herein in the present disclosure, the information related to the UE-initiated/triggered CSI-RSs could include/contain one or multiple CSI reporting settings each provided by CSI-ReportConfig, wherein the one or multiple CSI reporting settings could be associated with resourcesForUeInitiatedReporting, wherein:
      The resourcesForUeInitiatedReporting could correspond to a CSI resource set (enabled) for the UE-initiated/triggered reporting determined according to one or more examples described herein—e.g., the CSI resource set with the higher layer parameter ‘csiResourceSetForUeInitiatedReporting’ set to ‘enabled’.
      The resourcesForUeInitiatedReporting could correspond to or comprise one or more CSI-RS resources for the UE-initiated/triggered reporting determined according to one or more examples described herein.
      The resourcesForUeInitiatedReporting could provide one or more CSI-RS resources (e.g., SSB resources each provided by SSB-Index or NZP CSI-RS resources each provided by NZP-CSI-RS-Resource); the UE 116 could measure the one or more CSI-RS resources provided/configured in resourcesForUeInitiatedReporting and use/apply the corresponding measurement result(s) to autonomously initiate/trigger the event(s)-based or non-event(s)-based reporting as specified herein in the present disclosure.
   For the UE-initiated or UE-triggered reporting specified herein in the present disclosure, the information related to the UE-initiated/triggered CSI-RSs could include/contain one or multiple CSI resource settings each provided by CSI-ResourceConfig, one or multiple CSI resource sets each provided by CSI-SSB-ResourceSet or NZP-CSI-ResourceSet, or one or multiple CSI-RS resources each provided by SSB-Index or NZP-CSI-RS-Resource, wherein:
      The one or multiple CSI resource settings/CSI resource sets/CSI-RS resources could be linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI resource settings could correspond to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI resource sets could correspond to one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI-RS resources could correspond to one or more CSI-RS resources for the UE-initiated/triggered reporting determined according to one or more examples described herein.

The UE 116 could then measure the UE-initiated/triggered CSI-RS(s) as specified herein in the present disclosure, and use/apply the corresponding measurement result(s) for the aperiodic CSI reporting or to autonomously initiate/trigger the event(s)-based or non-event(s)-based reporting as specified herein in the present disclosure.

In another example, the UE 116 may not expect to receive from the network 130 an ACK (or NACK) for the indicator. For this case, the UE 116 could start to measure one or more UE-initiated/triggered CSI-RSs within a fifth time window/offset (e.g., in terms of the number of slots/symbols/etc.) starting from the transmission of the indicator (e.g., starting from the corresponding slot/symbol/etc.). When/if the UE 116 does not receive the UE-initiated/triggered CSI-RSs within the fifth time window/offset starting from the transmission of the indicator, the UE 116 could (re-)send the indicator; otherwise, the UE 116 could use/apply the corresponding measurement result(s) for the aperiodic CSI reporting or to autonomously initiate/trigger the event(s)-based or non-event(s)-based reporting as specified herein in the present disclosure. The value of the fifth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The information related to the (UE-initiated/triggered) CSI-RSs—provided/indicated to the network 130 via/by the indicator, for instance, could include/contain a trigger state containing one or more CSI reporting settings, one or more CSI reporting settings, one or more CSI resource settings, one or more CSI resource sets, and/or one or more CSI-RS resources according to one or more examples described herein. The UE 116 could then measure the UE-initiated/triggered CSI-RS(s) as specified herein in the present disclosure and use/apply the corresponding measurement result(s) for the aperiodic CSI reporting or to autonomously initiate/trigger the event(s)-based or non-event(s)-based reporting as specified herein in the present disclosure.

As discussed herein, the indicator, as specified herein in the present disclosure, could indicate/provide to the network one or more of: (i) an indication to initiate/trigger a transmission of a DCI that schedules aperiodic CSI report(s)—e.g., on PUSCH—by a ‘CSI request’ field in the DCI, (ii) an indication to initiate/trigger transmission(s) of trigger-state-less (aperiodic) CSI-RS(s)/CSI-RS resource(s), and (iii) information related to one or more (UE-initiated/triggered) CSI-RSs. Hence, the UE 116 could follow one or more examples described herein to determine resource configuration(s) for the (aperiodic or UE-initiated/triggered) CSI-RS(s), measure, according to the resource configuration(s), the (aperiodic or UE-initiated/triggered) CSI-RS(s), and use/apply the corresponding measurement result(s) for the aperiodic CSI reporting or the UE-initiated/triggered reporting as specified herein in the present disclosure. Furthermore, the signaling medium/container for reporting the indicator as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UCI, etc. Optionally:
For a first setting (i.e., UE-initiated/triggered/activated), the UE 116 could follow one or more examples described herein to determine resource configuration(s) for the (aperiodic or UE-initiated/triggered) CSI-RS(s), measure, according to the resource configuration(s), the (aperiodic or UE-initiated/triggered) CSI-RS(s), and use/apply the corresponding measurement result(s) for the aperiodic CSI reporting or the UE-initiated/triggered reporting as specified herein in the present disclosure.
For a second setting (i.e., NW-configured/indicated/provided), the UE 116 could follow the ‘CSI request’ field in the DCI, and therefore, the corresponding/associated trigger state to determine resource configuration(s) for the (aperiodic or UE-initiated/triggered) CSI-RS(s), measure, according to the resource configuration(s), the (aperiodic or UE-initiated/triggered) CSI-RS(s), and use/apply the corresponding measurement result(s) for the aperiodic CSI reporting or the UE-initiated/triggered reporting as specified herein in the present disclosure.

In the present disclosure, the first and/or second settings could correspond to various target application scenarios such as D2D, side-link (SL) communications, etc.; alternatively, the first and/or second settings could correspond to various system configurations. Furthermore, the UE 116 could be configured/indicated/provided by the network, e.g., via higher layer RRC signaling/parameter and/or MAC CE command and/or dynamic DCI based L1 signaling, the first and/or second settings (e.g., either the first setting or the second setting, or both the first and second settings).

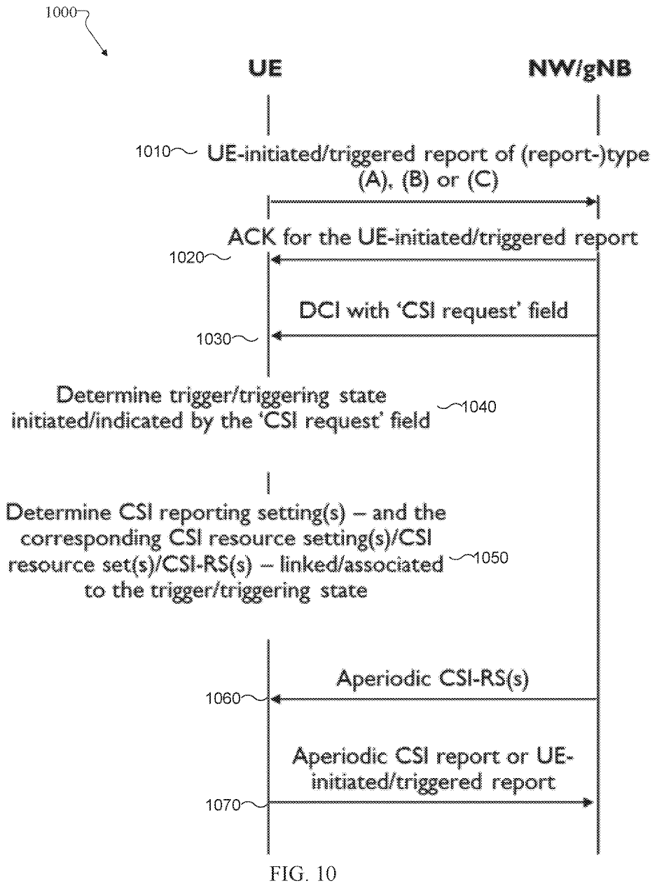

FIG. 10 illustrates an example procedure 1000 for UE-initiated/triggered CSI measurement and reporting according to embodiments of the present disclosure. For example, procedure 1000 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The procedure begins in 1010, the UE 116 sends UE-initiated/triggered report of (report-)type (A), (B), or (C) to the gNB 102 and/or the network 130. In 1020, the gNB 102 and/or the network 130 sends an ACK for the UE-initiated/triggered report to the UE 116. In 1030, the gNB 102 and/or the network 130 sends a DCI with ‘CSI request’ field to the UE 116. In 1040, the UE 116 determines trigger/triggering state initiated/indicated by the ‘CSI request’ field. In 1050, the UE 116 determines CSI reporting setting(s)—and the corresponding CSI resource setting(s)/CSI resource ser(s)/CSI-RS(s)—linked/associated to the trigger/triggering state. In 1060, the gNB 102 and/or the network 130 sends aperiodic CSI-RS(s) to the UE 116. In 1070, the UE 116 sends aperiodic CSI report or UE-initiated/triggered report to the gNB 102 and/or the network 130.

In one embodiment, as specified herein in the present disclosure, a UE could transmit/send to the network 130 a UE-initiated/UE-triggered report (or initiation/triggering) of a (report-)type (A), (B), or (C). Here, the UE-initiated/triggered report could also initiate/trigger a transmission of a DCI that schedules aperiodic CSI report(s)—e.g., on PUSCH—by a ‘CSI request’ field in the DCI, and therefore, transmission(s) of aperiodic CSI-RS(s)/CSI-RS resource(s).

In one example, the UE 116 may expect to receive from the network 130 an ACK (or NACK) for the UE-initiated/triggered report within a first time window/offset (e.g., in terms of the number of slots/symbols/etc.) starting from the transmission of the (last symbol of) UE-initiated/triggered report (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the UE-initiated/triggered report within the first time window/offset starting from the transmission of the (last symbol of) UE-initiated/triggered report or receives a NACK for the UE-initiated/triggered report within the first time window/offset starting from the transmission of the (last symbol of) UE-initiated/triggered report, the UE 116 could (re-)send/transmit the UE-initiated/triggered report.
When/if the UE 116 receives from the network 130 an ACK for the UE-initiated/triggered report within the first time window/offset starting from the transmission of the (last symbol of) UE-initiated/triggered report, the UE 116 may expect to receive from the network 130 a DCI that schedules aperiodic CSI report(s)—e.g., on PUSCH—by a ‘CSI request’ field in the DCI within a second time window/offset (e.g., in terms of the number of slots/symbols/etc.) starting from the reception of the ACK message (e.g., starting from the corresponding slot/symbol/etc.). The value of the second time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive from the network 130 a DCI that schedules aperiodic CSI report(s) by the ‘CSI request’ field indicated therein within the second time window/offset starting from the reception of the ACK for the UE-initiated/triggered report, the UE 116 could (re-)send/transmit the UE-initiated/triggered report. When/if the UE 116 receives from the network 130 a DCI that schedules aperiodic CSI report(s) by the ‘CSI request’ field indicated therein within the second time window/offset starting from the reception of the ACK for the UE-initiated/triggered report, the UE 116 could first determine a trigger/triggering state initiated/indicated by the ‘CSI request’ field in the DCI.
   The trigger/triggering state—configured using the higher layer parameter CSI-AperiodicTriggerState—initiated/indicated by the ‘CSI request’ field in the DCI could be associated with one or multiple CSI reporting settings each provided by CSI-ReportConfig, wherein a CSI reporting setting provided by CSI-ReportConfig could be linked to one or multiple periodic, semi-persistent, or aperiodic CSI resource settings (and therefore, the corresponding CSI resource set(s) and CSI-RS resource(s) configured/provided therein).
   For the UE-initiated or UE-triggered reporting specified herein in the present disclosure, and for periodic, semi-persistent and aperiodic CSI resource settings, the trigger/triggering state—configured using the higher layer parameter CSI-AperiodicTriggerState—initiated/indicated by the ‘CSI request’ field in the DCI could be associated with one or multiple CSI reporting settings each provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting as specified herein in the present disclosure, and for aperiodic CSI resource settings, the trigger/triggering state—configured using the higher layer parameter CSI-AperiodicTriggerState—initiated/indicated by the ‘CSI request’ field in the DCI could be associated with one or multiple CSI reporting settings each provided by CSI-ReportConfig, wherein the one or multiple CSI reporting settings could be associated with resourcesForUeInitiatedReporting, wherein:
      The resourcesForUeInitiatedReporting could correspond to a CSI resource set (enabled) for the UE-initiated/triggered reporting determined according to one or more examples described herein—e.g., the CSI resource set with the higher layer parameter ‘csiResourceSetForUeInitiatedReporting’ set to ‘enabled’.
      The resourcesForUeInitiatedReporting could correspond to or comprise one or more CSI-RS resources for the UE-initiated/triggered reporting determined according to one or more examples described herein.
      The resourcesForUeInitiatedReporting could provide one or more CSI-RS resources (e.g., SSB resources each provided by SSB-Index or NZP CSI-RS resources each provided by NZP-CSI-RS-Resource); the UE 116 could measure the one or more CSI-RS resources provided/configured in resourcesForUeInitiatedReporting, and use/apply the corresponding measurement result(s) to autonomously initiate/trigger the event(s)-based or non-event(s)-based reporting as specified herein in the present disclosure.

The UE 116 could then measure the CSI-RS(s) triggered by/associated to the trigger/triggering state as specified herein in the present disclosure and use/apply the corresponding measurement result(s) for the aperiodic CSI reporting or to autonomously initiate/trigger the event(s)-based or non-event(s)-based reporting as specified herein in the present disclosure.

In another example, the UE 116 may not expect to receive from the network 130 an ACK (or NACK) for the UE-initiated/triggered report of (report-)type (A), (B) or (C) as specified herein in the present disclosure. For this case, the UE 116 may expect to receive from the network 130 a DCI that schedules aperiodic CSI report(s)—e.g., on PUSCH—by a ‘CSI request’ field in the DCI within a third time window/offset (e.g., in terms of the number of slots/symbols/etc.) starting from the transmission of the (last symbol of) the UE-initiated/triggered report (e.g., starting from the corresponding slot/symbol/etc.). The value of the third time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive from the network 130 a DCI that schedules aperiodic CSI report(s) by the ‘CSI request’ field indicated therein within the third time window/offset starting from the transmission of the (last symbol of) UE-initiated/triggered report, the UE 116 could (re-)send/transmit the UE-initiated/triggered report. When/if the UE 116 receives from the network 130 a DCI that schedules aperiodic CSI report(s) by the ‘CSI request’ field indicated therein within the third time window/offset starting from the transmission of the (last symbol of) UE-initiated/triggered report, the UE 116 could first determine a trigger/triggering state initiated/indicated by the ‘CSI request’ field in the DCI. the UE 116 could then determine the CSI resource setting(s) (and therefore, the corresponding CSI resource set(s) and CSI-RS resource(s) configured/provided therein) according to the linked CSI reporting setting(s) that is associated to the trigger/triggering state—configured using the higher layer parameter CSI-AperiodicTriggerState—initiated/indicated by the ‘CSI request’ field in the DCI according to one or more examples described herein. The UE 116 could measure the CSI-RS(s) triggered by/associated to the trigger/triggering state as specified herein in the present disclosure, and use/apply the corresponding measurement result(s) for the aperiodic CSI reporting or to autonomously initiate/trigger the event(s)-based or non-event(s)-based reporting as specified herein in the present disclosure.

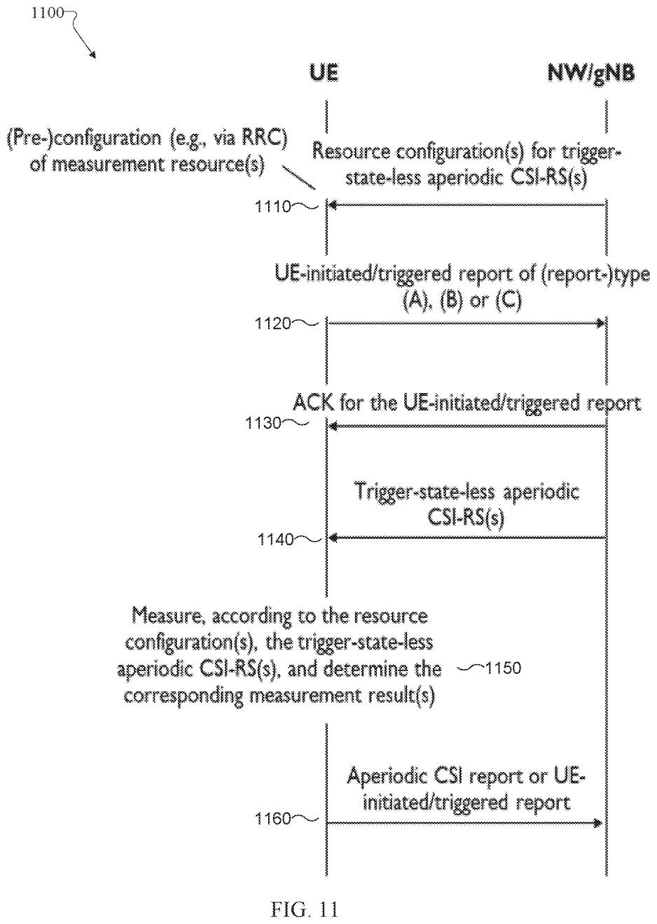

FIG. 11 illustrates an example procedure 1100 for UE-initiated/triggered CSI measurement and reporting according to embodiments of the present disclosure. For example, procedure 1100 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The procedure begins in 1110, the gNB 102 and/or the network 130 sends (pre-) configuration (e.g., via RRC) of measurement resource(s) and/or resource configuration(s) for trigger-state-less aperiodic CSI-RS(s) to the UE 116. In 1120, the UE 116 sends UE-initiated/triggered report of (report-)type (A), (B), or (C) to the gNB 102 and/or the network 130. In 1130, the gNB 102 and/or the network 130 send an ACK for the UE-initiated/triggered report to the UE 116. In 1140, the gNB 102 and/or the network 130 send trigger-state-less aperiodic CSI-RS(s) to the UE 116. In 1150, the UE 116 measures, according to the resource configuration(s), the trigger-state-less aperiodic CSI-RS(s) and determines the corresponding measurement result(s). In 1160, the UE 116 sends aperiodic CSI report or UE-initiated/triggered report to the gNB 102 and/or the network 130.

In one embodiment, as specified herein in the present disclosure, a UE could transmit/send to the network 130 a UE-initiated/UE-triggered report (or initiation/triggering) of a (report-)type (A), (B), or (C). Here, the UE-initiated/triggered report could also initiate/trigger transmission(s) of aperiodic CSI-RS(s)/CSI-RS resource(s).

In one example, the UE 116 may expect to receive from the network 130 an ACK (or NACK) for the UE-initiated/triggered report within a first time window/offset (e.g., in terms of the number of slots/symbols/etc.) starting from the transmission of the (last symbol of) UE-initiated/triggered report (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the UE-initiated/triggered report within the first time window/offset starting from the transmission of the (last symbol of) UE-initiated/triggered report or receives a NACK for the UE-initiated/triggered report within the first time window/offset starting from the transmission of the (last symbol of) UE-initiated/triggered report, the UE 116 could (re-)send/transmit the UE-initiated/triggered report.
When/if the UE 116 receives from the network 130 an ACK for the UE-initiated/triggered report within the first time window/offset starting from the transmission of the (last symbol of) UE-initiated/triggered report, the UE 116 could start to measure one or more trigger-state-less aperiodic CSI-RSs within a fourth time window/offset (e.g., in terms of the number of slots/symbols/etc.) starting from the reception of the ACK for the UE-initiated/triggered report (e.g., starting from the corresponding slot/symbol/etc.). When/if the UE 116 does not receive the trigger-state-less aperiodic CSI-RSs within the fourth time window/offset starting from the reception of the ACK for the UE-initiated/triggered report, the UE 116 could (re-)send/transmit the UE-initiated/triggered report; otherwise, the UE 116 could use/apply the corresponding measurement result(s) for the aperiodic CSI reporting or to autonomously initiate/trigger the event(s)-based or non-event(s)-based reporting as specified herein in the present disclosure. Furthermore, the UE 116 could be (pre-)configured/indicated/provided by the network 130, e.g., via higher layer RRC signaling/parameter and/or MAC CE command and/or dynamic DCI based L1 signaling, resource configuration(s) including resource mapping for the one or more trigger-state-less aperiodic CSI-RSs. The trigger-state-less aperiodic CSI-RSs may not be triggered/initiated by the ‘CSI request’ field in a DCI, and therefore, the trigger-state-less aperiodic CSI-RSs may not be associated with a trigger/triggering state. The value of the fourth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The resource configuration(s) for the trigger-state-less aperiodic CSI-RSs, for instance, could be provided through one or more CSI reporting settings, one or more CSI resource settings, one or more CSI resource sets, and/or one or more CSI-RS resources according to one or more examples described herein. More specifically:
   The resource configuration(s) for the trigger-state-less aperiodic CSI-RSs could be provided through one or multiple CSI reporting settings each provided by CSI-ReportConfig, wherein a CSI reporting setting provided by CSI-ReportConfig could be linked to one or multiple periodic, semi-persistent, or aperiodic CSI resource settings (and therefore, the corresponding CSI resource set(s) and CSI-RS resource(s) configured/provided therein).
   For the UE-initiated or UE-triggered reporting specified herein in the present disclosure, the resource configuration(s) for the trigger-state-less aperiodic CSI-RSs could be provided through one or multiple CSI reporting settings each provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting as specified herein in the present disclosure, the resource configuration(s) for the trigger-state-less aperiodic CSI-RSs could be provided through one or multiple CSI reporting settings each provided by CSI-ReportConfig, wherein the one or multiple CSI reporting settings could be associated with resourcesForUeInitiatedReporting, wherein:
      The resourcesForUeInitiatedReporting could correspond to a CSI resource set (enabled) for the UE-initiated/triggered reporting determined according to one or more examples described herein—e.g., the CSI resource set with the higher layer parameter ‘csiResourceSetForUeInitiatedReporting’ set to ‘enabled’.
      The resourcesForUeInitiatedReporting could correspond to or comprise one or more CSI-RS resources for the UE-initiated/triggered reporting determined according to one or more examples described herein.
      The resourcesForUeInitiatedReporting could provide one or more CSI-RS resources (e.g., SSB resources each provided by SSB-Index or NZP CSI-RS resources each provided by NZP-CSI-RS-Resource); the UE 116 could measure the one or more CSI-RS resources provided/configured in resourcesForUeInitiatedReporting and use/apply the corresponding measurement result(s) to autonomously initiate/trigger the event(s)-based or non-event(s)-based reporting as specified herein in the present disclosure.
   For the UE-initiated or UE-triggered reporting as specified herein in the present disclosure, the resource configuration(s) for the trigger-state-less aperiodic CSI-RSs could be provided through one or multiple CSI resource settings each provided by CSI-ResourceConfig, one or multiple CSI resource sets each provided by CSI-SSB-ResourceSet or NZP-CSI-ResourceSet, or one or multiple CSI-RS resources each provided by SSB-Index or NZP-CSI-RS-Resource, wherein:
      The one or multiple CSI resource settings/CSI resource sets/CSI-RS resources could be linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI resource settings could correspond to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI resource sets could correspond to one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI-RS resources could correspond to one or more CSI-RS resources for the UE-initiated/triggered reporting determined according to one or more examples described herein.

The UE 116 could then measure the trigger-state-less aperiodic CSI-RS(s) as specified herein in the present disclosure and use/apply the corresponding measurement result(s) for the aperiodic CSI reporting or to autonomously initiate/trigger the event(s)-based or non-event(s)-based reporting as specified herein in the present disclosure.

In another example, the UE 116 may not expect to receive from the network 130 an ACK (or NACK) for the UE-initiated/triggered report of (report-)type (A), (B) or (C). For this case, the UE 116 could start to measure one or more trigger-state-less aperiodic CSI-RSs within a fifth time window/offset (e.g., in terms of the number of slots/symbols/etc.) starting from the transmission of the (last symbol of) UE-initiated/triggered report (e.g., starting from the corresponding slot/symbol/etc.). When/if the UE 116 does not receive the trigger-state-less aperiodic CSI-RSs within the fifth time window/offset starting from the transmission of the (last symbol of) UE-initiated/triggered report, the UE 116 could (re-)send/transmit the UE-initiated/triggered report; otherwise, the UE 116 could use/apply the corresponding measurement result(s) for the aperiodic CSI reporting or to autonomously initiate/trigger the event(s)-based or non-event(s)-based reporting as specified herein in the present disclosure. Furthermore, the UE 116 could be (pre-)configured/indicated/provided by the network 130, e.g., via higher layer RRC signaling/parameter and/or MAC CE command and/or dynamic DCI based L1 signaling, resource configuration(s) including resource mapping for the one or more trigger-state-less aperiodic CSI-RSs. The trigger-state-less aperiodic CSI-RSs may not be triggered/initiated by the ‘CSI request’ field in a DCI, and therefore, the trigger-state-less aperiodic CSI-RSs may not be associated with a trigger/triggering state. The value of the fifth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The resource configuration(s) for the trigger-state-less aperiodic CSI-RSs, for instance, could be provided through one or more CSI reporting settings, one or more CSI resource settings, one or more CSI resource sets, and/or one or more CSI-RS resources according to one or more examples described herein. The UE 116 could then measure the trigger-state-less aperiodic CSI-RS(s) as specified herein in the present disclosure and use/apply the corresponding measurement result(s) for the aperiodic CSI reporting or to autonomously initiate/trigger the event(s)-based or non-event(s)-based reporting as specified herein in the present disclosure.

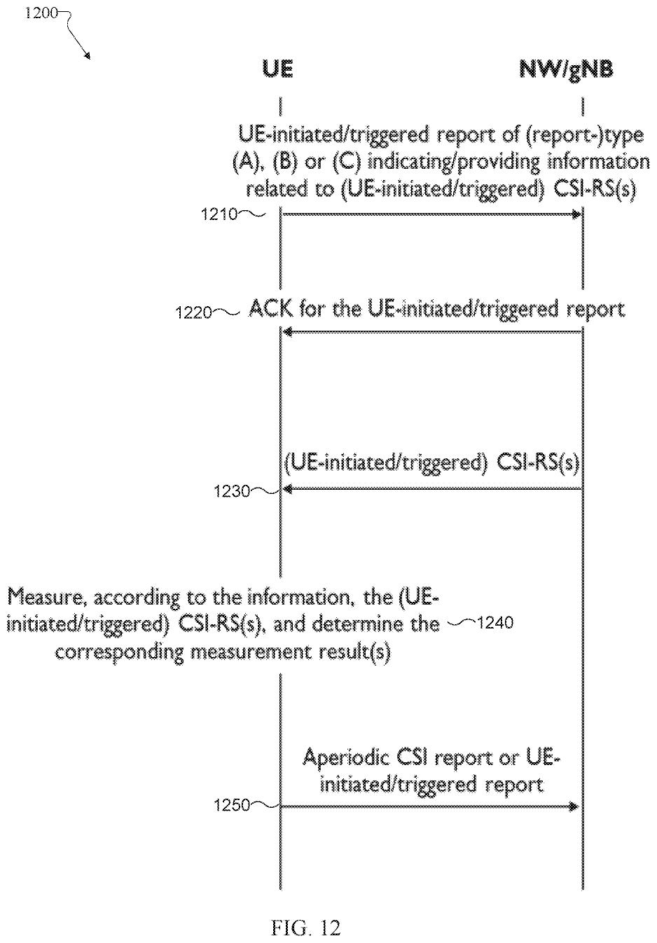

FIG. 12 illustrates an example procedure 1200 for UE-initiated/triggered CSI measurement and reporting according to embodiments of the present disclosure. For example, procedure 1200 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The procedure begins in 1210, the UE 116 sends UE-initiated/triggered report of (report-)type (A), (B), or (C) indicating/providing information related to (UE-initiated/triggered) CSI-RS(s) to the gNB 102 and/or the network 130. In 1220, the gNB 102 and/or the network 130 sends an ACK for the UE-initiated/triggered report the UE 116. In 1230, the gNB 102 and/or the network 130 sends (UE-initiated/triggered) CSI-RS(s) to the UE 116. In 1240, the UE measures, according to the information, the (UE-initiated/triggered) CSI-RS(s) and determines the corresponding measurement result(s). In 1250, the UE 116 sends aperiodic CSI report or UE-initiated/triggered report to the gNB 102 and/or the network 130.

In one embodiment, as specified herein in the present disclosure, a UE could transmit/send to the network 130 a UE-initiated/UE-triggered report (or initiation/triggering) of a (report-)type (A), (B), or (C). Here, the UE-initiated/triggered report could provide/indicate information related to one or more (UE-initiated/triggered) CSI-RS resources for (aperiodic) CSI reporting or UE-initiated/triggered reporting as specified herein in the present disclosure. For example, the information could include/contain a trigger state in CSI-AperiodicTriggerStateList containing a list of associated CSI reporting settings each provided by CSI-ReportConfig. For another example, the information could include/contain one or more CSI reporting settings/CSI reporting setting IDs, wherein a CSI reporting setting could be provided by CSI-ReportConfig. Yet for another example, the information could include/contain one or more CSI resource settings/CSI resource setting IDs, wherein a CSI resource setting could be provided by CSI-ResourceConfig. Yet for another example, the information could include/contain one or more CSI resource sets/CSI resource set IDs, wherein a CSI resource set could be provided by CSI-SSB-ResourceSet or NZP-CSI-RS-ResourceSet. Yet for another example, the information could include/contain one or more CSI-RS resources/CSI-RS resource indexes/IDs, wherein a CSI-RS resource could correspond to a SSB provided by SSB-Index or a NZP CSI-RS resource provided by nzp-CSI-RS-Resource.

In one example, the UE 116 may expect to receive from the network 130 an ACK (or NACK) for the UE-initiated/triggered report that carries/provides/indicates the information related to the UE-initiated/triggered CSI-RS(s) within a first time window/offset (e.g., in terms of the number of slots/symbols/etc.) starting from the transmission of the (last symbol of) UE-initiated/triggered report (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE does not receive from the network 130 an ACK for the UE-initiated/triggered report that carries/provides/indicates the information related to the UE-initiated/triggered CSI-RS(s) within the first time window/offset starting from the transmission of the (last symbol of) UE-initiated/triggered report or receives a NACK for the UE-initiated/triggered report that carries/provides/indicates the information related to the UE-initiated/triggered CSI-RS(s) within the first time window/offset starting from the transmission of the (last symbol of) UE-initiated/triggered report, the UE 116 could (re-)send/transmit the UE-initiated/triggered report that carries/provides/indicates the information related to the UE-initiated/triggered CSI-RS(s).
When/if the UE 116 receives from the network 130 an ACK for the UE-initiated/triggered report that carries/provides/indicates the information related to the UE-initiated/triggered CSI-RS(s) within the first time window/offset starting from the transmission of the (last symbol of) UE-initiated/triggered report, the UE 116 could start to measure one or more UE-initiated/triggered CSI-RSs within a fourth time window/offset (e.g., in terms of the number of slots/symbols/etc.) starting from the reception of the ACK for the UE-initiated/triggered report (e.g., starting from the corresponding slot/symbol/etc.). When/if the UE 116 does not receive the UE-initiated/triggered CSI-RS(s) within the fourth time window/offset starting from the reception of the ACK for the UE-initiated/triggered report, the UE 116 could (re-)send/transmit the UE-initiated/triggered report that carries/provides/indicates the information related to the UE-initiated/triggered CSI-RS(s); otherwise, the UE 116 could use/apply the corresponding measurement result(s) for the aperiodic CSI reporting or to autonomously initiate/trigger the event(s)-based or non-event(s)-based reporting as specified herein in the present disclosure. The value of the fourth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The information related to the one or more UE-initiated/triggered CSI-RS(s)—indicated/provided to the network 130 in part of the UE-initiated/triggered report—could include/contain one or more CSI reporting settings, one or more CSI resource settings, one or more CSI resource sets, and/or one or more CSI-RS resources according to one or more examples described herein. More specifically:
   The information related to the UE-initiated/triggered CSI-RS(s) could include/contain one or multiple CSI reporting settings or a trigger state containing one or multiple CSI reporting settings with each CSI reporting setting provided by CSI-ReportConfig, wherein a CSI reporting setting could be linked to one or multiple periodic, semi-persistent, or aperiodic CSI resource settings (and therefore, the corresponding CSI resource set(s) and CSI-RS resource(s) configured/provided therein).
   For the UE-initiated or UE-triggered reporting specified herein in the present disclosure, the information related to the UE-initiated/triggered CSI-RS(s) could include/contain one or multiple CSI reporting settings or a trigger state containing one or multiple CSI reporting settings with each CSI reporting setting provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting as specified herein in the present disclosure, the information related to the UE-initiated/triggered CSI-RS(s) could include/contain one or multiple CSI reporting settings each provided by CSI-ReportConfig, wherein the one or multiple CSI reporting settings could be associated with resourcesForUeInitiatedReporting, wherein:
      The resourcesForUeInitiatedReporting could correspond to a CSI resource set (enabled) for the UE-initiated/triggered reporting determined according to one or more examples described herein—e.g., the CSI resource set with the higher layer parameter ‘csiResourceSetForUeInitiatedReporting’ set to ‘enabled’.
      The resourcesForUeInitiatedReporting could correspond to or comprise one or more CSI-RS resources for the UE-initiated/triggered reporting determined according to one or more examples described herein.
      The resourcesForUeInitiatedReporting could provide one or more CSI-RS resources (e.g., SSB resources each provided by SSB-Index or NZP CSI-RS resources each provided by NZP-CSI-RS-Resource); the UE 116 could measure the one or more CSI-RS resources provided/configured in resourcesForUeInitiatedReporting and use/apply the corresponding measurement result(s) to autonomously initiate/trigger the event(s)-based or non-event(s)-based reporting as specified herein in the present disclosure.
   For the UE-initiated or UE-triggered reporting as specified herein in the present disclosure, the information related to the UE-initiated/triggered CSI-RSs could include/contain one or multiple CSI resource settings each provided by CSI-ResourceConfig, one or multiple CSI resource sets each provided by CSI-SSB-ResourceSet or NZP-CSI-ResourceSet, or one or multiple CSI-RS resources each provided by SSB-Index or NZP-CSI-RS-Resource, wherein:
      The one or multiple CSI resource settings/CSI resource sets/CSI-RS resources could be linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI resource settings could correspond to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI resource sets could correspond to one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI-RS resources could correspond to one or more CSI-RS resources for the UE-initiated/triggered reporting determined according to one or more examples described herein.

The UE 116 could then measure the UE-initiated/triggered CSI-RS(s) as specified herein in the present disclosure, and use/apply the corresponding measurement result(s) for the aperiodic CSI reporting or to autonomously initiate/trigger the event(s)-based or non-event(s)-based reporting as specified herein in the present disclosure.

In another example, the UE 116 may not expect to receive from the network 130 an ACK (or NACK) for the UE-initiated/triggered report of (report-)type (A), (B) or (C) that carries/provides/indicates the information related to the (UE-initiated/triggered) CSI-RS(s). For this case, the UE 116 could start to measure one or more UE-initiated/triggered CSI-RSs within a fifth time window/offset (e.g., in terms of the number of slots/symbols/etc.) starting from the transmission of the (last symbol of) UE-initiated/triggered report that carries/provides/indicates the information related to the UE-initiated/triggered CSI-RS(s) (e.g., starting from the corresponding slot/symbol/etc.). When/if the UE 116 does not receive the UE-initiated/triggered CSI-RSs within the fifth time window/offset starting from the transmission of the (last symbol of) UE-initiated/triggered report, the UE 116 could (re-)send/transmit the UE-initiated/triggered report that carries/provides/indicates the information related to the UE-initiated/triggered CSI-RS(s); otherwise, the UE 116 could use/apply the corresponding measurement result(s) for the aperiodic CSI reporting or to autonomously initiate/trigger the event(s)-based or non-event(s)-based reporting as specified herein in the present disclosure. The value of the fifth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The information related to the (UE-initiated/triggered) CSI-RSs—provided/indicated to the network 130 in part of the UE-initiated/triggered report as specified herein in the present disclosure, for instance, could include/contain a trigger state containing one or more CSI reporting settings, one or more CSI reporting settings, one or more CSI resource settings, one or more CSI resource sets and/or one or more CSI-RS resources according to one or more examples described herein. The UE 116 could then measure the UE-initiated/triggered CSI-RS(s) as specified herein in the present disclosure and use/apply the corresponding measurement result(s) for the aperiodic CSI reporting or to autonomously initiate/trigger the event(s)-based or non-event(s)-based reporting as specified herein in the present disclosure.

As discussed herein, the UE-initiated/triggered report of (report-)type (A), (B) or (C), as specified herein in the present disclosure, could indicate/provide to the network 130 one or more of: (i) an indication to initiate/trigger a transmission of a DCI that schedules aperiodic CSI report(s)—e.g., on PUSCH—by a ‘CSI request’ field in the DCI, (ii) an indication to initiate/trigger transmission(s) of trigger-state-less (aperiodic) CSI-RS(s)/CSI-RS resource(s), and (iii) information related to one or more (UE-initiated/triggered) CSI-RSs. Hence, the UE 116 could follow one or more examples described herein to determine resource configuration(s) for the (aperiodic or UE-initiated/triggered) CSI-RS(s), measure, according to the resource configuration(s), the (aperiodic or UE-initiated/triggered) CSI-RS(s), and use/apply the corresponding measurement result(s) for the aperiodic CSI reporting or the UE-initiated/triggered reporting as specified herein in the present disclosure. Furthermore, the signaling medium/container for reporting the UE-initiated/triggered report of (report-)type (A), (B) or (C) as specified herein in the present disclosure could be PUCCH, PUSCH, PRACH, MAC CE, UCI, etc. Optionally:
For a first setting (i.e., UE-initiated/triggered/activated), the UE 116 could follow one or more examples described herein to determine resource configuration(s) for the (aperiodic or UE-initiated/triggered) CSI-RS(s), measure, according to the resource configuration(s), the (aperiodic or UE-initiated/triggered) CSI-RS(s), and use/apply the corresponding measurement result(s) for the aperiodic CSI reporting or the UE-initiated/triggered reporting as specified herein in the present disclosure.
For a second setting (i.e., NW-configured/indicated/provided), the UE 116 could follow the ‘CSI request’ field in the DCI, and therefore, the corresponding/associated trigger state to, determine resource configuration(s) for the (aperiodic or UE-initiated/triggered) CSI-RS(s), measure, according to the resource configuration(s), the (aperiodic or UE-initiated/triggered) CSI-RS(s), and use/apply the corresponding measurement result(s) for the aperiodic CSI reporting or the UE-initiated/triggered reporting as specified herein in the present disclosure.

In the present disclosure, the first and/or second settings could correspond to various target application scenarios such as D2D, side-link (SL) communications, etc.; alternatively, the first and/or second settings could correspond to various system configurations. Furthermore, the UE 116 could be configured/indicated/provided by the network 130, e.g., via higher layer RRC signaling/parameter and/or MAC CE command and/or dynamic DCI based L1 signaling, the first and/or second settings (e.g., either the first setting or the second setting, or both the first and second settings).

In (up to Rel.17) NR specification, the most resource-efficient reporting mechanism for a content (e.g., beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE 116 knows the DL channel condition better. In this case, it is clearly beneficial if the UE 116 can initiate its own aperiodic reporting for a content (e.g., beam, CSI etc.). For instance, when the UE 116 is configured only with aperiodic beam reporting and the channel condition is worsened to the point of beam failure, the loss of link due to beam failure can be avoided if the UE 116 can transmit an aperiodic beam report without having to wait for a beam report request/trigger from the NW/gNB. Likewise, when the UE 116 is configured only with aperiodic CSI reporting and the channel condition is worsened due to UE speed/movement, the performance degradation due to faster link quality degradation can be avoided if the UE 116 can transmit an aperiodic CSI report without having to wait for a CSI request/trigger from the NW/gNB. Such UE-initiated reporting for a content can be enabled for other types of report quantities (different from traditional beam or CSI reports).

Although UE-initiated reporting can be beneficial, efficient designs are needed to ensure that the latency is reduced and, at the same time, error events can be minimized. Therefore, there is a need for efficient designs for UE-initiated reporting for a content that can offer good trade-off between latency and reliability. In particular, when the UE-initiated reporting framework can include multiple report types (or report quantities), or/and multiple event types when a report types can be associated with an event (e.g., for beam report, the event can be beam failure, and for CSI, the event can be user throughput degradation or increasing retransmission rate).

This disclosure provides example embodiments on UE-initiated reporting. More specifically, the present disclosure provides various means of triggering/initiating (semi-persistent) CSI measurement/reporting by the UE 116 (or jointly with the network).

The present disclosure provides various novel and detailed resource and reporting settings to enable the UE-initiated/triggered reporting. Furthermore, various means of triggering/initiating (semi-persistent) CSI measurement/reporting by the UE 116 (or jointly by the UE and the network) are specified in the present disclosure.

In the present disclosure, a UE detects (or determines) a need for transmitting a UE-initiated/UE-triggered report (or initiation/triggering) of a (report-)type (A), (B), or (C), where:
(A) includes an initiator/trigger/pre-notification message.
(B) includes a report/content (comprising one or multiple report quantities).
(C) includes both a trigger/pre-notification message and a (corresponding) report/content.

The report is to facilitate/enable efficient/timely/fast/reliable communication over the link/channel between a target entity (e.g., NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g. CRI, SSBRI) and Jᵢ is a beam metric (e.g. L1-RSRP, L1-SINR).
In one example, the content includes CSI-related quantity/quantities. For example, at least one of (RI, PMI, CQI, CRI, LI).
In one example, the content includes TDCP-related quantity/quantities. For example, an indicator about the Doppler profile (e.g., Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g., non-beam, non-CSI, non-TDCP) quantity/quantities.
   In one example, quantity/quantities comprise a selector/indicator indicating selection of one (or >1) of either:
      beam (TCI state) TCI states (e.g., DL TCI state, UL TCI state, or unified (joint) DL/UL TCI state), or
      panel(s) (e.g., UE panels for DL reception or/and UL transmission), or
      antenna(e) (e.g., UE antennae for DL reception or/and UL transmission), or
      antenna port(s) (e.g., UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities and at least one other quantity/quantities.
In one example, the content includes CSI-related quantity/quantities and at least one other quantity/quantities.
In one example, the content includes TDCP-related quantity/quantities and at least one other quantity/quantities.
In one example, the content includes beam-related quantity/quantities and CSI-related quantity/quantities.
In one example, the content includes beam-related quantity/quantities and TDCP-related quantity/quantities.
In one example, the content includes TDCP-related quantity/quantities and CSI-related quantity/quantities.

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE 116 is a Uu interface (i.e., DL, UL).

In one example, the link/channel between the target entity and the UE 116 is a sidelink (SL), or a device-to-device (D2D) or PC5 interface.

In one example, such reporting can be non-event-based or autonomous, the UE 116 can initiate/trigger the report autonomously (i.e., without being associated with any event) or unconditionally/freely. For example, the UE 116 can be configured with a triggering time window (or multiple UL slots) and the UE 116 can trigger the report during this window.

In one example, such reporting can be event-based, i.e., the UE 116 can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 6 (for joint) and Table 7/Table 8 (for separate). In these examples, the event-types and the report-types are separate (explicit). However, they can also be joint, as shown in Table 9. A few examples of the autonomous UE-initiated report are shown in Table 10.

TABLE 6
Event-based UE-initiated report

| | Report | | |
|---|---|---|---|
| Event type | Type | Trigger/pre-notification message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non-CSI/beam/TDCP | (A) | Yes (e.g., non-CSI-related event) | No |
| | (B) | No | Yes |
| | (C) | Yes (e.g., non-CSI-related event) | Yes |
| 4. other | (A) | Yes (no need for content) | No |
| (content-free/less events) | | | |

TABLE 7
Event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 8
Event-based UE-initiated report

| Report-type | Trigger/pre-notification message | Content |
|---|---|---|
| (A) | Yes | No |
| (B) | No | Yes |
| (C) | Yes | Yes |

TABLE 9
Event-based UE-initiated report

| Report | | |
|---|---|---|
| Type | Trigger/pre-notification message | Content |
| 0 | Yes (e.g., beam-related event), | No |
| | content-specific or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 10
Non-event-based or autonomous UE-initiated report

| Report | | |
|---|---|---|
| Type | Trigger/pre-notification message | Content |
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, an index or a parameter (e.g., reportQuantity) can be used to indicate one example from tables herein. The index/parameter can be used to configure the UE-initiated report according to one or more examples described herein, e.g., via higher layer RRC. Such a configuration can be subject to the UE 116 capability. In one example, the index/parameter can also indicate multiple (e.g., 2) examples from tables herein. In this case, the UE-initiated report can include the report for at least one for the two.

In this disclosure, the UE-initiated or UE-triggered reporting as specified herein in the present disclosure could be associated with or linked to one or more CSI reporting settings each provided by CSI-ReportConfig.
In one example, the CSI reporting setting ID(s) provided by reportConfigId for the one or more CSI reporting settings for the UE-initiated or UE-triggered reporting could be fixed in the system specification(s)—e.g., corresponding to the lowest/highest or predefined/preconfigured CSI reporting setting ID(s), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-MeasConfig) and/or MAC CE command and/or dynamic DCI based L1 signaling, the CSI reporting setting ID(s)—provided by reportConfigId—for the one or more CSI reporting settings for the UE-initiated or UE-triggered reporting.
In another example, the one or more CSI reporting settings for the UE-initiated or UE-triggered reporting could correspond to the CSI reporting setting(s) with the higher layer parameter ‘reportQuantity’ configured therein set to ‘none’.
In yet another example, a higher layer parameter denoted by ‘ueInitiatedReporting’ could be provided/configured in a CSI reporting setting (e.g., in the corresponding higher layer RRC parameter CSI-ReportConfig). For this case, the one or more CSI reporting settings for the UE-initiated or UE-triggered reporting could correspond to the CSI reporting setting(s) with the higher layer parameter ‘ueInitiatedReporting’ configured therein set to ‘enabled’.
In yet another example, the UE 116 could be provided/configured/indicated by the network 130, e.g., via higher layer RRC signaling/parameter (e.g., in/via the higher layer RRC parameter CSI-MeasConfig) and/or MAC CE command and/or dynamic DCI based L1 signaling, a bitmap with each bit position/entry of the bitmap corresponding/associated to a CSI reporting setting configured therein. When/if a bit position/entry of the bitmap is set to ‘1’ (or ‘0’), the corresponding/associated CSI reporting setting could be enabled for the UE-initiated/triggered reporting.

In the present disclosure, a CSI reporting setting for the UE-initiated/triggered reporting as described herein could be associated with one or more CSI resource settings (each provided by CSI-ResourceConfig); here, the one or more CSI resource settings could be referred to as CSI resource setting(s) for the UE-initiated/triggered reporting. Each CSI resource setting for the UE-initiated/triggered reporting could comprise one or more CSI resource sets (e.g., SSB resource set(s) provided by CSI-SSB-ResourceSet or NZP CSI-RS resource set(s) provided by nzp-CSI-RS-ResourceSet); here, the one or more CSI resource sets could be referred to as CSI resource set(s) for the UE-initiated/triggered reporting. Furthermore, each CSI resource set for the UE-initiated/triggered reporting could comprise one or more CSI-RS resources including SSB resource indexes (each provided by SSB-Index) or one or more NZP CSI-RS resources (each provided by NZP-CSI-RS-Resource) for the UE-initiated/triggered reporting. In the present disclosure, the UE 116 could measure the one or more CSI-RSs for the UE-initiated/triggered reporting (e.g., provided/configured in the CSI resource setting(s)/CSI resource set(s) for the UE-initiated/triggered reporting) and use/apply the corresponding measurement result(s) to autonomously initiate/trigger the event(s)-based or non-event(s)-based reporting as specified herein in the present disclosure.

In the present disclosure, a CSI reporting setting could be associated with one or more CSI resource settings (each provided by CSI-ResourceConfig), wherein each CSI resource setting could comprise one or more CSI resource sets (e.g., SSB resource set(s) provided by CSI-SSB-ResourceSet or NZP CSI-RS resource set(s) provided by nzp-CSI-RS-ResourceSet) and each CSI resource set could comprise one or more CSI-RS resources including SSB resource indexes (each provided by SSB-Index) or one or more NZP CSI-RS resources (each provided by NZP-CSI-RS-Resource).
In one example, the one or more CSI resource settings could be (enabled) for the UE-initiated/triggered reporting according to one or more of the following.
   For example, the CSI resource setting ID(s) provided by esi-ResourceConfigId for the one or more CSI resource settings for the UE-initiated or UE-triggered reporting could be fixed in the system specification(s)—e.g., corresponding to the lowest/highest or predefined/preconfigured CSI resource setting ID(s), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-MeasConfig) and/or MAC CE command and/or dynamic DCI based L1 signaling, the CSI resource setting ID(s)—provided by csi-ResourceConfigId—for the one or more CSI resource settings for the UE-initiated or UE-triggered reporting.
   For another example, a higher layer parameter denoted by ‘csiResourceConfigForUeInitiatedReporting’ could be provided/configured in a CSI resource setting (e.g., in the corresponding higher layer RRC parameter CSI-Resource Config). For this case, the one or more CSI resource settings for the UE-initiated or UE-triggered reporting could correspond to the CSI resource setting(s) with the higher layer parameter ‘csiResourceConfigForUeInitiatedReporting’ configured therein set to ‘enabled’.
   Yet for another example, the UE 116 could be provided/configured/indicated by the network 130, e.g., via higher layer RRC signaling/parameter (e.g., in/via the higher layer RRC parameter CSI-MeasConfig) and/or MAC CE command and/or dynamic DCI based L1 signaling, a bitmap with each bit position/entry of the bitmap corresponding/associated to a CSI resource setting configured therein. When/if a bit position/entry of the bitmap is set to ‘1’ (or ‘0’), the corresponding/associated CSI resource setting could be enabled for the UE-initiated/triggered reporting.
In another example, the one or more CSI resource sets (provided/configured in the one or more CSI resource settings) could be (enabled) for the UE-initiated/triggered reporting according to one or more of the following.
   For example, the CSI resource set ID(s) (e.g., provided by csi-SSB-ResourceSetId for a SSB resource set or nzp-CSI-RS-ResourceSetId for a NZP CSI-RS resource set) for the one or more CSI resource sets for the UE-initiated or UE-triggered reporting could be fixed in the system specification(s)—e.g., corresponding to the lowest/highest or predefined/preconfigured CSI resource set ID(s), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-ResourceConfig) and/or MAC CE command and/or dynamic DCI based L1 signaling, the CSI resource set ID(s)—provided by csi-SSB-ResourceSetId for a SSB resource set or nzp-CSI-RS-ResourceSetId for a NZP CSI-RS resource set—for the one or more CSI resource sets for the UE-initiated or UE-triggered reporting.
   For another example, a higher layer parameter denoted by ‘csiResourceSetForUeInitiatedReporting’ could be provided/configured in a CSI resource set (e.g., in the corresponding higher layer RRC parameter csi-SSB-ResourceSetId for a SSB resource set or nzp-CSI-RS-ResourceSetId for a NZP CSI-RS resource set). For this case, the one or more CSI resource sets for the UE-initiated or UE-triggered reporting could correspond to the CSI resource set(s) with the higher layer parameter ‘csiResourceSetForUeInitiatedReporting’ configured therein set to ‘enabled’.
   Yet for another example, the UE 116 could be provided/configured/indicated by the network 130, e.g., via higher layer RRC signaling/parameter (e.g., in/via the higher layer RRC parameter CSI-ResourceConfig) and/or MAC CE command and/or dynamic DCI based L1 signaling, a bitmap with each bit position/entry of the bitmap corresponding/associated to a CSI resource set configured therein. When/if a bit position/entry of the bitmap is set to ‘1’ (or ‘0’), the corresponding/associated CSI resource set such as SSB resource set or NZP CSI-RS resource set could be enabled for the UE-initiated/triggered reporting.
In yet another example, the one or more CSI-RS resources (provided/configured in the one or more CSI resource sets) could be (enabled) for the UE-initiated/triggered reporting according to one or more of the following.
   For example, the CSI-RS resource ID(s) (e.g., provided by SSB-Index for a SSB resource or nzp-CSI-RS-ResourceId for a NZP CSI-RS resource) for the one or more CSI-RS resources for the UE-initiated or UE-triggered reporting could be fixed in the system specification(s)—e.g., corresponding to the lowest/highest or predefined/preconfigured CSI-RS resource ID(s), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, the CSI-RS resource ID(s)—provided by SSB-Index for a SSB resource or nzp-CSI-RS-ResourceId for a NZP CSI-RS resource—for the one or more CSI-RS resources for the UE-initiated or UE-triggered reporting.
   For another example, a higher layer parameter denoted by ‘csiResourceForUeInitiatedReporting’ could be provided/configured in a CSI-RS resource (e.g., in the corresponding higher layer RRC parameter SSB-Index for a SSB resource or NZP-CSI-RS-Resource for a NZP CSI-RS resource). For this case, the one or more CSI-RS resources for the UE-initiated or UE-triggered reporting could correspond to the CSI-RS resources with the higher layer parameter ‘csiResourceForUeInitiatedReporting’ configured therein set to ‘enabled’.
   Yet for another example, the UE 116 could be provided/configured/indicated by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, a bitmap with each bit position/entry of the bitmap corresponding/associated to a CSI-RS resource configured therein. When/if a bit position/entry of the bitmap is set to ‘1’ (or ‘0’), the corresponding/associated CSI-RS resource such as a SSB resource or a NZP CSI-RS resource could be enabled for the UE-initiated/triggered reporting.

In the present disclosure, the UE could receive from the network, one or more MAC CEs/MAC CE commands to update one or more of the measurement CSI-RSs as specified herein in the present disclosure for (aperiodic) CSI reporting or the UE-initiated/triggered reporting. Furthermore, the measurement resource and/or reporting settings—including the CSI reporting settings (each provided by CSI-ReportConfig), the CSI resource settings (each provided by CSI-ResourceConfig), the CSI resource sets (each provided by CSI-SSB-ResourceSet or NZP-CSI-RS-ResourceSet) and/or the CSI-RS resources (each corresponding to a SSB or a NZP CSI-RS resource) configured therein—as specified herein in the present disclosure could be (one-to-one) associated/linked to one or more events or event types as specified herein in the present disclosure. The UE could be provided/configured/indicated by the network, e.g., via higher layer RRC signaling and/or MAC CE command and/or dynamic DCI based L1 signaling, the association/linkage. Upon receiving or determining the measurement resource and/or reporting settings, the UE could then, based on the association/linkage, determine the corresponding event(s) or event type(s) for the UE-initiated/triggered reporting. In addition, the measurement resource and/or reporting settings—including the CSI reporting settings (each provided by CSI-ReportConfig), the CSI resource settings (each provided by CSI-ResourceConfig), the corresponding CSI resource sets (each provided by CSI-SSB-ResourceSet or NZP-CSI-RS-ResourceSet) and/or the CSI-RS resources (each corresponding to a SSB or a NZP CSI-RS resource) configured therein—as specified herein in the present disclosure could be (one-to-one) associated/linked to one or more uplink resources/channels/signals (e.g., one or more PUCCH/PUSCH resources, one or more PRACH resources, etc.). The UE could be provided/configured/indicated by the network, e.g., via higher layer RRC signaling and/or MAC CE command and/or dynamic DCI based L1 signaling, the association/linkage. Upon receiving or determining the measurement resource and/or reporting settings, the UE could then, based on the association/linkage, determine the corresponding uplink resource(s)/channel(s)/signal(s)—e.g., the PUCCH/PUSCH resource(s) or the PRACH resource(s)—to send/transmit the UE-initiated/triggered report.

As specified herein in the present disclosure, in one embodiment, one or more CSI resource settings could be (enabled) for the UE-initiated/triggered reporting. The UE could measure the CSI-RS(s) configured in the CSI resource setting for the UE-initiated/triggered reporting and use/apply the corresponding measurement result(s) to autonomously initiate/trigger the event(s)-based or non-event(s)-based reporting as specified herein in the present disclosure.

As specified herein in the present disclosure, in one embodiment, one or more CSI resource sets (configured in one or more CSI resource settings) could be (enabled) for the UE-initiated/triggered reporting. The UE could measure the CSI-RS(s) configured in the CSI resource set for the UE-initiated/triggered reporting and use/apply the corresponding measurement result(s) to autonomously initiate/trigger the event(s)-based reporting as specified herein in the present disclosure.

As specified herein in the present disclosure, in one embodiment, the UE could be configured by the network, e.g., via higher layer RRC signaling/parameter (e.g., in a CSI resource set provided by CSI-SSB-ResourceSet or nzp-CSI-RS-ResourceSet) and/or MAC CE command and/or dynamic DCI based L1 signaling, one or more (e.g., N≥1) first reference signals (RSs) or RS resources for beam, channel or interference measurement(s), wherein a first RS could correspond to a SSB (e.g., provided by SSB-Index) or a CSI-RS for tracking, a CSI-RS for CSI acquisition or a CSI-RS for beam management (e.g., provided by NZP-CSI-RS-Resource). Furthermore, the UE could use the measurement results of one or more (e.g., M where 1≤M≤N) of the first RSs—referred to as second RSs in the present disclosure—for the UE-initiated or UE-triggered reporting as specified herein in the present disclosure. As described herein, the second RSs here can also be referred to as the CSI-RSs or CSI-RS resources (enabled) for the UE-initiated/triggered reporting. For example, the UE 116 could autonomously determine which M second RSs (out of the N first RSs), and therefore, their corresponding measurement results, to use for the UE-initiated/triggered reporting. For another example, the UE 116 could be indicated/configured/provided by the network 130, e.g., via higher layer RRC signaling/parameter and/or MAC CE command and/or dynamic DCI based L1 signaling, which M second RSs (out of the N first RSs), and therefore, their corresponding measurement results, to use for the UE-initiated/triggered reporting. More specifically:
In one example, the M second RSs or indexes of the M second RSs—out of the N first RSs—could be fixed in the system specification(s) and known to both the UE 116 and network 130 sides. Specifically, for this design example, the positions/orderings/indexes of the M second RSs in the N first RSs are known to both the UE 116 and network 130 sides.
   For example, the M second RSs could correspond to the first (e.g., received or configured to receive earliest in time) M RSs of the N first RSs. For instance, for M=1, the UE 116 could use the first RS (e.g., received or configured to receive earliest in time) of the N first RSs, and therefore, the corresponding measurement result(s), for the UE-initiated/triggered reporting.
   For another example, the M second RSs could correspond to the last (e.g., received or configured to receive latest in time) M RSs of the N first RSs. For instance, for M=1, the UE 116 could use the last RS (e.g., received or configured to receive latest in time) of the N first RSs, and therefore, the corresponding measurement result(s), for the UE-initiated/triggered reporting.
   Yet for another example, the M second RSs could correspond to the M RSs of the N first RSs with the lowest (or highest) RS indexes. For instance, for M=1, the UE 116 could use the RS with the lowest (or highest) RS index of the N first RSs, and therefore, the corresponding measurement result(s), for the UE-initiated/triggered reporting.
   Yet for another example, the M second RSs could correspond to the M RSs of the N first RSs with the lowest (or highest) odd RS indexes. For instance, for M=N, the M second RSs could correspond to each of the RSs out of the N first RSs with odd RS indexes.
   Yet for another example, the M second RSs could correspond to the M RSs of the N first RSs with the lowest (or highest) even RS indexes. For instance, for M=N, the M second RSs could correspond to each of the RSs out of the N first RSs with even RS indexes.
   Yet for another example, the M second RSs could correspond to the M RSs of the N first RSs with predefined (odd/even) RS indexes.
   Yet for another example, the M second RSs could correspond to the M RSs of the N first RSs with predefined ordering of reception time.
In another example, the M second RSs or indexes of the M second RSs—out of the N first RSs—could be fixed in the system specification(s) and known to both the UE 116 and network 130 sides. Specifically, for this design example, the starting/ending RS index(es) of the M second RSs in the N first RSs are known to both the UE 116 and network 130 sides.
   For example, the starting RS could correspond to the first RS (e.g., received or configured to receive earliest in time) of the N first RSs; alternatively, the starting RS could correspond to the RS of the N first RSs with the lowest (or highest) RS index.
      In one example, the M second RSs could correspond to the first M RSs including the starting RS—out of the N first RSs—that are received or configured to receive earliest in time after reception of the starting RS. For instance, for M=1, the UE 116 could use the starting RS, and therefore, the corresponding measurement result(s), for the UE-initiated/triggered reporting.
      In another example, the M second RSs could correspond to the M RSs including the starting RS—out of the N first RSs—that are with the lowest (or highest) RS indexes lower (or higher) than the starting RS index. For instance, for M=1, the UE 116 could use the starting RS, and therefore, the corresponding measurement result(s), for the UE-initiated/triggered reporting.
      In yet another example, the M second RSs could correspond to the M RSs including the starting RS—out of the N first RSs—that are with the lowest (or highest) odd RS indexes lower (or higher) than the starting RS index; alternatively, the M second RSs could correspond to the M RSs including the starting RS—out of the N first RSs—that are with the lowest (or highest) even RS indexes lower (or higher) than the starting RS index.
      In yet another example, the M second RSs could correspond to the M RSs including the starting RS—out of the N first RSs—that are with predefined ordering of reception time later than the reception of the starting RS; alternatively, the M second RSs could correspond to the M RSs including the starting RS—out of the N first RSs—that are with predefined (odd/even) RS indexes lower (or higher) than the starting RS index.
   For another example, the ending RS could correspond to the last RS (e.g., received or configured to receive latest in time) of the N first RSs; alternatively, the ending RS could correspond to the RS of the N first RSs with the highest (or lowest) RS index.
      In one example, the M second RSs could correspond to the last M RSs including the ending RS—out of the N first RSs—that are received or configured to receive latest in time before reception of the ending RS. For instance, for M=1, the UE 116 could use the ending RS, and therefore, the corresponding measurement result(s), for the UE-initiated/triggered reporting.
      In another example, the M second RSs could correspond to the M RSs including the ending RS—out of the N first RSs—that are with the highest (or lowest) RS indexes higher (or lower) than the ending RS index. For instance, for M=1, the UE 116 could use the ending RS, and therefore, the corresponding measurement result(s), for the UE-initiated/triggered reporting.
      In yet another example, the M second RSs could correspond to the M RSs including the ending RS—out of the N first RSs—that are with the highest (or lowest) odd RS indexes higher (or lower) than the ending RS index; alternatively, the M second RSs could correspond to the M RSs including the ending RS—out of the N first RSs—that are with the highest (or lowest) even RS indexes higher (or lower) than the ending RS index.
      In yet another example, the M second RSs could correspond to the M RSs including the ending RS—out of the N first RSs—that are with predefined ordering of reception time earlier than the reception of the ending RS; alternatively, the M second RSs could correspond to the M RSs including the ending RS—out of the N first RSs—that are with predefined (odd/even) RS indexes higher (or lower) than the ending RS index.
   Yet for another example, the starting/ending RS could correspond to a predefined RS index out of the N first RSs; alternatively, the starting/ending RS could correspond to a RS out of the N first RSs that is received or configured to receive in a predefined reception time. For this case, the M second RSs could be determined according to the starting/ending RS specified herein and one or more of the described design examples herein in the present disclosure.
In yet another example, the M second RSs or indexes of the M second RSs—out of the N first RSs—could be fixed in the system specification(s) and known to both the UE 116 and network 130 sides. Specifically, for this design example, information of the M second RSs such as a time window/duration for the M second RSs including the starting/ending RS and/or the number of the second RSs (i.e., M in this design example) and/or etc. are known to both the UE 116 and network 130 sides. For this case, the starting/ending RS and/or the M second RSs and/or etc. of the time window/duration for the M second RSs (and therefore, the corresponding information) could be determined according to one or more of the described design examples herein in the present disclosure.
In yet another example, the UE 116 could be provided/indicated/configured by the network 130, e.g., via higher layer RRC signaling/parameter (e.g., via a CSI resource/reporting setting) and/or MAC CE command and/or dynamic DCI based L1 signaling, the positions/orderings/indexes of the M second RSs in the N first RSs as described/specified herein in the present disclosure, and/or the starting/ending RS index(es) of the M second RSs in the N first RSs as described/specified herein in the present disclosure, and/or the information of the M second RSs such as the time window/duration for the M second RSs including the starting/ending RS and/or the number of the second RSs (i.e., M in this design example) and/or etc. as described/specified herein in the present disclosure, and/or etc.
   For example, the RS index(es) of the M second RSs (e.g., provided by SSB-Index for a SSB resource or nzp-CSI-RS-ResourceId for a NZP CSI-RS resource) in the N first RSs could be fixed in the system specification(s)—e.g., corresponding to the lowest/highest or predefined/preconfigured RS index(es) and known to both the UE 116 and network 130 sides. Alternatively, the UE 116 could be provided/indicated/configured by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, the RS index(es) of the M second RSs—provided by SSB-Index for a SSB resource or nzp-CSI-RS-ResourceId for a NZP CSI-RS resource—in the N first RSs.
   For another example, a higher layer parameter denoted by ‘csiResourceForUeInitiatedReporting’ could be provided/configured in the configuration of a RS resource (e.g., in the corresponding higher layer RRC parameter SSB-Index for a SSB resource or NZP-CSI-RS-Resource for a NZP CSI-RS resource). For this case, the second RSs (or second RS resources) could correspond to the RS resources with the higher layer parameter ‘csiResourceForUeInitiatedReporting’ configured therein set to ‘enabled’.
   Yet for another example, the UE 116 could be provided/configured/indicated by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, a bitmap with each bit position/entry of the bitmap corresponding/associated to a first RS or RS resource configured therein. When/if a bit position/entry of the bitmap is set to ‘1’ (or ‘0’), the corresponding/associated first RS or RS resource such as a SSB resource or a NZP CSI-RS resource could be enabled as a second RS or RS resource for the UE-initiated/triggered reporting.

The UE 116 could measure the CSI-RS(s) for the UE-initiated/triggered reporting as specified herein in the present disclosure and use/apply the corresponding measurement result(s) to autonomously initiate/trigger the event(s)-based or non-event(s)-based reporting.

In the present disclosure, the UE 116 could be provided/configured/indicated by the network, e.g., via higher layer RRC signaling/parameter and/or MAC CE command and/or dynamic DCI based L1 signaling, whether the UE-initiated or UE-triggered reporting is enabled or not. For instance, a higher layer RRC parameter denoted by ueInitiatedReporting could be provided/configured in PDSCH-Config, PDCCH-Config, ControlResourceSet, CSI-ReportConfig, CSI-ResourceConfig, etc. When/if the higher layer parameter ueInitiatedReporting is set to enabled, the UE 116 could measure the CSI-RS(s) for the UE-initiated/triggered reporting determined according to one or more examples described herein and use/apply the corresponding measurement result(s) to autonomously initiate/trigger the event(s)-based or non-event(s)-based reporting as specified herein in the present disclosure. In addition, the CSI resource setting(s)—and therefore, the corresponding CSI resource set(s) and CSI-RS resource(s) configured therein—for the UE-initiated/triggered reporting could be configured or received or configured to receive the latest in time (e.g., in the latest or most recent slot). Furthermore, the CSI resource setting(s)—and therefore, the corresponding CSI resource set(s) and CSI-RS resource(s) configured therein—for the UE-initiated/triggered reporting could be configured with ‘resourceType’ set to ‘aperiodic’, ‘semiPersistent’, or ‘periodic’.

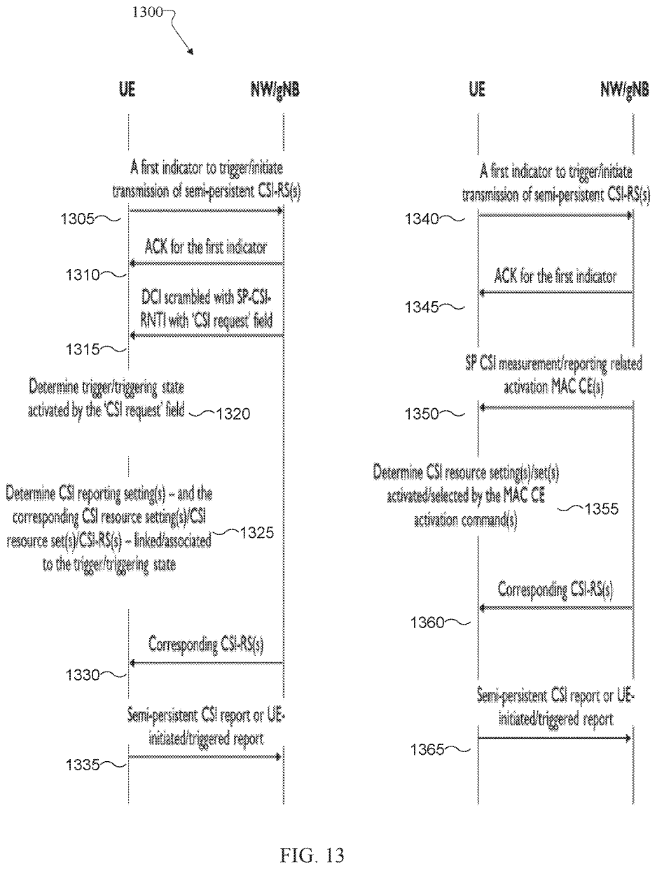

FIG. 13 illustrates examples procedures 1300 for UE-initiated/triggered CSI measurement and reporting according to embodiments of the present disclosure. For example, procedures 1300 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The first procedure begins in 1305, the UE 116 sends a first indicator to trigger/initiate transmission of semi-persistent CSI-RS(s) to the gNB 102 and/or the network 130. In 1310, the gNB 102 and/or the network 130 sends an ACK for the first indicator to the UE 116. In 1315, the gNB 102 and/or the network 130 sends a CSI scrambled with semi-persistent channel state information radio network temporary identifier (SP-CSI-RNTI) with ‘CSI’ request field to the UE 116. In 1320, the UE 116 determines trigger/triggering state activated by the ‘CSI request’ field. In 1325, the UE 116 determines CSI report setting(s)—and the corresponding CSI resource setting(s)/CSI resource set(s)/CSI-RS(s)—linked/associated to the trigger/triggering state. In 1330, the gNB 102 and/or the network 130 sends corresponding CSI-RS(s) to the UE 116. In 1335, the UE 116 sends semi-persistent CSI report or UE-initiated/triggered report to the gNB 102 and/or the network 130.

The second procedure begins in 1340, the UE 116 sends a first indicator to trigger/initiate transmission of semi-persistent CSI-RS(s) to the gNB 102 and/or the network 130. In 1345, the gNB 102 and/or the network 130 sends an ACK for the first indicator to the UE 116. In 1350, the gNB 102 and/or the network 130 sends semi-persistent (SP) CSI measurement/reporting related activation MAC CE(s) to the UE 116. In 1355, the UE 116 determines CSI resource setting(s)/set(s) activated/selected by the MAC CE activation command(s). In 1360, the gNB 102 and/or the network 130 send corresponding CSI-RS(s) to the UE 116. In 1365, the UE 116 sends semi-persistent CSI report or UE initiated/triggered report to the gNB 102 and/or the network 130.

In one embodiment, the UE 116 could indicate to the network 130, or send to the network 130 a first indicator, to initiate/trigger a transmission of a DCI scrambled with SP-CSI-RNTI that activates semi-persistent CSI report(s)—e.g., on PUSCH—by a ‘CSI request’ field in the DCI, and therefore, transmission(s) of the corresponding/associated CSI-RS(s)/CSI-RS resource(s), or to initiate/trigger one or more (MAC CE) activation commands (e.g., the SP CSI-RS/CSI-interference management (IM) Resource Set Activation/Deactivation MAC CE, the SP CSI reporting on PUCCH Activation/Deactivation MAC CE, and/or the SP ZP CSI-RS Resource Set Activation/Deactivation MAC CE) that activate semi-persistent CSI report(s)—e.g., on PUCCH, and therefore, transmission(s) of the corresponding/associated CSI-RS(s)/CSI-RS resource(s). That is, the first indicator not only could initiate/trigger transmission of semi-persistent CSI-RS(s), but also could indicate/provide to the network 130 on which (type of) uplink channel(s) including PUCCH and/or PUSCH the semi-persistent CSI report could be sent/transmitted. In the present disclosure, the first indicator could correspond to the trigger/pre-notification message in a (report-)type (A) based report or a (report-)type (C) based report, or part of the (corresponding) content in a (report-)type (B) based report or a (report-)type (C) based report.

In one example, the UE 116 may expect to receive from the network 130 an ACK (or NACK) for the first indicator within a first time window/offset (e.g., in terms of the number of slots/symbols/etc.) starting from the transmission of the first indicator (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the first indicator within the first time window/offset starting from the transmission of the first indicator or receives a NACK for the first indicator within the first time window/offset starting from the transmission of the first indicator, the UE 116 could (re-)send the first indicator.
When/if the UE 116 receives from the network 130 an ACK for the first indicator within the first time window/offset starting from the transmission of the first indicator, the UE 116 may expect to receive from the network 130 a DCI scrambled with SP-CSI-RNTI that activates semi-persistent CSI report(s)—e.g., on PUSCH—by a ‘CSI request’ field in the DCI when/if the first indicator may also indicate/provide that the semi-persistent CSI report(s) could be sent/transmitted on PUSCH, or to receive from the network 130 one or more (MAC CE) activation commands that activate semi-persistent CSI report(s)—e.g., on PUCCH—when/if the first indicator may also indicate/provide that the semi-persistent CSI report(s) could be sent/transmitted on PUCCH within a second time window/offset (e.g., in terms of the number of slots/symbols/etc.) starting from the reception of the ACK message (e.g., starting from the corresponding slot/symbol/etc.). The value of the second time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive from the network 130 a DCI scrambled with SP-CSI-RNTI that activates semi-persistent CSI report(s) on PUSCH(s) by the ‘CSI request’ field indicated therein or MAC CE activation command(s) that activates semi-persistent CSI report(s) on PUCCH(s) within the second time window/offset starting from the reception of the ACK for the first indicator, the UE 116 could (re-)send the first indicator. When/if the UE 116 receives from the network 130 a DCI scrambled with SP-CSI-RNTI that activates semi-persistent CSI report(s) by the ‘CSI request’ field indicated therein (when/if the first indicator also indicates/provides that the semi-persistent CSI report(s) could be sent/transmitted on PUSCH) or MAC CE activation command(s) that activates semi-persistent CSI report(s) (when/if the first indicator also indicates/provides that the semi-persistent CSI report(s) could be sent/transmitted on PUCCH) within the second time window/offset starting from the reception of the ACK for the first indicator, the UE 116 could first determine a trigger/triggering state activated by the ‘CSI request’ field in the DCI from CSI-SemiPersistentOnPUSCH-TriggerStateList or one or more of the CSI resource settings/sets (e.g., configured with ‘semi-Persistent’) configured for the UE 116 that are selected/activated by the MAC CE activation command(s).
   The trigger/triggering state activated by the ‘CSI request’ field in the DCI scrambled with SP-CSI-RNTI could be associated with one or multiple CSI reporting settings each provided by CSI-ReportConfig, wherein a CSI reporting setting provided by CSI-ReportConfig could be linked to one or multiple periodic, semi-persistent, or aperiodic CSI resource settings (and therefore, the corresponding CSI resource set(s) and CSI-RS resource(s) configured/provided therein). Or, the CSI resource setting(s)/set(s) selected/activated by the MAC CE activation command(s)—e.g., from the CSI resource settings/sets (e.g., configured with ‘semi-Persistent’) configured for the UE 116—could correspond to one or multiple periodic, semi-persistent, or aperiodic CSI resource settings/sets (and therefore, the corresponding CSI resource set(s) and CSI-RS resource(s) configured/provided therein).
   For the UE-initiated or UE-triggered reporting specified herein in the present disclosure, and for periodic, semi-persistent and aperiodic CSI resource settings, the trigger/triggering state activated by the ‘CSI request’ field in the DCI scrambled with SP-CSI-RNTI could be associated with one or multiple CSI reporting settings each provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting as specified herein in the present disclosure, and for periodic, semi-persistent, or aperiodic CSI resource settings, the CSI resource setting(s)/set(s) selected/activated by the MAC CE activation command(s)—e.g., from the CSI resource settings/sets (e.g., configured with ‘semi-Persistent’) configured for the UE 116—could correspond to or be determined according to one or more of the following.
      The CSI resource setting(s)/set(s) selected/activated by the MAC CE activation command(s) could correspond to one or more CSI resource settings/sets linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The CSI resource setting(s) selected/activated by the MAC CE activation command(s) could correspond to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The CSI resource set(s) selected/activated by the MAC CE activation command(s) could correspond to one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The CSI resource setting(s)/set(s) selected/activated by the MAC CE activation command(s) could comprise one or more CSI-RS resources for the UE-initiated/triggered reporting determined according to one or more examples described herein.

The UE 116 could then measure the CSI-RS(s) activated by/associated to the trigger/triggering state or the MAC CE activation command(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

In another example, the UE 116 may not expect to receive from the network 130 an ACK (or NACK) for the first indicator. For this case, the UE 116 may expect to receive from the network 130 a DCI scrambled with SP-CSI-RNTI that activates semi-persistent CSI report(s)—e.g., on PUSCH—by a ‘CSI request’ field in the DCI when/if the first indicator may also indicate/provide that the semi-persistent CSI report(s) could be sent/transmitted on PUSCH, or to receive from the network 130 one or more (MAC CE) activation commands that activate semi-persistent CSI report(s)—e.g., on PUCCH—when/if the first indicator may also indicate/provide that the semi-persistent CSI report(s) could be sent/transmitted on PUCCH, within a third time window/offset (e.g., in terms of the number of slots/symbols/etc.) starting from the transmission of the first indicator (e.g., starting from the corresponding slot/symbol/etc.). The value of the third time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive from the network 130 a DCI scrambled with SP-CSI-RNTI that activates semi-persistent CSI report(s) on PUSCH(s) by the ‘CSI request’ field indicated therein or MAC CE activation command(s) that activates semi-persistent CSI report(s) on PUCCH(s) within the third time window/offset starting from the transmission of the first indicator, the UE 116 could (re-)send the first indicator. When/if the UE 116 receives from the network 130 a DCI scrambled with SP-CSI-RNTI that activates semi-persistent CSI report(s) by the ‘CSI request’ field indicated therein (when/if the first indicator also indicates/provides that the semi-persistent CSI report(s) could be sent/transmitted on PUSCH) or MAC CE activation command(s) that activates semi-persistent CSI report(s) (when/if the first indicator also indicates/provides that the semi-persistent CSI report(s) could be sent/transmitted on PUCCH) within the third time window/offset starting from the transmission of the first indicator, the UE 116 could first determine a trigger/triggering state activated by the ‘CSI request’ field in the DCI from CSI-SemiPersistentOnPUSCH-TriggerStateList or one or more of the CSI resource settings/sets (e.g., configured with ‘semi-Persistent’) configured for the UE 116 that are selected/activated by the MAC CE activation command(s). The UE 116 could then determine the CSI resource setting(s)/set(s) (and therefore, the corresponding CSI resource set(s) and CSI-RS resource(s) configured/provided therein) according to the linked CSI reporting setting(s) that is associated to the trigger/triggering state activated by the ‘CSI request’ field in the DCI or the CSI resource setting(s)/set(s) activated/selected by the MAC CE activation command(s) according to one or more examples described herein. The UE 116 could measure the CSI-RS(s) activated by/associated to the trigger/triggering state or the MAC CE activation command(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

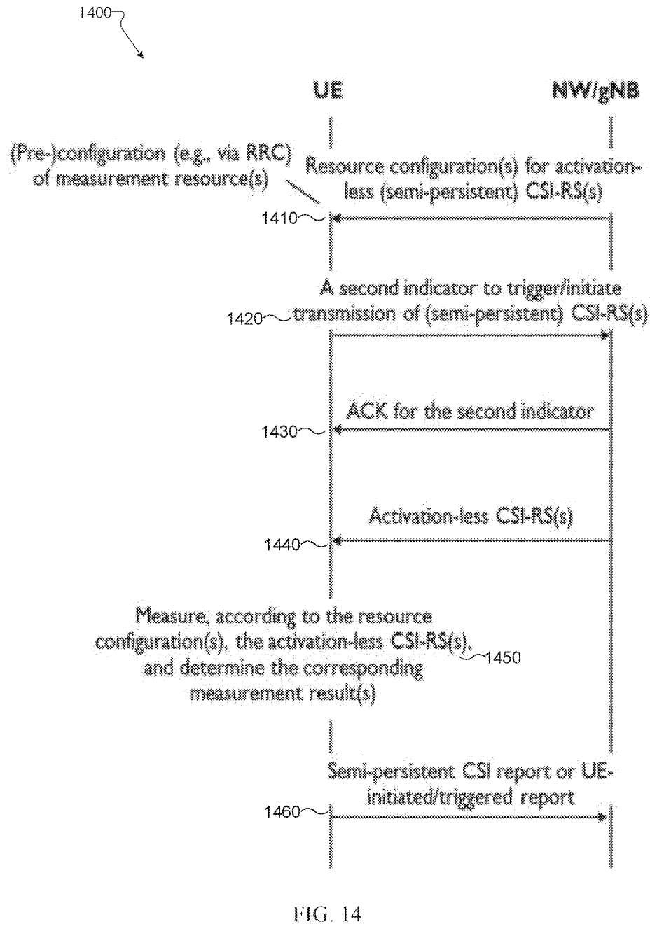

FIG. 14 illustrates an example procedure 1400 for UE-initiated/triggered CSI measurement and reporting according to embodiments of the present disclosure. For example, procedure 1400 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The procedure begins in 1410, the gNB 102 and/or the network 130 send (Pre-)configuration (e.g., via RRC) of measurement resource(s) and/or resource configuration(s) for activation-less (semi-persistent) CSI-RS(s) to the UE 116. In 1420, the UE 116 sends a second indicator to trigger/initiate transmission of (semi-persistent) CSI-RS(s) to the gNB 102 and/or the network 130. In 1430, the gNB 102 and/or the network 130 sends an ACK for the second indicator to the UE 116. In 1440, the gNB 102 and/or the network 130 sends activation-less CSI-RS(s) to the UE 116. In 1450, the UE 116 measures, according to the resource configuration(s), the activation-less CSI-S(s) and determine the corresponding measurement result(s). In 1460, the UE 116 sends semi-persistent CSI report or UE-initiated/triggered report to the gNB 102 and/or the network 130.

In one embodiment, the UE 116 could indicate to the network 130, or send to the network 130 a second indicator, to initiate/trigger transmission(s) of (semi-persistent) CSI-RS(s)/CSI-RS resource(s). In addition to initiating/triggering transmission of semi-persistent CSI-RS(s), the second indicator could also indicate/provide to the network 130 on which (type of) uplink channel(s) including PUCCH and/or PUSCH the semi-persistent CSI report could be sent/transmitted. In the present disclosure, the second indicator could correspond to the trigger/pre-notification message in a (report-)type (A) based report or a (report-)type (C) based report, or part of the (corresponding) content in a (report-)type (B) based report or a (report-)type (C) based report.

In one example, the UE 116 may expect to receive from the network 130 an ACK (or NACK) for the second indicator within a first time window/offset (e.g., in terms of the number of slots/symbols/etc.) starting from the transmission of the indicator (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the second indicator within the first time window/offset starting from the transmission of the second indicator or receives a NACK for the second indicator within the first time window/offset starting from the transmission of the second indicator, the UE 116 could (re-)send the second indicator.
When/if the UE 116 receives from the network 130 an ACK for the second indicator within the first time window/offset starting from the transmission of the second indicator, the UE 116 could start to measure one or more activation-less (semi-persistent) CSI-RSs within a fourth time window/offset (e.g., in terms of the number of slots/symbols/etc.) starting from the reception of the ACK for the second indicator (e.g., starting from the corresponding slot/symbol/etc.). When/if the UE 116 does not receive the activation-less CSI-RSs within the fourth time window/offset starting from the reception of the ACK for the second indicator, the UE 116 could (re-)send the second indicator; otherwise, the UE 116 could use/apply the corresponding measurement result(s) for the semi-persistent CSI reporting or to autonomously initiate/trigger the event(s)-based or non-event(s)-based reporting as specified herein in the present disclosure. Furthermore, the UE 116 could be (pre-)configured/indicated/provided by the network 130, e.g., via higher layer RRC signaling/parameter and/or MAC CE command and/or dynamic DCI based L1 signaling, resource configuration(s) including resource mapping for the one or more activation-less CSI-RSs. The activation-less CSI-RSs may not be activated by the ‘CSI request’ field in a DCI scrambled with SP-CSI-RNTI, and therefore, the corresponding trigger/triggering state or the activation-less CSI-RSs may not be activated by the MAC CE activation command(s) as specified herein in the present disclosure. The value of the fourth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The resource configuration(s) for the activation-less CSI-RSs, for instance, could be provided through one or more CSI reporting settings, one or more CSI resource settings, one or more CSI resource sets and/or one or more CSI-RS resources according to one or more examples described herein. More specifically:
   The resource configuration(s) for the activation-less CSI-RSs could be provided through one or multiple CSI reporting settings each provided by CSI-ReportConfig, wherein a CSI reporting setting provided by CSI-ReportConfig could be linked to one or multiple periodic, semi-persistent, or aperiodic CSI resource settings (and therefore, the corresponding CSI resource set(s) and CSI-RS resource(s) configured/provided therein).
   For the UE-initiated or UE-triggered reporting specified herein in the present disclosure, the resource configuration(s) for the activation-less CSI-RSs could be provided through one or multiple CSI reporting settings each provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting specified herein in the present disclosure, the resource configuration(s) for the activation-less CSI-RSs could be provided through one or multiple CSI resource settings each provided by CSI-ResourceConfig, one or multiple CSI resource sets each provided by CSI-SSB-ResourceSet or NZP-CSI-ResourceSet, or one or multiple CSI-RS resources each provided by SSB-Index or NZP-CSI-RS-Resource, wherein:
      The one or multiple CSI resource settings/CSI resource sets/CSI-RS resources could be linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI resource settings could correspond to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI resource sets could correspond to one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI-RS resources could correspond to one or more CSI-RS resources for the UE-initiated/triggered reporting determined according to one or more examples described herein.

The UE 116 could then measure the activation-less CSI-RS(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

In another example, the UE 116 may not expect to receive from the network 130 an ACK (or NACK) for the second indicator. For this case, the UE 116 could start to measure one or more activation-less CSI-RSs within a fifth time window/offset (e.g., in terms of the number of slots/symbols/etc.) starting from the transmission of the second indicator (e.g., starting from the corresponding slot/symbol/etc.). When/if the UE 116 does not receive the activation-less CSI-RSs within the fifth time window/offset starting from the transmission of the second indicator, the UE 116 could (re-)send the second indicator; otherwise, the UE 116 could use/apply the corresponding measurement result(s) for the semi-persistent CSI reporting or to autonomously initiate/trigger the event(s)-based or non-event(s)-based reporting as specified herein in the present disclosure. Furthermore, the UE 116 could be (pre-)configured/indicated/provided by the network 130, e.g., via higher layer RRC signaling/parameter and/or MAC CE command and/or dynamic DCI based L1 signaling, resource configuration(s) including resource mapping for the one or more activation-less CSI-RSs. The activation-less CSI-RSs may not be activated by the ‘CSI request’ field in a DCI scrambled with SP-CSI-RNTI, and therefore, the corresponding trigger/triggering state, or the activation-less CSI-RSs may not be activated by the MAC CE activation command(s) as specified herein in the present disclosure. The value of the fifth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The resource configuration(s) for the activation-less CSI-RSs, for instance, could be provided through one or more CSI reporting settings, one or more CSI resource settings, one or more CSI resource sets, and/or one or more CSI-RS resources according to one or more examples described herein. The UE 116 could then measure the activation-less CSI-RS(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

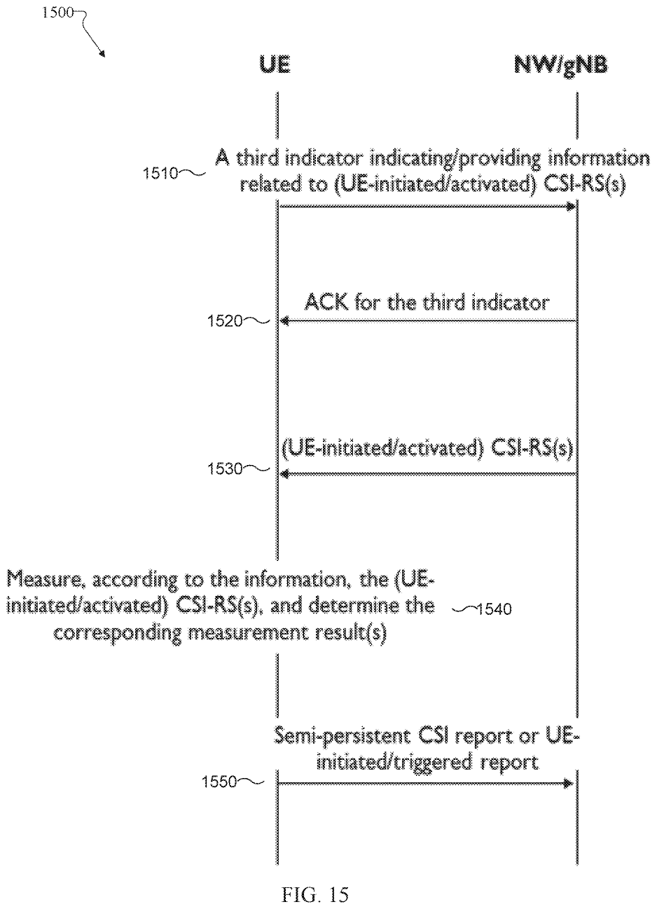

FIG. 15 illustrates an example procedure 1500 for UE-initiated/triggered CSI measurement and reporting according to embodiments of the present disclosure. For example, procedure 1500 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The procedure begins in 1510, the UE 116 sends a third indicator indicating/providing information related to (UE-initiated/activated) CSI-RS(s) to the gNB 102 and/or the network 130. In 1520, the gNB 102 and/or the network 130 sends an ACK for the third indicator to the UE 116. In 1530, the gNB 102 and/or the network 130 sends (UE-initiated/activated) CSI-RS(s) to the UE 116. In 1540, the UE measures, according to the information, the (UE-initiated/activated) CSI-RS(s) and determines the corresponding measurement result(s). In 1550, the UE 116 sends semi-persistent CSI report or UE-initiated/triggered report to the gNB 102 and/or the network 130.

In one embodiment, the UE 116 could indicate to the network 130, or send to the network 130 a third indicator, to provide/indicate information related to one or more (UE-initiated/activated) CSI-RS resources for (semi-persistent) CSI reporting or UE-initiated/triggered reporting as specified herein in the present disclosure. For example, the information could include/contain a trigger state in CSI-SemiPersistentOnPUSCH-TriggerStateList containing one or more associated CSI reporting settings each provided by CSI-ReportConfig. For another example, the information could include/contain one or more CSI reporting settings/CSI reporting setting IDs—e.g., those linked to one or more CSI resource settings/sets that can be activated/selected from the configured CSI resource settings/sets (e.g., configured with ‘semi-Persistent’), wherein a CSI reporting setting could be provided by CSI-ReportConfig. Yet for another example, the information could include/contain one or more CSI resource settings/CSI resource setting IDs that can be activated/selected from the configured CSI resource settings (e.g., configured with ‘semi-Persistent’), wherein a CSI resource setting could be provided by CSI-ResourceConfig. Yet for another example, the information could include/contain one or more CSI resource sets/CSI resource set IDs that can be activated/selected from the configured CSI resource sets associated to the configured CSI resource settings (e.g., configured with ‘semi-Persistent’), wherein a CSI resource set could be provided by CSI-SSB-ResourceSet or NZP-CSI-RS-ResourceSet. Yet for another example, the information could include/contain one or more CSI-RS resources/CSI-RS resource indexes/IDs that can be activated/selected from the CSI-RS resources in the configured CSI resource set(s) associated to the configured CSI resource setting(s) (e.g., configured with ‘semi-Persistent’), wherein a CSI-RS resource could correspond to a SSB provided by SSB-Index or a NZP CSI-RS resource provided by nzp-CSI-RS-Resource. Yet for another example, the information could contain/include PUCCH resources for (semi-persistent) CSI reporting or the UE-initiated/triggered reporting as specified herein in the present disclosure. Furthermore, in addition to providing/indicating information related to one or more (UE-initiated/activated) CSI-RS resources for (semi-persistent) CSI reporting or UE-initiated/triggered reporting as specified herein in the present disclosure, the third indicator could also indicate/provide to the network 130 on which (type of) uplink channel(s) including PUCCH and/or PUSCH the semi-persistent CSI report could be sent/transmitted. In the present disclosure, the indicator could correspond to the trigger/pre-notification message in a (report-)type (A) based report or a (report-)type (C) based report, or part of the (corresponding) content in a (report-)type (B) based report or a (report-)type (C) based report.

In one example, the UE 116 may expect to receive from the network 130 an ACK (or NACK) for the third indicator within a first time window/offset (e.g., in terms of the number of slots/symbols/etc.) starting from the transmission of the third indicator (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the third indicator within the first time window/offset starting from the transmission of the third indicator or receives a NACK for the third indicator within the first time window/offset starting from the transmission of the third indicator, the UE 116 could (re-)send the third indicator.
When/if the UE 116 receives from the network 130 an ACK for the third indicator within the first time window/offset starting from the transmission of the third indicator, the UE 116 could start to measure one or more UE-initiated/activated CSI-RSs within a fourth time window/offset (e.g., in terms of the number of slots/symbols/etc.) starting from the reception of the ACK for the third indicator (e.g., starting from the corresponding slot/symbol/etc.), wherein the information related to the one or more UE-initiated/activated CSI-RS resources is provided/indicated to the network 130 by/via the third indicator. When/if the UE 116 does not receive the UE-initiated/activated CSI-RSs within the fourth time window/offset starting from the reception of the ACK for the third indicator, the UE 116 could (re-)send the third indicator; otherwise, the UE 116 could use/apply the corresponding measurement result(s) for the semi-persistent CSI reporting or to autonomously initiate/trigger the event(s)-based or non-event(s)-based reporting as specified herein in the present disclosure. The value of the fourth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. As discussed herein, the information related to the UE-initiated/activated CSI-RS(s)—indicated/provided to the network 130 by/via the third indicator—could include/contain one or more CSI reporting settings, one or more CSI resource settings, one or more CSI resource sets and/or one or more CSI-RS resources according to one or more examples described herein. More specifically:
   The information related to the UE-initiated/activated CSI-RSs could contain/include one or multiple CSI reporting settings or a trigger state containing one or multiple CSI reporting settings with each CSI reporting setting provided by CSI-ReportConfig, wherein a CSI reporting setting could be linked to one or multiple periodic, semi-persistent, or aperiodic CSI resource settings (and therefore, the corresponding CSI resource set(s) and CSI-RS resource(s) configured/provided therein).
   For the UE-initiated or UE-triggered reporting specified herein in the present disclosure, the information related to the UE-initiated/activated CSI-RSs could include/contain one or multiple CSI reporting settings or a trigger state containing one or multiple CSI reporting settings with each CSI reporting setting provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting specified herein in the present disclosure, the information related to the UE-initiated/activated CSI-RSs could include/contain one or multiple CSI resource settings each provided by CSI-ResourceConfig, one or multiple CSI resource sets each provided by CSI-SSB-ResourceSet or NZP-CSI-ResourceSet, or one or multiple CSI-RS resources each provided by SSB-Index or NZP-CSI-RS-Resource, wherein
      The one or multiple CSI resource settings/CSI resource sets/CSI-RS resources could be linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI resource settings could correspond to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI resource sets could correspond to one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI-RS resources could correspond to one or more CSI-RS resources for the UE-initiated/triggered reporting determined according to one or more examples described herein.

The UE 116 could then measure the UE-initiated/activated CSI-RS(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

In another example, the UE 116 may not expect to receive from the network 130 an ACK (or NACK) for the third indicator. For this case, the UE 116 could start to measure one or more UE-initiated/activated CSI-RSs within a fifth time window/offset (e.g., in terms of the number of slots/symbols/etc.) starting from the transmission of the third indicator (e.g., starting from the corresponding slot/symbol/etc.). When/if the UE 116 does not receive the UE-initiated/activated CSI-RSs within the fifth time window/offset starting from the transmission of the third indicator, the UE 116 could (re-)send the third indicator; otherwise, the UE 116 could use/apply the corresponding measurement result(s) for the semi-persistent CSI reporting or to autonomously initiate/trigger the event(s)-based or non-event(s)-based reporting as specified herein in the present disclosure. The value of the fifth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. For instance, the information related to the (UE-initiated/activated) CSI-RSs—provided/indicated to the network 130 via/by the third indicator could include/contain a trigger state containing one or more CSI reporting settings, one or more CSI reporting settings, one or more CSI resource settings, one or more CSI resource sets, and/or one or more CSI-RS resources according to one or more examples described herein. The UE 116 could then measure the UE-initiated/activated CSI-RS(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

In the present disclosure, the UE could indicate/provide to the network, one or more of the first, second and third indicators as specified herein in the present disclosure. Hence, the UE could follow one or more examples described herein to determine resource configuration(s) for the (semi-persistent or UE-initiated/activated) CSI-RS(s), measure, according to the resource configuration(s), the (semi-persistent or UE-initiated/activated) CSI-RS(s), and use/apply the corresponding measurement result(s) for the semi-persistent CSI reporting or the UE-initiated/triggered reporting as specified herein in the present disclosure. Furthermore, the signaling medium/container for reporting the first, second and/or third indicators as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UCI, etc. Optionally:
For a first setting (i.e., UE-initiated/triggered/activated), the UE could follow one or more examples described herein to determine resource configuration(s) for the (semi-persistent or UE-initiated/activated) CSI-RS(s), measure, according to the resource configuration(s), the (semi-persistent or UE-initiated/activated) CSI-RS(s) and use/apply the corresponding measurement result(s) for the semi-persistent CSI reporting or the UE-initiated/triggered reporting as specified herein in the present disclosure.
For a second setting (i.e., NW-configured/indicated/provided), the UE could follow the ‘CSI request’ field in the DCI scrambled with SP-CSI-RNTI, and therefore, the corresponding/associated trigger state or the MAC CE activation command(s) as specified herein in the present disclosure to determine resource configuration(s) for the (semi-persistent or UE-initiated/activated) CSI-RS(s), measure, according to the resource configuration(s), the (semi-persistent or UE-initiated/activated) CSI-RS(s) and use/apply the corresponding measurement result(s) for the semi-persistent CSI reporting or the UE-initiated/triggered reporting as specified herein in the present disclosure.

In the present disclosure, the first and/or second settings could correspond to various target application scenarios such as D2D, side-link (SL) communications, etc.; alternatively, the first and/or second settings could correspond to various system configurations. Furthermore, the UE could be configured/indicated/provided by the network 130, e.g., via higher layer RRC signaling/parameter and/or MAC CE command and/or dynamic DCI based L1 signaling, the first and/or second settings (e.g., either the first setting or the second setting, or both the first and second settings).

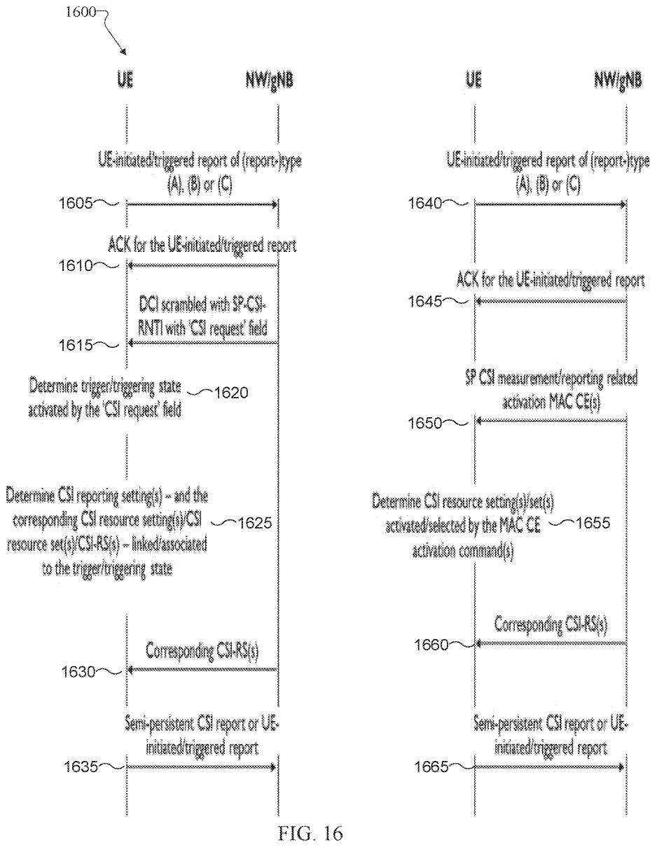

FIG. 16 illustrates examples procedures 1600 for UE-initiated/triggered CSI measurement and reporting according to embodiments of the present disclosure. For example, procedures 1600 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The first procedure begins in 1605, the UE 116 sends UE-initiated/triggered report of (report-)type (A), (B), or (C) to the gNB 102 and/or the network 130. In 1610, the gNB 102 and/or the network 130 sends an ACK for the UE-initiated/triggered report to the UE 116. In 1615, the gNB 102 and/or the network 130 sends a DCI scramble with SP-CSI-RNTI with ‘CSI request’ field to the UE 116. In 1620, the UE 116 determines trigger/triggering state activated by the ‘CSI request’ field. In 1625, the UE 116 determines CSI reporting setting(s)—and the corresponding CSI resource setting(s)/CSI resource set(s)/CSI-RS(s)—linked/associated to the trigger/triggering state. In 1630, the gNB 102 and/or the network 130 send corresponding CSI-RS(s) to the UE 116. In 1635, the UE 116 sends semi-persistent report or UE-initiated/triggered report to the gNB 102 and/or the network 130.

The second procedure begins in 1640, the UE 116 sends UE-initiated/triggered report of (report-)type (A), (B), or (C) to the gNB 102 and/or the network 130. In 1645, the gNB 102 and/or the network 130 sends an ACK for the UE-initiated/triggered report to the UE 116. In 1650, the gNB 102 and/or the network 130 sends SP CSI measurement/reporting related activation MAC CE(s). In 1655, the UE 116 determines CSI resource setting(s)/set(s) activated/selected by the MAC CE activation command(s). In 1660, the gNB 102 and/or the network 130 sends corresponding CSI-RS(s) to the UE 116. In 1665, the UE 116 sends semi-persistent CSI report or UE-initiated/triggered report to the gNB 102 and/or the network 130.

In one embodiment, as specified herein in the present disclosure, a UE could transmit/send to the network a UE-initiated/UE-triggered report (or initiation/triggering) of a (report-)type (A), (B), or (C). Here, the UE-initiated/triggered report could also initiate/trigger a transmission of a DCI scrambled with SP-CSI-RNTI that activates semi-persistent CSI report(s)—e.g., on PUSCH—by a ‘CSI request’ field in the DCI, and therefore, transmission(s) of the corresponding/associated CSI-RS(s)/CSI-RS resource(s), or to initiate/trigger one or more (MAC CE) activation commands (e.g., the SP CSI-RS/CSI-IM Resource Set Activation/Deactivation MAC CE, the SP CSI reporting on PUCCH Activation/Deactivation MAC CE, and/or the SP ZP CSI-RS Resource Set Activation/Deactivation MAC CE) that activate semi-persistent CSI report(s)—e.g., on PUCCH, and therefore, transmission(s) of the corresponding/associated CSI-RS(s)/CSI-RS resource(s). That is, the UE-initiated/triggered report not only could initiate/trigger transmission of semi-persistent CSI-RS(s), but also could indicate/provide to the network 130 on which (type of) uplink channel(s) including PUCCH and/or PUSCH the semi-persistent CSI report could be sent/transmitted.

In one example, the UE 116 may expect to receive from the network 130 an ACK (or NACK) for the UE-initiated/triggered report within a first time window/offset (e.g., in terms of the number of slots/symbols/etc.) starting from the transmission of the (last symbol of) UE-initiated/triggered report (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the UE-initiated/triggered report within the first time window/offset starting from the transmission of the (last symbol of) UE-initiated/triggered report or receives a NACK for the UE-initiated/triggered report within the first time window/offset starting from the transmission of the (last symbol of) UE-initiated/triggered report, the UE 116 could (re-)send/transmit the UE-initiated/triggered report.
When/if the UE 116 receives from the network 130 an ACK for the UE-initiated/triggered report within the first time window/offset starting from the transmission of the (last symbol of) UE-initiated/triggered report, the UE 116 may expect to receive from the network 130 a DCI scrambled with SP-CSI-RNTI that activates semi-persistent CSI report(s)—e.g., on PUSCH—by a ‘CSI request’ field in the DCI when/if the UE-initiated/triggered report may also indicate/provide that the semi-persistent CSI report(s) could be sent/transmitted on PUSCH, or to receive from the network 130 one or more (MAC CE) activation commands that activate semi-persistent CSI report(s)—e.g., on PUCCH—when/if the UE-initiated/triggered report may also indicate/provide that the semi-persistent CSI report(s) could be sent/transmitted on PUCCH, within a second time window/offset (e.g., in terms of the number of slots/symbols/etc.) starting from the reception of the ACK message (e.g., starting from the corresponding slot/symbol/etc.). The value of the second time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive from the network 130 a DCI scrambled with SP-CSI-RNTI that activates semi-persistent CSI report(s) on PUSCH(s) by the ‘CSI request’ field indicated therein or MAC CE activation command(s) that activates semi-persistent CSI report(s) on PUCCH(s) within the second time window/offset starting from the reception of the ACK for the UE-initiated/triggered report, the UE 116 could (re-)send/transmit the UE-initiated/triggered report. When/if the UE 116 receives from the network 130 a DCI scrambled with SP-CSI-RNTI that activates semi-persistent CSI report(s) by the ‘CSI request’ field indicated therein (when/if the UE-initiated/triggered report also indicates/provides that the semi-persistent CSI report(s) could be sent/transmitted on PUSCH) or MAC CE activation command(s) that activates semi-persistent CSI report(s) (when/if the UE-initiated/triggered report also indicates/provides that the semi-persistent CSI report(s) could be sent/transmitted on PUCCH) within the second time window/offset starting from the reception of the ACK for the UE-initiated/triggered report, the UE 116 could first determine a trigger/triggering state activated by the ‘CSI request’ field in the DCI from CSI-SemiPersistentOnPUSCH-TriggerStateList or one or more of the CSI resource settings/sets (e.g., configured with ‘semi-Persistent’) configured for the UE 116 that are selected/activated by the MAC CE activation command(s).
   The trigger/triggering state activated by the ‘CSI request’ field in the DCI scrambled with SP-CSI-RNTI could be associated with one or multiple CSI reporting settings each provided by CSI-ReportConfig, wherein a CSI reporting setting provided by CSI-ReportConfig could be linked to one or multiple periodic, semi-persistent, or aperiodic CSI resource settings (and therefore, the corresponding CSI resource set(s) and CSI-RS resource(s) configured/provided therein). Or, the CSI resource setting(s)/set(s) selected/activated by the MAC CE activation command(s)—e.g., from the CSI resource settings/sets (e.g., configured with ‘semi-Persistent’) configured for the UE 116—could correspond to one or multiple periodic, semi-persistent, or aperiodic CSI resource settings/sets (and therefore, the corresponding CSI resource set(s) and CSI-RS resource(s) configured/provided therein).
   For the UE-initiated or UE-triggered reporting specified herein in the present disclosure, and for periodic, semi-persistent and aperiodic CSI resource settings, the trigger/triggering state activated by the ‘CSI request’ field in the DCI scrambled with SP-CSI-RNTI could be associated with one or multiple CSI reporting settings each provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting as specified herein in the present disclosure, and for periodic, semi-persistent, or aperiodic CSI resource settings, the CSI resource setting(s)/set(s) selected/activated by the MAC CE activation command(s)—e.g., from the CSI resource settings/sets (e.g., configured with ‘semi-Persistent’) configured for the UE 116—could correspond to or be determined according to one or more of the following.
      The CSI resource setting(s)/set(s) selected/activated by the MAC CE activation command(s) could correspond to one or more CSI resource settings/sets linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The CSI resource setting(s) selected/activated by the MAC CE activation command(s) could correspond to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The CSI resource set(s) selected/activated by the MAC CE activation command(s) could correspond to one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The CSI resource setting(s)/set(s) selected/activated by the MAC CE activation command(s) could comprise one or more CSI-RS resources for the UE-initiated/triggered reporting determined according to one or more examples described herein.

The UE 116 could then measure the CSI-RS(s) activated by/associated to the trigger/triggering state or the MAC CE activation command(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

In another example, the UE 116 may not expect to receive from the network 130 an ACK (or NACK) for the UE-initiated/triggered report of (report-)type (A), (B) or (C) as specified herein in the present disclosure. For this case, the UE 116 may expect to receive from the network 130 a DCI scrambled with SP-CSI-RNTI that activates semi-persistent CSI report(s)—e.g., on PUSCH—by a ‘CSI request’ field in the DCI when/if the UE-initiated/triggered report may also indicate/provide that the semi-persistent CSI report(s) could be sent/transmitted on PUSCH, or to receive from the network 130 one or more (MAC CE) activation commands that activate semi-persistent CSI report(s)—e.g., on PUCCH—when/if the UE-initiated/triggered report may also indicate/provide that the semi-persistent CSI report(s) could be sent/transmitted on PUCCH, within a third time window/offset (e.g., in terms of the number of slots/symbols/etc.) starting from the transmission of the (last symbol of) the UE-initiated/triggered report (e.g., starting from the corresponding slot/symbol/etc.). The value of the third time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive from the network 130 a DCI scrambled with SP-CSI-RNTI that activates semi-persistent CSI report(s) on PUSCH(s) by the ‘CSI request’ field indicated therein or MAC CE activation command(s) that activates semi-persistent CSI report(s) on PUCCH(s) within the third time window/offset starting from the transmission of the (last symbol of) UE-initiated/triggered report, the UE 116 could (re-)send/transmit the UE-initiated/triggered report. When/if the UE 116 receives from the network 130 a DCI scrambled with SP-CSI-RNTI that activates semi-persistent CSI report(s) by the ‘CSI request’ field indicated therein (when/if the UE-initiated/triggered report also indicates/provides that the semi-persistent CSI report(s) could be sent/transmitted on PUSCH) or MAC CE activation command(s) that activates semi-persistent CSI report(s) (when/if the UE-initiated/triggered report also indicates/provides that the semi-persistent CSI report(s) could be sent/transmitted on PUCCH) within the third time window/offset starting from the transmission of the (last symbol of) UE-initiated/triggered report, the UE 116 could first determine a trigger/triggering state activated by the ‘CSI request’ field in the DCI from CSI-SemiPersistentOnPUSCH-TriggerStateList or one or more of the CSI resource settings/sets (e.g., configured with ‘semi-Persistent’) configured for the UE 116 that are selected/activated by the MAC CE activation command(s). The UE 116 could then determine the CSI resource setting(s)/set(s) (and therefore, the corresponding CSI resource set(s) and CSI-RS resource(s) configured/provided therein) according to the linked CSI reporting setting(s) that is associated to the trigger/triggering state activated by the ‘CSI request’ field in the DCI or the CSI resource setting(s)/set(s) activated/selected by the MAC CE activation command(s) according to one or more examples described herein. The UE 116 could measure the CSI-RS(s) activated by/associated to the trigger/triggering state or the MAC CE activation command(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

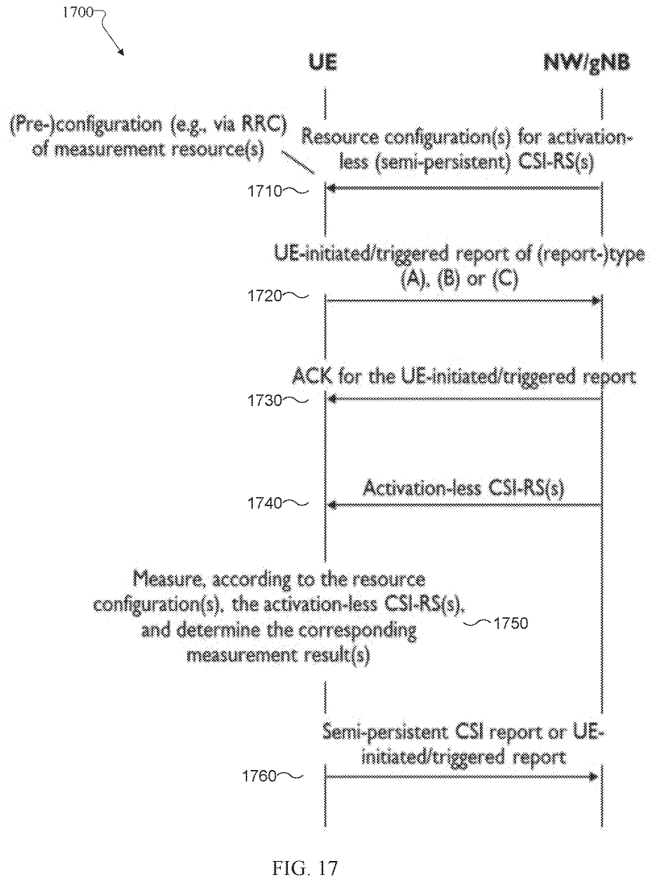

FIG. 17 illustrates an example procedure 1700 for UE-initiated/triggered CSI measurement and reporting according to embodiments of the present disclosure. For example, procedure 1700 for UE-initiated/triggered CSI measurement and reporting can be performed by the UE 116 and the gNB 102 and/or the network 130 in the wireless network 100 of FIG. 1. This example is for illustration only and other embodiments can be used without departing from the scope of the present disclosure.

The procedure begins in 1710, the gNB 102 and/or the network 130 sends (Pre-)configuration (e.g., via RRC) of measurement resource(s) and/or resource configuration(s) for activation-less (semi-persistent) CSI-RS(s) to the UE 116. In 1720, the UE 116 sends UE-initiated/triggered report of (report-)type (A), (B), or (C) to the gNB 102 and/or the network 130. In 1730, the gNB 102 and/or the network 130 sends an ACK for the UE-initiated/triggered report to the UE 116. In 1740, the gNB 102 and/or the network 130 sends activation-less CSI-RS(s) to the UE 116. In 1750, the UE 116 measures, according to the resource configuration(s), the activation-less CSI-RS(s) and determines the corresponding measurement result(s). In 1760, the UE 116 sends semi-persistent CSI report or UE-initiated/triggered report to the gNB 102 and/or the network 130.

In one embodiment, as specified herein in the present disclosure, a UE could transmit/send to the network 130 a UE-initiated/UE-triggered report (or initiation/triggering) of a (report-)type (A), (B), or (C). Here, the UE-initiated/triggered report could also initiate/trigger transmission(s) of (semi-persistent) CSI-RS(s)/CSI-RS resource(s). In addition to initiating/triggering transmission of semi-persistent CSI-RS(s), the UE-initiated/triggered report could also indicate/provide to the network 130 on which (type of) uplink channel(s) including PUCCH and/or PUSCH the semi-persistent CSI report could be sent/transmitted.

In one example, the UE 116 may expect to receive from the network 130 an ACK (or NACK) for the UE-initiated/triggered report within a first time window/offset (e.g., in terms of the number of slots/symbols/etc.) starting from the transmission of the (last symbol of) UE-initiated/triggered report (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the UE-initiated/triggered report within the first time window/offset starting from the transmission of the (last symbol of) UE-initiated/triggered report or receives a NACK for the UE-initiated/triggered report within the first time window/offset starting from the transmission of the (last symbol of) UE-initiated/triggered report, the UE 116 could (re-)send/transmit the UE-initiated/triggered report.
When/if the UE 116 receives from the network 130 an ACK for the UE-initiated/triggered report within the first time window/offset starting from the transmission of the (last symbol of) UE-initiated/triggered report, the UE 116 could start to measure one or more activation-less (semi-persistent) CSI-RSs within a fourth time window/offset (e.g., in terms of the number of slots/symbols/etc.) starting from the reception of the ACK for the UE-initiated/triggered report (e.g., starting from the corresponding slot/symbol/etc.). When/if the UE 116 does not receive the activation-less CSI-RSs within the fourth time window/offset starting from the reception of the ACK for the UE-initiated/triggered report, the UE 116 could (re-)send/transmit the UE-initiated/triggered report; otherwise, the UE 116 could use/apply the corresponding measurement result(s) for the semi-persistent CSI reporting or to autonomously initiate/trigger the event(s)-based or non-event(s)-based reporting as specified herein in the present disclosure. Furthermore, the UE 116 could be (pre-)configured/indicated/provided by the network 130, e.g., via higher layer RRC signaling/parameter and/or MAC CE command and/or dynamic DCI based L1 signaling, resource configuration(s) including resource mapping for the one or more activation-less (semi-persistent) CSI-RSs. The activation-less CSI-RSs may not be triggered/initiated by the ‘CSI request’ field in a DCI scrambled with SP-CSI-RNTI, and therefore, the corresponding trigger/triggering state or the activation-less CSI-RSs may not be activated by the MAC CE activation command(s) as specified herein in the present disclosure. The value of the fourth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The resource configuration(s) for the activation-less CSI-RSs, for instance, could be provided through one or more CSI reporting settings, one or more CSI resource settings, one or more CSI resource sets, and/or one or more CSI-RS resources according to one or more examples described herein. More specifically:
   The resource configuration(s) for the activation-less CSI-RSs could be provided through one or multiple CSI reporting settings each provided by CSI-ReportConfig, wherein a CSI reporting setting provided by CSI-ReportConfig could be linked to one or multiple periodic, semi-persistent, or aperiodic CSI resource settings (and therefore, the corresponding CSI resource set(s) and CSI-RS resource(s) configured/provided therein).
   For the UE-initiated or UE-triggered reporting specified herein in the present disclosure, the resource configuration(s) for the activation-less CSI-RSs could be provided through one or multiple CSI reporting settings each provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting as specified herein in the present disclosure, the resource configuration(s) for the activation-less CSI-RSs could be provided through one or multiple CSI resource settings each provided by CSI-ResourceConfig, one or multiple CSI resource sets each provided by CSI-SSB-ResourceSet or NZP-CSI-ResourceSet, or one or multiple CSI-RS resources each provided by SSB-Index or NZP-CSI-RS-Resource, wherein:
      The one or multiple CSI resource settings/CSI resource sets/CSI-RS resources could be linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI resource settings could correspond to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI resource sets could correspond to one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI-RS resources could correspond to one or more CSI-RS resources for the UE-initiated/triggered reporting determined according to one or more examples described herein.

The UE 116 could then measure the activation-less (semi-persistent) CSI-RS(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

In another example, the UE 116 may not expect to receive from the network 130 an ACK (or NACK) for the UE-initiated/triggered report of (report-)type (A), (B) or (C). For this case, the UE 116 could start to measure one or more activation-less (semi-persistent) CSI-RSs within a fifth time window/offset (e.g., in terms of the number of slots/symbols/etc.) starting from the transmission of the (last symbol of) UE-initiated/triggered report (e.g., starting from the corresponding slot/symbol/etc.). When/if the UE 116 does not receive the activation-less CSI-RSs within the fifth time window/offset starting from the transmission of the (last symbol of) UE-initiated/triggered report, the UE 116 could (re-)send/transmit the UE-initiated/triggered report; otherwise, the UE 116 could use/apply the corresponding measurement result(s) for the semi-persistent CSI reporting or to autonomously initiate/trigger the event(s)-based or non-event(s)-based reporting as specified herein in the present disclosure. Furthermore, the UE 116 could be (pre-)configured/indicated/provided by the network 130, e.g., via higher layer RRC signaling/parameter and/or MAC CE command and/or dynamic DCI based L1 signaling, resource configuration(s) including resource mapping for the one or more activation-less CSI-RSs. The activation-less CSI-RSs may not be activated by the ‘CSI request’ field in a DCI scrambled with SP-CSI-RNTI, and therefore, the corresponding trigger/triggering state or the activation-less CSI-RSs may not be activated by the MAC CE activation command(s) as specified herein in the present disclosure. The value of the fifth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The resource configuration(s) for the activation-less CSI-RSs, for instance, could be provided through one or more CSI reporting settings, one or more CSI resource settings, one or more CSI resource sets, and/or one or more CSI-RS resources according to one or more examples described herein. The UE 116 could then measure the activation-less (semi-persistent) CSI-RS(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

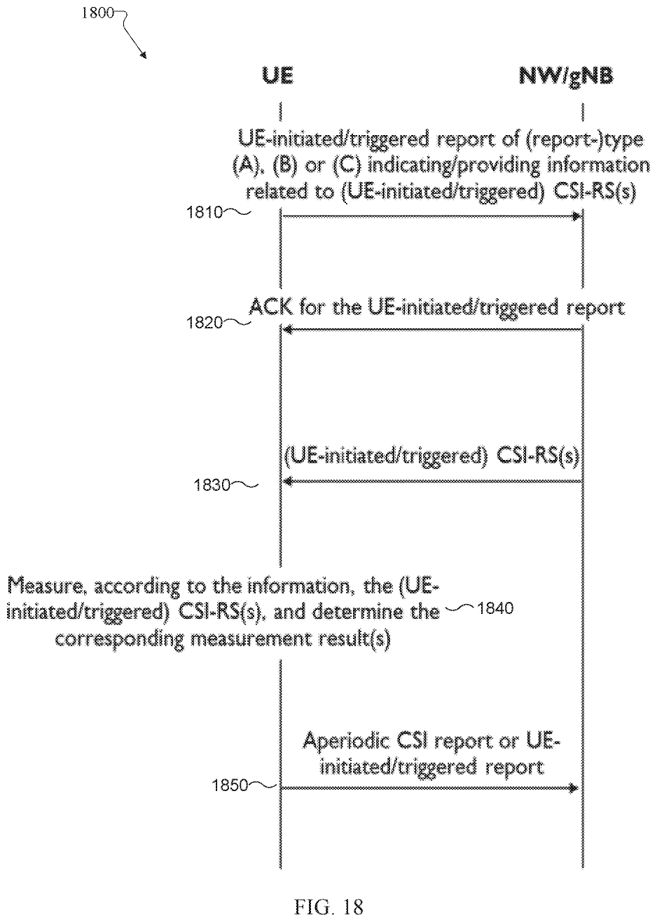

FIG. 18 illustrates an example procedure 1800 for semi-persistent CSI report or UE-initiated/triggered report according to embodiments of the present disclosure. For example, procedure 1800 for semi-persistent CSI report or UE-initiated/triggered report can be performed by the UE 116 and the gNB 102 and/or the network 130 in the wireless network 100 of FIG. 1. This example is for illustration only and other embodiments can be used without departing from the scope of the present disclosure.

The procedure begins in 1810, the UE 116 sends UE-initiated/triggered report of (report-)type (A), (B), or (C) indicating/providing information related to (UE-initiated/triggered_CSI-RS(s) to the gNB 102 and/or the network 130. In 1820, the gNB 102 and/or the network 130 sends an ACK for the UE-initiated/triggered report to the UE 116. In 1830, the gNB 102 and/or the network 130 sends (UE-initiated/triggered) CSI-RS(s) to the UE 116. In 1840, the UE 116 measures, according to the information, the (UE-initiated/triggered) CSI-RS(s) and determines the corresponding measurement results(s). In 1850, the UE 116 sends aperiodic CSI report or UE-initiated/triggered report to the gNB 102 and/or the network 130.

In one embodiment, as specified herein in the present disclosure, a UE could transmit/send to the network 130 a UE-initiated/UE-triggered report (or initiation/triggering) of a (report-)type (A), (B), or (C). Here, the UE-initiated/triggered report could provide/indicate information related to one or more (UE-initiated/activated) CSI-RS resources for (semi-persistent) CSI reporting or UE-initiated/triggered reporting as specified herein in the present disclosure. For example, the information could include/contain a trigger state in CSI-SemiPersistentOnPUSCH-TriggerStateList containing one or more associated CSI reporting settings each provided by CSI-ReportConfig. For another example, the information could include/contain one or more CSI reporting settings/CSI reporting setting IDs—e.g., those linked to one or more CSI resource settings/sets that can be activated/selected from the configured CSI resource settings/sets (e.g., configured with ‘semi-Persistent’), wherein a CSI reporting setting could be provided by CSI-ReportConfig. Yet for another example, the information could include/contain one or more CSI resource settings/CSI resource setting IDs that can be activated/selected from the configured CSI resource settings (e.g., configured with ‘semi-Persistent’), wherein a CSI resource setting could be provided by CSI-ResourceConfig. Yet for another example, the information could include/contain one or more CSI resource sets/CSI resource set IDs that can be activated/selected from the configured CSI resource sets associated to the configured CSI resource settings (e.g., configured with ‘semi-Persistent’), wherein a CSI resource set could be provided by CSI-SSB-ResourceSet or NZP-CSI-RS-ResourceSet. Yet for another example, the information could include/contain one or more CSI-RS resources/CSI-RS resource indexes/IDs that can be activated/selected from the CSI-RS resources in the configured CSI resource set(s) associated to the configured CSI resource setting(s) (e.g., configured with ‘semi-Persistent’), wherein a CSI-RS resource could correspond to a SSB provided by SSB-Index or a NZP CSI-RS resource provided by nzp-CSI-RS-Resource. Yet for another example, the information could contain/include PUCCH resources for (semi-persistent) CSI reporting or the UE-initiated/triggered reporting as specified herein in the present disclosure. Furthermore, in addition to providing/indicating information related to one or more (UE-initiated/activated) CSI-RS resources for (semi-persistent) CSI reporting or UE-initiated/triggered reporting as specified herein in the present disclosure, the UE-initiated/triggered report could also indicate/provide to the network 130 on which (type of) uplink channel(s) including PUCCH and/or PUSCH the semi-persistent CSI report could be sent/transmitted.

In one example, the UE 116 may expect to receive from the network 130 an ACK (or NACK) for the UE-initiated/triggered report that carries/provides/indicates the information related to the UE-initiated/activated CSI-RS(s) within a first time window/offset (e.g., in terms of the number of slots/symbols/etc.) starting from the transmission of the (last symbol of) UE-initiated/triggered report (e.g., starting from the corresponding slot/symbol/etc.). The value of the first time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
When/if the UE 116 does not receive from the network 130 an ACK for the UE-initiated/triggered report that carries/provides/indicates the information related to the UE-initiated/activated CSI-RS(s) within the first time window/offset starting from the transmission of the (last symbol of) UE-initiated/triggered report or receives a NACK for the UE-initiated/triggered report that carries/provides/indicates the information related to the UE-initiated/activated CSI-RS(s) within the first time window/offset starting from the transmission of the (last symbol of) UE-initiated/triggered report, the UE 116 could (re-)send/transmit the UE-initiated/triggered report that carries/provides/indicates the information related to the UE-initiated/activated CSI-RS(s).
When/if the UE 116 receives from the network 130 an ACK for the UE-initiated/triggered report that carries/provides/indicates the information related to the UE-initiated/activated CSI-RS(s) within the first time window/offset starting from the transmission of the (last symbol of) UE-initiated/triggered report, the UE 116 could start to measure one or more UE-initiated/activated CSI-RSs within a fourth time window/offset (e.g., in terms of the number of slots/symbols/etc.) starting from the reception of the ACK for the UE-initiated/triggered report (e.g., starting from the corresponding slot/symbol/etc.). When/if the UE 116 does not receive the UE-initiated/activated CSI-RS(s) within the fourth time window/offset starting from the reception of the ACK for the UE-initiated/triggered report, the UE 116 could (re-)send/transmit the UE-initiated/triggered report that carries/provides/indicates the information related to the UE-initiated/activated CSI-RS(s); otherwise, the UE 116 could use/apply the corresponding measurement result(s) for the semi-persistent CSI reporting or to autonomously initiate/trigger the event(s)-based or non-event(s)-based reporting as specified herein in the present disclosure. The value of the fourth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The information related to the one or more UE-initiated/activated CSI-RS(s)—indicated/provided to the network 130 in part of the UE-initiated/triggered report—could include/contain one or more CSI reporting settings, one or more CSI resource settings, one or more CSI resource sets and/or one or more CSI-RS resources according to one or more examples described herein. More specifically:
   The information related to the UE-initiated/activated CSI-RS(s) could include/contain one or multiple CSI reporting settings or a trigger state containing one or multiple CSI reporting settings with each CSI reporting setting provided by CSI-ReportConfig, wherein a CSI reporting setting could be linked to one or multiple periodic, semi-persistent, or aperiodic CSI resource settings (and therefore, the corresponding CSI resource set(s) and CSI-RS resource(s) configured/provided therein).
   For the UE-initiated or UE-triggered reporting specified herein in the present disclosure, the information related to the UE-initiated/activated CSI-RS(s) could include/contain one or multiple CSI reporting settings or a trigger state containing one or multiple CSI reporting settings with each CSI reporting setting provided by CSI-ReportConfig, wherein:
      The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI reporting settings could be linked to one or more CSI resource settings, and therefore, the corresponding CSI resource set(s) configured therein, wherein a CSI resource set could comprise one or more CSI-RS resources for the UE-initiated/triggered reporting determined according to one or more examples described herein.
   For the UE-initiated or UE-triggered reporting as specified herein in the present disclosure, the information related to the UE-initiated/activated CSI-RSs could include/contain one or multiple CSI resource settings each provided by CSI-ResourceConfig, one or multiple CSI resource sets each provided by CSI-SSB-ResourceSet or NZP-CSI-ResourceSet, or one or multiple CSI-RS resources each provided by SSB-Index or NZP-CSI-RS-Resource, wherein:
      The one or multiple CSI resource settings/CSI resource sets/CSI-RS resources could be linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
      The one or multiple CSI resource settings could correspond to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
      The one or multiple CSI resource sets could correspond to one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
      The one or multiple CSI-RS resources could correspond to one or more CSI-RS resources for the UE-initiated/triggered reporting determined according to one or more examples described herein.

The UE 116 could then measure the UE-initiated/activated CSI-RS(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

In another example, the UE 116 may not expect to receive from the network 130 an ACK (or NACK) for the UE-initiated/triggered report of (report-)type (A), (B) or (C) that carries/provides/indicates the information related to the (UE-initiated/activated) CSI-RS(s). For this case, the UE 116 could start to measure one or more UE-initiated/activated CSI-RSs within a fifth time window/offset (e.g., in terms of the number of slots/symbols/etc.) starting from the transmission of the (last symbol of) UE-initiated/triggered report that carries/provides/indicates the information related to the UE-initiated/activated CSI-RS(s) (e.g., starting from the corresponding slot/symbol/etc.). When/if the UE 116 does not receive the UE-initiated/activated CSI-RSs within the fifth time window/offset starting from the transmission of the (last symbol of) UE-initiated/triggered report, the UE 116 could (re-)send/transmit the UE-initiated/triggered report that carries/provides/indicates the information related to the UE-initiated/activated CSI-RS(s); otherwise, the UE 116 could use/apply the corresponding measurement result(s) for the semi-persistent CSI reporting or to autonomously initiate/trigger the event(s)-based or non-event(s)-based reporting as specified herein in the present disclosure. The value of the fifth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. The information related to the (UE-initiated/activated) CSI-RSs—provided/indicated to the network 130 in part of the UE-initiated/triggered report as specified herein in the present disclosure, for instance, could include/contain a trigger state containing one or more CSI reporting settings, one or more CSI reporting settings, one or more CSI resource settings, one or more CSI resource sets and/or one or more CSI-RS resources according to one or more examples described herein. The UE 116 could then measure the UE-initiated/activated CSI-RS(s) as specified herein in the present disclosure and use/apply the corresponding measurement result(s) for the semi-persistent CSI reporting or to autonomously initiate/trigger the event(s)-based or non-event(s)-based reporting as specified herein in the present disclosure.

As discussed herein, the UE-initiated/triggered report of (report-)type (A), (B) or (C), as specified herein in the present disclosure, could indicate/provide to the network 130 one or more of: (i) an indication to initiate/trigger a transmission of a DCI scrambled with SP-CSI-RNTI that activates semi-persistent CSI report(s)—e.g., on PUSCH—by a ‘CSI request’ field in the DCI, (ii) an indication to initiate/trigger one or more (MAC CE) activation commands (e.g., the SP CSI-RS/CSI-IM Resource Set Activation/Deactivation MAC CE, the SP CSI reporting on PUCCH Activation/Deactivation MAC CE, and/or the SP ZP CSI-RS Resource Set Activation/Deactivation MAC CE) that activate semi-persistent CSI report(s)—e.g., on PUCCH, (ii) an indication to initiate/trigger transmission(s) of activation-less (semi-persistent) CSI-RS(s)/CSI-RS resource(s), and (iii) information related to one or more (UE-initiated/activated) CSI-RSs. Hence, the UE 116 could follow one or more examples described herein to determine resource configuration(s) for the (semi-persistent or UE-initiated/activated) CSI-RS(s), measure, according to the resource configuration(s), the (semi-persistent or UE-initiated/activated) CSI-RS(s), and use/apply the corresponding measurement result(s) for the semi-persistent CSI reporting or the UE-initiated/triggered reporting as specified herein in the present disclosure. Furthermore, the signaling medium/container for reporting the UE-initiated/triggered report of (report-)type (A), (B) or (C) as specified herein in the present disclosure could be PUCCH, PUSCH, PRACH, MAC CE, UCI, etc. Optionally:
For a first setting (i.e., UE-initiated/triggered/activated), the UE 116 could follow one or more examples described herein to determine resource configuration(s) for the (semi-persistent or UE-initiated/activated) CSI-RS(s), measure, according to the resource configuration(s), the (semi-persistent or UE-initiated/activated) CSI-RS(s), and use/apply the corresponding measurement result(s) for the semi-persistent CSI reporting or the UE-initiated/triggered reporting as specified herein in the present disclosure.
For a second setting (i.e., NW-configured/indicated/provided), the UE 116 could follow the ‘CSI request’ field in the DCI, and therefore, the corresponding/associated trigger state, or the MAC CE activation command(s) as specified herein in the present disclosure to determine resource configuration(s) for the (semi-persistent or UE-initiated/activated) CSI-RS(s), measure, according to the resource configuration(s), the (semi-persistent or UE-initiated/activated) CSI-RS(s), and use/apply the corresponding measurement result(s) for the semi-persistent CSI reporting or the UE-initiated/triggered reporting as specified herein in the present disclosure.

In the present disclosure, the first and/or second settings could correspond to various target application scenarios such as D2D, side-link (SL) communications, etc.; alternatively, the first and/or second settings could correspond to various system configurations. Furthermore, the UE could be configured/indicated/provided by the network, e.g., via higher layer RRC signaling/parameter and/or MAC CE command and/or dynamic DCI based L1 signaling, the first and/or second settings (e.g., either the first setting or the second setting, or both the first and second settings).

For the UE-initiated or UE-activated semi-persistent CSI reporting specified herein in the present disclosure (and therefore, the corresponding CSI resource setting(s), CSI resource set(s) or CSI-RS resource(s)), the UE 116 could indicate to the network, or send to the network a fourth indicator, wherein the fourth indicator could correspond to or be determined according to one or more of the following.
In one example, the fourth indicator could initiate/trigger a transmission of a DCI scrambled with SP-CSI-RNTI that releases semi-persistent CSI report(s)—e.g., on PUSCH, and therefore, deactivate transmission(s) of the corresponding/associated CSI-RS(s)/CSI-RS resource(s).
   For example, the UE 116 may expect to receive from the network 130 an ACK (or NACK) for the fourth indicator within a sixth time window/offset (e.g., in terms of the number of slots/symbols/etc.) starting from the transmission of the fourth indicator (e.g., starting from the corresponding slot/symbol/etc.). The value of the sixth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
      When/if the UE 116 does not receive from the network 130 an ACK for the fourth indicator within the sixth time window/offset starting from the transmission of the fourth indicator or receives a NACK for the fourth indicator within the sixth time window/offset starting from the transmission of the fourth indicator, the UE 116 could (re-)send the fourth indicator and/or continue the semi-persistent CSI reporting—e.g., on PUSCH(s).
      When/if the UE 116 receives from the network 130 an ACK for the fourth indicator within the sixth time window/offset starting from the transmission of the fourth indicator, the UE 116 may expect to receive/validate, for semi-persistent CSI release, a physical downlink control channel (PDCCH) on a DCI scrambled with SP-CSI-RNTI within a seventh time window/offset (e.g., in terms of the number of slots/symbols/etc.) starting from the reception of the ACK for the fourth indicator (e.g., starting from the corresponding slot/symbol/etc.), wherein the DCI format could contain one or more special fields set according to document and standard [4]. The value of the seventh time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive/validate the DCI scrambled with SP-CSI-RNTI that releases the semi-persistent CSI reporting within the seventh time window/offset, the UE 116 could (re-)send the fourth indicator and/or continue the semi-persistent CSI reporting—e.g., on PUSCH(s); otherwise, the UE 116 could deactivate the semi-persistent CSI reporting—e.g., on PUSCH(s).
   For another example, the UE 116 may not expect to receive from the network 130 an ACK (or NACK) for the fourth indicator. For this case, the UE 116 may expect to receive/validate, for semi-persistent CSI release, a PDCCH on a DCI scrambled with SP-CSI-RNTI, within an eighth time window/offset (e.g., in terms of the number of slots/symbols/etc.) starting from the transmission of the fourth indicator (e.g., starting from the corresponding slot/symbol/etc.), wherein the DCI format could contain one or more special fields set according to document and standard [4]. The value of the eighth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive/validate the DCI scrambled with SP-CSI-RNTI that releases the semi-persistent CSI reporting within the eighth time window/offset, the UE 116 could (re-)send the fourth indicator and/or continue the semi-persistent CSI reporting—e.g., on PUSCH(s); otherwise, the UE 116 could deactivate the semi-persistent CSI reporting—e.g., on PUSCH(s).
In another example, the fourth indicator could initiate/trigger one or more (MAC CE) deactivation commands (e.g., the SP CSI-RS/CSI-IM Resource Set Activation/Deactivation MAC CE, the SP CSI reporting on PUCCH Activation/Deactivation MAC CE, and/or the SP ZP CSI-RS Resource Set Activation/Deactivation MAC CE) that deactivate semi-persistent CSI report(s)—e.g., on PUCCH, and therefore deactivate transmission(s) of the corresponding/associated CSI-RS(s)/CSI-RS resource(s).
   For example, the UE 116 may expect to receive from the network 130 an ACK (or NACK) for the fourth indicator within a sixth time window/offset (e.g., in terms of the number of slots/symbols/etc.) starting from the transmission of the fourth indicator (e.g., starting from the corresponding slot/symbol/etc.). The value of the sixth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
      When/if the UE 116 does not receive from the network 130 an ACK for the fourth indicator within the sixth time window/offset starting from the transmission of the fourth indicator or receives a NACK for the fourth indicator within the sixth time window/offset starting from the transmission of the fourth indicator, the UE 116 could (re-)send the fourth indicator and/or continue the semi-persistent CSI reporting—e.g., on PUCCH(s).
      When/if the UE 116 receives from the network 130 an ACK for the fourth indicator within the sixth time window/offset starting from the transmission of the fourth indicator, the UE 116 may expect to receive from the network 130 one or more (MAC CE) deactivation commands that deactivate semi-persistent CSI report(s)—e.g., on PUCCH—and therefore cease the transmission(s) of the corresponding/associated CSI-RS(s)/CSI-RS resource(s), within a seventh time window/offset (e.g., in terms of the number of slots/symbols/etc.) starting from the reception of the ACK for the fourth indicator (e.g., starting from the corresponding slot/symbol/etc.). The value of the seventh time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive the MAC CE deactivation command(s) that deactivates the semi-persistent CSI reporting within the seventh time window/offset, the UE 116 could (re-)send the fourth indicator and/or continue the semi-persistent CSI reporting—e.g., on PUCCH(s); otherwise, the UE 116 could deactivate the semi-persistent CSI reporting—e.g., on PUCCH(s)—and assume cessation of the transmission(s) of the corresponding/associated CSI-RS(s)/CSI-RS resource(s).
   For another example, the UE 116 may not expect to receive from the network 130 an ACK (or NACK) for the fourth indicator. For this case, the UE 116 may expect to receive from the network 130 one or more (MAC CE) deactivation commands that deactivate semi-persistent CSI report(s)—e.g., on PUCCH—and therefore, cease the transmission(s) of the corresponding/associated CSI-RS(s)/CSI-RS resource(s) within an eighth time window/offset (e.g., in terms of the number of slots/symbols/etc.) starting from the transmission of the fourth indicator (e.g., starting from the corresponding slot/symbol/etc.). The value of the eighth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH. When/if the UE 116 does not receive the MAC CE deactivation command(s) that deactivates the semi-persistent CSI reporting within the eighth time window/offset, the UE 116 could (re-)send the fourth indicator and/or continue the semi-persistent CSI reporting—e.g., on PUCCH(s); otherwise, the UE 116 could deactivate the semi-persistent CSI reporting—e.g., on PUCCH(s)—and assume cessation of the transmission(s) of the corresponding/associated CSI-RS(s)/CSI-RS resource(s).
In yet another example, the fourth indicator could initiate/trigger deactivation/cessation of transmission(s) of activation-less (semi-persistent) CSI-RS(s) as specified herein in the present disclosure.
   For example, the UE 116 may expect to receive from the network 130 an ACK (or NACK) for the fourth indicator within a sixth time window/offset (e.g., in terms of the number of slots/symbols/etc.) starting from the transmission of the fourth indicator (e.g., starting from the corresponding slot/symbol/etc.). The value of the sixth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
      When/if the UE 116 does not receive from the network 130 an ACK for the fourth indicator within the sixth time window/offset starting from the transmission of the fourth indicator or receives a NACK for the fourth indicator within the sixth time window/offset starting from the transmission of the fourth indicator, the UE 116 could (re-)send the fourth indicator and/or continue the semi-persistent CSI reporting.
      When/if the UE 116 receives from the network 130 an ACK for the fourth indicator within the sixth time window/offset starting from the transmission of the fourth indicator, the UE 116 could deactivate the semi-persistent CSI reporting and assume cessation of the transmission(s) of the activation-less (semi-persistent) CSI-RS(s)/CSI-RS resource(s) as specified herein in the present disclosure, x time/duration/offset (e.g., x symbols/slots/etc.) after the reception of the ACK for the fourth indicator, wherein the value of x could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
   For another example, the UE 116 may not expect to receive from the network 130 an ACK (or NACK) for the fourth indicator. For this case, the UE 116 could deactivate the semi-persistent CSI reporting and assume cessation of the transmission(s) of the activation-less (semi-persistent) CSI-RS(s)/CSI-RS resource(s) as specified herein in the present disclosure, y time/duration/offset (e.g., y symbols/slots/etc.) after the transmission of the fourth indicator, wherein the value of y could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
In yet another example, the fourth indicator could provide/indicate information related to one or more CSI-RS resources that can be deactivated for semi-persistent CSI reporting or UE-initiated/triggered reporting as specified herein in the present disclosure—which can be denoted by UE-deactivated CSI-RS(s) in the present disclosure. For example, the information could include/contain a trigger state in CSI-SemiPersistentOnPUSCH-TriggerStateList containing one or more associated CSI reporting settings each provided by CSI-ReportConfig, wherein the CSI resource setting(s)—and therefore, the corresponding CSI resource set(s) and CSI-RS resource(s) configured therein—can be deactivated for the semi-persistent CSI reporting or the UE-initiated/triggered reporting. For another example, the information could include/contain one or more CSI reporting settings/CSI reporting setting IDs—e.g., those linked to one or more CSI resource settings/sets (and therefore, the corresponding CSI-RS resource(s) configured therein) that can be deactivated for the semi-persistent CSI reporting or the UE-initiated/triggered reporting, wherein a CSI reporting setting could be provided by CSI-ReportConfig. Yet for another example, the information could include/contain one or more CSI resource settings/CSI resource setting IDs (and therefore, the corresponding CSI resource set(s) and the CSI-RS resource(s) configured therein) that can be deactivated for the semi-persistent CSI reporting or the UE-initiated/triggered reporting, wherein a CSI resource setting could be provided by CSI-ResourceConfig. Yet for another example, the information could include/contain one or more CSI resource sets/CSI resource set IDs (and therefore, the CSI-RS resource(s) configured therein) that can be deactivated for the semi-persistent CSI reporting or the UE-initiated/triggered reporting, wherein a CSI resource set could be provided by CSI-SSB-ResourceSet or NZP-CSI-RS-ResourceSet. Yet for another example, the information could include/contain one or more CSI-RS resources/CSI-RS resource indexes/IDs that can be deactivated for the semi-persistent CSI reporting or the UE-initiated/triggered reporting, wherein a CSI-RS resource could correspond to a SSB provided by SSB-Index or a NZP CSI-RS resource provided by nzp-CSI-RS-Resource. Yet for another example, the information could contain/include PUCCH resources that can be deactivated for (semi-persistent) CSI reporting or the UE-initiated/triggered reporting as specified herein in the present disclosure.
   For example, the UE 116 may expect to receive from the network 130 an ACK (or NACK) for the fourth indicator within a sixth time window/offset (e.g., in terms of the number of slots/symbols/etc.) starting from the transmission of the fourth indicator (e.g., starting from the corresponding slot/symbol/etc.). The value of the sixth time window/offset could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
      When/if the UE 116 does not receive from the network 130 an ACK for the fourth indicator within the sixth time window/offset starting from the transmission of the fourth indicator or receives a NACK for the fourth indicator within the sixth time window/offset starting from the transmission of the fourth indicator, the UE 116 could (re-)send the fourth indicator and/or continue the semi-persistent CSI reporting.
      When/if the UE 116 receives from the network 130 an ACK for the fourth indicator within the sixth time window/offset starting from the transmission of the fourth indicator, the UE 116 could deactivate the semi-persistent CSI reporting and assume cessation of the transmission(s) of the UE-initiated/activated CSI-RS(s)/CSI-RS resource(s) as specified herein in the present disclosure, x time/duration/offset (e.g., x symbols/slots/etc.) after the reception of the ACK for the fourth indicator, wherein the value of x could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.
   For another example, the UE 116 may not expect to receive from the network 130 an ACK (or NACK) for the fourth indicator. For this case, the UE 116 could deactivate the semi-persistent CSI reporting and assume cessation of the transmission(s) of the UE-initiated/activated CSI-RS(s)/CSI-RS resource(s) as specified herein in the present disclosure, y time/duration/offset (e.g., y symbols/slots/etc.) after the transmission of the fourth indicator, wherein the value of y could be: (i) fixed in the system specification(s), (ii) configured/provided/indicated by the network 130, e.g., via higher layer RRC signaling/parameter and/or MAC CE command and/or dynamic DCI based L1 signaling, or (iii) autonomously determined by the UE 116 and sent to the network 130 via uplink channels such as PUCCH/PUSCH.

According to the design examples described in the present disclosure, a UE-initiated/triggered report of (report-)type(A), (B) or (C) as specified herein in the present disclosure could act/serve as the fourth indicator in its entirety, or a UE-initiated/triggered report of (report-)type(A), (B) or (C) as specified herein in the present disclosure could include/contain the fourth indicator. Hence, the described/specified deactivation of the semi-persistent CSI reporting or the cessation of the transmission(s) of the corresponding/associated CSI-RS(s)/CSI-RS resource(s) for the fourth indicator can be equally applied to the UE-initiated/triggered report of (report-)type (A), (B) or (C).

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method performed by a user equipment (UE) in a wireless communication system, the method comprising:
receiving, from a base station, configuration information for a channel state information (CSI) report including information configuring a UE initiated report;
measuring a reference signal (RS) configured by a CSI resource set for the UE initiated report;
transmitting, to the base station, an indicator for the UE initiated report based on an event which is determined based on a layer 1-RS received power (L1-RSRP) value of the RS greater that a threshold value; and
transmitting, to the base station, the CSI report on a physical uplink shared channel (PUSCH),
wherein the information configuring the UE initiated report includes information configuring a type of the event,
wherein the RS is a CSI-RS or a synchronization signal, SS/physical broadcasting channel (PBCH) block (SSB), and
wherein the indicator for the UE initiated report is for requesting downlink control information (DCI) scheduling the PUSCH.

2. The method of claim 1, wherein the DCI includes a CSI request field indicating a CSI trigger state associated with the configuration information for the CSI report.

3. The method of claim 1, wherein:
the UE is configured with multiple CSI configurations including the configuration information for the CSI report, and
the multiple CSI configurations are associated with a same CSI trigger state.

4. The method of claim 1, wherein the CSI report includes an indicator indicating the configuration information for the CSI report.

5. The method of claim 1, wherein:
the indicator for the UE initiated report is transmitted on a physical uplink control channel (PUCCH), and
the information configuring the UE initiated report includes information configuring the PUCCH.

6. The method of claim 1, wherein the information configuring the UE initiated report includes information configuring the PUSCH.

7. A user equipment (UE) in a wireless communication system, the UE comprising:
a transceiver configured to receive, from a base station, configuration information for a channel state information (CSI) report including information configuring a UE initiated report; and
a processor operably coupled with the transceiver, the processor configured to measure a reference signal (RS) configured by a CSI resource set for the UE initiated report,
wherein the transceiver is further configured to:
transmit, to the base station, an indicator for the UE initiated report based on an event which is determined based on a layer 1-RS received power (L1-RSRP) value of the RS greater that a threshold value, and
transmit, to the base station, the CSI report on a physical uplink shared channel (PUSCH),
wherein the information configuring the UE initiated report includes information configuring a type of the event,
wherein the RS is a CSI-RS or a synchronization signal, SS/physical broadcasting channel (PBCH) block (SSB), and
wherein the indicator for the UE initiated report is for requesting downlink control information (DCI) scheduling the PUSCH.

8. The UE of claim 7, wherein the DCI includes a CSI request field indicating a CSI trigger state associated with the configuration information for the CSI report.

9. The UE of claim 7, wherein:
the UE is configured with multiple CSI configurations including the configuration information for the CSI report, and
the multiple CSI configurations are associated with a same CSI trigger state.

10. The UE of claim 7, wherein the CSI report includes an indicator indicating the configuration information for the CSI report.

11. The UE of claim 7, wherein:
the indicator for the UE initiated report is transmitted on a physical uplink control channel (PUCCH), and
the information configuring the UE initiated report includes information configuring the PUCCH.

12. The UE of claim 7, wherein the information configuring the UE initiated report includes information configuring the PUSCH.

13. A base station (BS) in a wireless communication system, the BS comprising:
a processor; and
a transceiver operably coupled with the processor, the transceiver configured to:
transmit, to a user equipment (UE), configuration information for a channel state information (CSI) report including information configuring a UE initiated report;
transmit a reference signal (RS) configured by a CSI resource set for the UE initiated report;
receive, from the UE, an indicator for the UE initiated report based on an event which is based on a layer 1-RS received power (L1-RSRP) value of the RS greater that a threshold value; and
receive, from the UE, the CSI report on a physical uplink shared channel (PUSCH),
wherein the information configuring the UE initiated report includes information configuring a type of the event,
wherein the RS is a CSI-RS or a synchronization signal, SS/physical broadcasting channel (PBCH) block (SSB), and
wherein the indicator for the UE initiated report is for requesting downlink control information (DCI) scheduling the PUSCH.

14. The BS of claim 13, wherein the DCI includes a CSI request field indicating a CSI trigger state associated with the configuration information for the CSI report.

15. The BS of claim 13, wherein:
the UE is configured with multiple CSI configurations including the configuration information for the CSI report, and
the multiple CSI configurations are associated with a same CSI trigger state.

16. The BS of claim 13, wherein the CSI report includes an indicator indicating the configuration information for the CSI report.

17. The BS of claim 13, wherein:
the indicator for the UE initiated report is transmitted on a physical uplink control channel (PUCCH), and
the information configuring the UE initiated report includes information configuring the PUCCH.

18. The BS of claim 13, wherein the information configuring the UE initiated report includes information configuring the PUSCH.
